(19) United States
(12) Patent Application Publication
(10) Pub. No.: US 2025/0263824 A1
(43) Pub. Date: Aug. 21, 2025

(54) ADDITIVELY MANUFACTURED OXIDE DISPERSION-STRENGTHENED ALLOY

(71) Applicant: Massachusetts Institute of Technology, Cambridge, MA (US)

(72) Inventors: Zachary C. Cordero, Westwood, MA (US); Andres Garcia Jimenez, Boston, MA (US); Wenyuan Hou, Colonie, NY (US)

(73) Assignee: Massachusetts Institute of Technology, Cambridge, MA (US)

(21) Appl. No.: 19/055,804

(22) Filed: Feb. 18, 2025

Related U.S. Application Data
(60) Provisional application No. 63/553,895, filed on Feb. 15, 2024.

(51) Int. Cl. C22C 32/00; B33Y 70/10; C22C 19/05

(52) U.S. Cl. CPC C22C 32/0026; B33Y 70/10; C22C 19/058

(57) ABSTRACT

An oxyide dispersion-strengthened (ODS) alloy is disclosed that is compatible with melt-based additive manufacturing processes, such as laser powder bed fusion (L-PBF) while achieving material properties, such as resistance to frictional ignition, comparable to or better than wrought ODS alloys. This is accomplished, in part, by adjusting the composition of the ODS alloy and/or adjusting the operating parameters of the additive manufacturing process to reduce or, in some instances, mitigate dispersoid coarsening and slag formation. For example, a nickel (Ni)-based ODS alloy may include less than 0.3 wt % aluminum (Al) to reduce the formation of low melting point oxides that are prone to coarsening and slag formation. In another example, various processing parameters associated with a selective laser melting process, such as beam power, beam spot size, and scan speed, may be chosen to reduce a melt time associated with the additive manufacturing process.

### CROSS-REFERENCE TO RELATED APPLICATION(S)

This application claims the priority benefit, under 35 U.S.C. 119 (c), of U.S. Application No. 63/553,895, filed Feb. 15, 2024 and entitled, “ADDITIVELY MANUFACTURED BURN-RESISTANT ALLOY FOR HIGH-PRESSURE OXYGEN ENVIRONMENTS,” which is incorporated herein by reference in its entirety.

### GOVERNMENT SUPPORT

This invention was made with government support under N00014-22-1-2036 awarded by the Office of Naval Research, and DMR2004913 awarded by the National Science Foundation. The government has certain rights in the invention.

### BACKGROUND

Staged combustion reusable rocket engines typically generate high-pressure oxygen environments. For example, the oxygen-rich turbopump of oxidizer-rich and full-flow staged combustion rocket engines often includes a high-temperature, oxygen-rich gas that flows from a preburner into a turbine. As shown in FIG. 1A, a staged combustion power cycle may direct the majority or, in some instances, all the propellant into a combustion chamber. The gas pressures in oxygen-rich turbopumps are appreciably higher than conventional gas turbine engines, as shown in FIG. 1B. As a result, conventional turbines made from, for example, high-strength Ni-base superalloys with high concentrations of reactive Ti and Al, are often susceptible to metal ignition and burning.

Metal ignition and oxygen fires can occur in several ways. For reference, FIG. 1C shows an illustration of an example oxygen-rich turbopump where an oxygen-rich gas flows past a turbine blade located downstream with respect to a portion of the turbopump where liquid oxygen and liquid methane are combusted. In one example, metal ignition can occur due to friction between components that rub against one another. For example, a rotor may rub against a stationary component (e.g., a stator), which can lead to friction ignition and catastrophic failure of the engine.

### SUMMARY

The Inventors have recognized and appreciated certain oxide dispersion-strengthened (ODS) alloys exhibit exceptional resistance to frictional ignition due to the presence of oxide nanoparticles, which strengthen the underlying metal and improve the adhesion of a protective oxide tribolayer. However, the Inventors have also recognized components formed from ODS alloys using conventional manufacturing processes are generally limited to relatively simple geometries. Thus, the fabrication of components with relatively complex geometries requires additional manufacturing steps, resulting in material waste and increased costs.

In particular, conventional ODS alloys are often formed using solid-state powder processing where a base alloy is mechanically alloyed with oxide nanoparticles to form a powder and the powder is thereafter densified using a pressure-assisted consolidation process (e.g., extrusion, hot pressing). Solid-state powder processing has been used, in part, to reduce oxide agglomeration (i.e., slag) and coarsening in the ODS alloy, which are mechanisms that can degrade the properties of the ODS alloy. However, solid-state powder processing is significantly limited in terms of the geometry of the components that can be fabricated. For example, solid-state powder processing is typically used to form an ingot. The ingot is then worked into the desired shape of a component. In other words, the component is formed from wrought ODS alloy.

Accordingly, the Inventors recognized melt-based additive manufacturing (AM) processes can address the limitations of solid-state powder processing by printing components with a near-net geometry, i.e., a geometry that is similar to the final geometry for that component. However, previous attempts at using AM to form components from a Ni-based ODS alloy have led to extensive coarsening and slag formation, thus degrading the properties of the ODS alloy.

The present disclosure is thus directed to various inventive implementations of an ODS alloy that is compatible with melt-based additive manufacturing and additive manufacturing processes for manufacturing components from the ODS alloys disclosed herein. Specifically, the ODS alloys disclosed herein and the components formed from thereof may be formed using melt-based additive manufacturing with appreciably reduced coarsening and/or slag formation. In some instances, the ODS alloys disclosed herein and the components formed from thereof may be formed using melt-based additive manufacturing with no coarsening and/or slag formation. In this manner, the ODS alloys disclosed herein may maintain the exceptional properties of conventional wrought ODS alloys while allowing fabrication of more complex components via additive manufacturing.

In one aspect, the ODS alloys disclosed herein may comprise nickel (Ni), chromium (Cr), yttria (Y₂O₃), and aluminum (Al). If Al is present, the amount of Al may be sufficiently low, in part, to reduce or, in some instances, prevent the formation of low melting point oxides of Y₂O₃ and Al, which are prone to coarsening and forming slag. For example, the weight concentration of Al may be less than or equal to 0.3 wt % or, more preferably, less than 0.1 wt %. In some implementations, the Ni may have a concentration ranging from about 65 wt % to about 90 wt %. In some implementations, the Cr may have a concentration ranging from about 5 wt % to about 35 wt %. In some implementations, the Y₂O₃ may have a concentration ranging from about 0.1 wt % to about 1 wt %. The ODS alloy may further comprise one or more strengthening elements including, but not limited to, iron (Fe), molybdenum (Mo), manganese (Mn), tungsten (W), cobalt (Co), niobium (Nb), tantalum (Ta), titanium (Ti), carbon (C), copper (Cu), silicon (Si), and sulfur(S).

In another aspect, the ODS alloys disclosed herein may include dispersoids after manufacture. For example, the ODS alloy may include a matrix formed of Ni and Cr and the dispersoids may be uniformly distributed throughout the matrix. The dispersoids may be formed of Y₂O₃ and Al. The dispersoids, which are the source of coarsening and slag formation, typically exhibit a size distribution. In some implementations, the size distribution may be such that a majority of the dispersoids have a diameter (or effective diameter) less than or equal to about 30 nm. Said another way, the dispersoids may include a first subset of dispersoids having a diameter less than or equal to 30 nm and a second subset of dispersoids having diameter greater than 30 nm. The first number density of the first subset of dispersoids is greater than a second number density of the second subset of dispersoids.

In yet another aspect, the additive manufacturing processes disclosed herein may be a selective laser melting process where a laser is used to selectively melt an ODS feedstock powder according to a predetermined pattern. For example, the selective laser melting process may be laser powder bed fusion (L-PBF). One or more operating parameters of the selective laser melting process may be adjusted to reduce or, in some instances, prevent coarsening and/or slag formation during fabrication of a component. The operating parameters include, but is not limited to, a laser beam power, a laser spot size, and a scan speed (i.e., the speed of the laser relative to the feedstock powder). In some implementations, the laser beam power may range from about 120 W to about 250 W. In some implementations, the laser beam radius may range from about 30 μm to about 60 μm. In some implementations, the scan speed may range from about 0.8 m/s to about 1.2 m/s.

The ODS alloys and additive manufacturing processes disclosed herein may be used to make components for various applications. In one example, a component formed from the ODS alloys disclosed herein may be used in an apparatus where the component is exposed to high pressure oxygen-rich environments, such as an oxygen-rich turbopump used in an oxidizer-rich staged combustion rocket engine or a full-flow staged combustion rocket engine.

In one example implementation, an ODS alloy comprises a first concentration of nickel (Ni), a second concentration of chromium (Cr) ranging from about 15 wt % to about 25 wt %, a third concentration of yttria (Y₂O₃) ranging from about 0.1 wt % to about 1 wt %, and a fourth concentration of aluminum (Al) less than about 0.1 wt %. In some implementations, the sum of the first, second, third, and fourth concentrations equals 100 wt %. In some implementations, the alloy may further comprise strengthening alloying elements including, but not limited to, Fe (e.g., less than or equal to 8 wt %), Mo (e.g., less than or equal to 0.3 wt %), Mn (e.g., less than or equal to 1 wt %), W (e.g., less than or equal to 0.2 wt %), Co (e.g., less than or equal to 2 wt %), Nb (including Ta) (e.g., less than or equal to 5 wt %), Ti (e.g., less than or equal to 3 wt %), C (e.g., less than or equal to 2 wt %), Cu (e.g., less than or equal to 0.5 wt %), Si (e.g., less than or equal to 0.4 wt %), S (e.g., less than or equal to 0.02 wt %), and any combinations of the foregoing elements.

In another example implementation, an ODS alloy comprises: a concentration of nickel (Ni) ranging from about 65 wt % to about 90 wt %; a concentration of chromium (Cr) ranging from about 5 wt % to about 35 wt %; a concentration of yttria (Y2O3) ranging from about 0.1 wt % to about 0.5 wt %; and a concentration of aluminum (Al) less than 0.3 wt %.

In another example implementation, an ODS alloy comprises: nickel (Ni); chromium (Cr); yttria (Y2O3); and aluminum (Al), wherein the ODS alloy has a grain structure indicative of an additive manufacturing process.

In another example implementation, a method for making a component from an oxide dispersion-strengthened (ODS) alloy comprises: providing a feedstock powder, the feedstock powder including: a concentration of nickel (Ni) ranging from about 65 wt % to about 90 wt %; a concentration of chromium (Cr) ranging from about 5 wt % to about 35 wt %; a concentration of yttria (Y2O3) ranging from about 0.1 wt % to about 0.5 wt %; and a concentration of aluminum (Al) less than 0.3 wt %; and making, via an additive manufacturing process, the component from the feedstock powder; wherein the component has a grain structure including a plurality of columnar grains aligned substantially parallel with a build direction associated with the additive manufacturing process.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A shows an example rocket engine supporting a staged combustion power cycle that directs propellant into a combustion chamber.

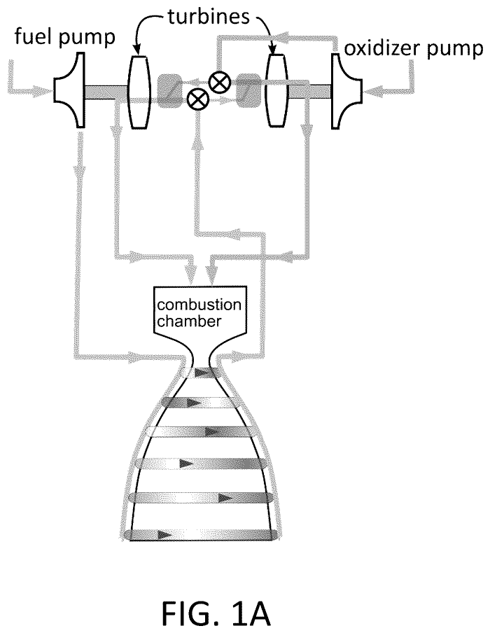

FIG. 1B shows a plot of the inlet oxygen pressure and inlet temperature for a turbopump used in conventional rocket engines and aeroengines.

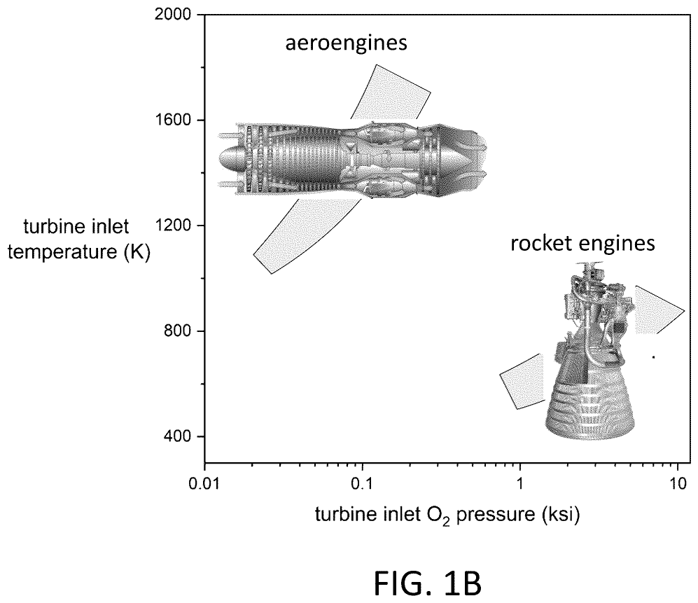

FIG. 1C shows an example oxygen-rich turbopump and illustrations of frictional ignition, which is a mechanism that can lead to metal ignition and burning.

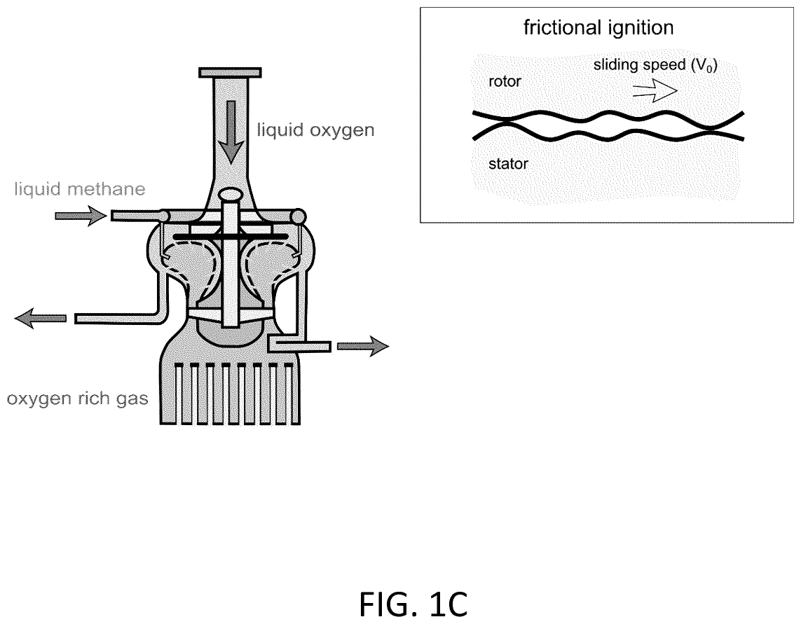

FIG. 2 shows an example oxygen dispersion-strengthened (ODS) alloy.

FIG. 3A shows an external view of an example frictional ignition rig to evaluate frictional ignition of a sample material.

FIG. 3B shows a cross-sectional view of the frictional ignition rig of FIG. 3A with an inset showing a rotating sample and a stationary sample.

FIG. 4 shows plots of (a) a room-temperature thermal conductivity (κ), (b) a room-temperature yield strength (σ_{y}), (c) a solidus temperature (Tₘ) of various materials.

FIG. 5 shows in situ time-series images of a Ni-20Cr frictional ignition event. Test conditions: v=22 m/s, L=31 N/s, PO₂=3.4 MPa.

FIG. 6 shows tabulated results from frictional ignition tests under v=22 m/s and L=31 N/s.

FIG. 7 shows the test duration plotted against Cr content. All tests results resulted in specimen ignition, except for Ni under PO2=6.9 MPa and MA754 under both pressures. Vertical arrow indicates runout of the MA754 experiments.

FIG. 8 shows the friction coefficient as a function of time under PO₂=6.9 MPa. Crosses indicate ignition. The Ni test terminated early because of excessive specimen deformation.

FIG. 9 shows the time-averaged steady-state friction coefficient as a function of Cr content.

FIG. 10 shows the interfacial temperature at the rubbing surface under PO₂=6.9 MPa as a function of time. Crosses indicate ignition.

FIG. 11 shows the peak interfacial temperature as a function of Cr content.

FIG. 12 shows the flash temperature T_{f} and bulk interfacial temperature T_{b} at the rubbing surface as a function of time for Ni-20Cr under the two different O₂ pressures.

FIG. 13 shows the axial displacement as a function of time under PO₂=6.9 MPa.

FIG. 14 shows macrographs of non-ignited samples. Test duration (tₛ), interfacial temperature (Tₚ), and contact pressure (σₘₐₓ) at test termination for the different samples are as follows: Ni (tₛ=53 s, Tₚ=1380 K, σₘₐₓ=11 MPa), Ni-20Cr (117 s, 1470 K, 23 MPa), MA754 (121 s, 1490 K, 23 MPa).

FIG. 15 shows a frictional ignition property diagram with T₀=298 K. Data points in black correspond to alloys tested.

FIG. 16 shows scanning electron microscope (SEM) micrographs of the rubbing surface on a non-ignited Ni-20Cr sample. Test conditions were PO₂=6.9 MPa, v=22 m/s, L=31 N/s. Test duration was 117 s and the peak interfacial temperature was 1470 K

FIG. 17 shows SEM micrographs of the rubbing interfaces of interrupted non-ignited samples. Test conditions: PO₂=6.9 MPa, v=22 m/s, L=31 N/s. FIGS. 18 and 21 are high-magnification views of the boxed regions in these micrographs.

FIG. 18 shows SEM micrographs of tribolayers formed during frictional ignition testing of non-ODS Ni—Cr alloys-(a) Ni, (b) Ni-20Cr, (c) Ni-20Cr, (d) Ni-30Cr. Images are high-magnification views of boxed regions in FIG. 17.

FIG. 19 shows an XRD pattern from the tribolayer on a non-ignited Ni-20Cr sample. The data was collected using a Co X-ray source.

FIG. 20 shows a predominance diagram for Ni-20Cr. The broken line indicates the expected temperature drop across the oxide tribolayer at ignition.

FIG. 21 shows SEM micrographs of tribolayers formed during frictional ignition testing of ODS Ni—Cr alloys—(a) MA754, (b) MA758. The micrographs are high-magnification views of boxed regions shown in FIG. 17.

FIG. 22 shows a scanning tunnel electron microscope (STEM) micrograph and energy dispersive X-ray spectroscopy (EDS) mapping of the metal/oxide interface in the tribolayer of MA754. The encircled arrow indicates location and direction of the EDS linescan across a grain boundary shown in FIG. 23. EDS elemental composition maps of the highlighted area are shown on the right.

FIG. 23 shows an EDS linescan across a grain boundary. The location and direction of the linescan correspond to the encircled arrow in FIG. 22.

FIG. 24 shows a SEM micrograph of the MA754 oxide tribolayer highlighting large NiCr₂O₄ islands in the NiO matrix that likely were part of a continuous Cr₂O₃ layer prior to breakaway oxidation.

FIG. 25 shows a plot of the hardness of the oxide and underlying metal near the metal/oxide interface as a function of Cr content. These specimens were tested under: PO₂=6.9 MPa, v=22 m/s, L=31N/s.

FIG. 26 shows a SEM micrograph of RAM Ni-20Cr-0.45Y₂O₃ feedstock, with inset showing micron-scale Y₂O₃ agglomerates as well as nanoscale Y₂O₃ dispersoids.

FIG. 27 shows a table of powder compositions.

FIG. 28 shows isocontours of relative density (\tilde{ρ}) from density measurements on as-printed Ni-20Cr (10 specimens) and Ni-20Cr-1Y₂O₃ (28 specimens) as functions of laser power (P) and scan speed (v) given a constant beam radius (r_{B}=20 μm), hatch spacing (η=40 μm), and layer thickness (β=20 μm). Broken lines indicate extrapolated isocontours. Higher laser powers and slower scan speeds were used to achieve full density for RAM ODS material.

FIG. 29 shows backscatter electron micrographs of (a) Ni-20Cr, (b) Ni-20Cr-0.45Y₂O₃, (c) Ni-20Cr-1Y₂O₃, and (d) Ni-20Cr-0.45Y₂O₃-1Al. The Ni-20Cr and Ni-20Cr-0.45Y₂O₃ variants are defect-free whereas the high Y₂O₃ and Al-rich variants contain micron-scale slag inclusions.

FIG. 30 shows (a) a STEM HAADF micrograph of Ni-20Cr-0.45Y₂O₃. The dense dislocation network obscures dispersoids smaller than ˜10 nm. (b) STEM EDS measurements of a nanoscale Y₂O₃ dispersoid.

FIG. 31 shows the dispersoid composition vs. diameter for ODS alloys with varying Al content. The dispersoids were only slightly Al enriched in the 0.3 wt % Al alloy, whereas the Al content increased with dispersoid size in the 1 wt % Al alloy.

FIG. 32 shows a SANS spectrum from L-PBF Ni-20Cr-0.45Y₂O₃ (P=140 W, v=1.2 m/s).

FIG. 33 shows the dispersoid size distribution in Ni-20Cr-0.45Y₂O₃ (P=140 W, v=1.2 m/s). The SANS size distribution is compared to STEM stereological measurements collected here and on a similar alloy.

FIG. 34 shows dispersoid size distributions in alloys with varying Y₂O₃ and Al content (P=140 W, v=1.2 m/s), showing an increase in mean dispersoid size with alloying additions.

FIG. 35 shows dispersoid size distributions in Ni-20Cr-0.45Y₂O₃ printed (a) with varying scan speed but fixed power (140 W), and (b) with varying power but fixed scan speed (1.2 m/s). The dispersoid size distribution of wrought MA754 is included to allow comparison to a conventional ODS material of similar composition.

FIG. 36 shows L-PBF process diagram for Ni-base ODS alloys, with axes of dimensionless beam power (\tilde{P}) and scan speed (\tilde{v}). Labels indicate mean dispersoid size. Isocontours of relative density from FIG. 28 are overlaid.

FIG. 37 shows dimensionless numbers that characterize momentum and mass transport as a function of dispersoid size d. These parameters indicate that nanoscale oxide dispersoids smaller than 1 μm experience creeping flow and grow through diffusion-mediated mass transport mechanisms.

FIG. 38 shows a table of thermophysical inputs to the scaling analysis and dissolution zone model. Ranges are given for temperature-dependent properties.

FIG. 39 shows the modeling framework for predicting final dispersoid size and slag formation.

FIG. 40 shows time-series images from a CFD simulation of the melt pool during L-PBF of Ni-20Cr with laser parameters P=140 W, v=1.2 m/s, and r_{B}=20 μm. The colored spheres are tracer particles for extracting the time-temperature profile of fluid elements within the melt pool.

FIG. 41 shows (a) thermal excursions and (b) resulting Y₂O₃ solubility following Eq. 3.9 for tracer particles shown in FIG. 40 (P=140 W, v=1.2 m/s).

FIG. 42 shows temperature-dependent concentrations of Y₂O₃ and Y₃Al₅O₁₂ in liquid Ni. Broken lines indicate where the oxide is molten. The solubility curve of YAlO₃ is essentially the same as that of Y₃Al₅O₁₂. The shaded region indicates the temperature window bounded by the melting and boiling temperatures of Ni-20Cr. The dissolution temperatures (T_{dis}) of 0.2 at % Y₂O₃ and 0.53 at % Y₃Al₅O₁₂ are 2080 K and 2095 K, as indicated by the vertical lines.

FIG. 43 shows the ratio of dispersoid diameter after dissolution (d) to initial oxide diameter (d₀) as a function of initial dispersoid size for the thermal excursions shown in FIG. 41 (P=140 W, v=1.2 m/s).

FIG. 44 shows the final dispersoid (a) size (d_{f}) and (b) number density (N) at the center of the melt track shown in FIG. 40 (P=140 W, v=1.2 m/s) as a function of oxide-melt interfacial energy γ_{SL}.

FIG. 45 shows the evolution of dispersoid (a) size (d) and (b) number density (N) over the thermal excursions from FIG. 41, assuming an initial dispersoid diameter d₀=100 nm. Solid lines show the evolution of pure Y₂O₃ while broken lines show the evolution of Y₃Al₅O₁₂, formed through reactions between Y₂O₃ and Al while dissolved in the melt.

FIG. 46 shows the simulated melt track cross-section for P=140 W, v=1.2 m/s. The shading indicates the final dispersoid size after single-pass melting given initial dispersoid diameters d₀ of (a) 10 nm, (b) 100 nm, and (c) 1 μm. The cross-hatched region indicates unmelted material.

FIG. 47 shows the melt track cross-section for P=140 W, v=1.2 m/s. Dissolution zones for varying oxide diameters are overlaid. Labels indicate the largest oxide size that will be dissolved within the dissolution zone.

FIG. 48 shows the dissolution zone coverage for different combinations of laser power and initial oxide size. Increasing laser power and decreasing initial oxide size result in greater dissolution zone coverage.

FIG. 49 shows a comparison between (a) SEM observations of slag inclusions in L-PBF NiCoCr-1Y₂O₃ printed using a previous process with increased hatch spacing vs (b) dissolution zone model predictions of slag retention zones with d₀=200 nm or d₀=1 μm.

FIG. 50 shows a comparison between (a) SEM observation of slag inclusions in L-PBF Ni-8Cr-5.5Al-1Ti-0.5Y₂O₃ and (b) the dissolution zone model prediction.

FIG. 51 shows a processing diagram overlaid with solid isocontours for predicted final dispersoid diameter and dispersoid number density given a retained Y₂O₃ concentration of 0.16 wt %. Experimental parameter sets are labeled with SANS measurements of dispersoid diameter. Red isocontours are bounds for slag-free printing given the initial Y₂O₃ size indicated on the contour. Parameter sets towards the upper left are least prone to slag.

FIG. 52 shows the effects of Y₂O₃ and Al concentration on final dispersoid size. Solid lines are isocontours of predicted dispersoid diameter. Broken lines are isocontours of oxide composition, assuming full reaction between Al and Y₂O₃.

FIG. 53 shows (a) a schematic velocity field within the melt pool. (b-c) CFD calculations of the velocity field, viewed (b) along the symmetry plane and (c) transverse to the scan direction.

FIG. 54 shows a ratio of oxide dissolution and melting timescales vs. temperature. t_{dis}/tₘₑₗₜ is much greater than unity above the oxide melting temperatures of Y₂O₃ (2711 K) and Y₃Al₅O₁₂ (2196 K).

FIG. 55 shows a table of parameters used in Eqs. 3.30-3.33 to transform the thermal excursion given by Eq. 3.17.

FIG. 56 shows a comparison between thermal excursions predicted by CFD and by the reduced order model for (a) the exemplary parameter set shown in FIG. 41 and (b-e) four parameter sets at the extremes of the viable L-PBF processing envelope. The reduced order model is generally in good agreement with the CFD predictions.

### DETAILED DESCRIPTION

Following below are more detailed descriptions of various concepts related to, and implementations of, oxide dispersion-strengthened (ODS) alloys and processes for forming ODS alloys using additive manufacturing. It should be appreciated that various concepts introduced above and discussed in greater detail below may be implemented in multiple ways. Examples of specific implementations and applications are provided primarily for illustrative purposes so as to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

In the discussion below, various examples of inventive ODS alloys and additive manufacturing processes to fabricate components from the ODS alloys are provided, wherein a given example or set of examples showcases one or more compositions of ODS alloys and/or operating parameters of an additive manufacturing process (e.g., laser powder bed fusion), such as laser beam power, laser spot size, and scan speed. It should be appreciated that one or more features discussed in connection with a given example of an ODS alloy or additive manufacturing process may be employed in other respective examples of ODS alloys and additive manufacturing processes according to the present disclosure, such that the various features disclosed herein may be readily combined in a given ODS alloy or additive manufacturing process according to the present disclosure (provided that respective features are not mutually inconsistent).

Certain dimensions and parameters of the ODS alloy and the additive manufacturing processes used to form components from the ODS alloy are described herein using the terms “approximately,” “about,” “substantially,” and/or “similar.” As used herein, the terms “approximately,” “about,” “substantially,” and/or “similar” indicates that each of the described dimensions or features is not a strict boundary or parameter and does not exclude functionally similar variations therefrom. Unless context or the description indicates otherwise, the use of the terms “approximately,” “about,” “substantially,” and/or “similar” in connection with a numerical parameter indicates that the numerical parameter includes variations that, using mathematical and industrial principles accepted in the art (e.g., rounding, measurement or other systematic errors, manufacturing tolerances, etc.), would not vary the least significant digit.

### 1. EXAMPLE OXIDE DISPERSION-STRENGTHENED (ODS) ALLOYS FOR ADDITIVE MANUFACTURING

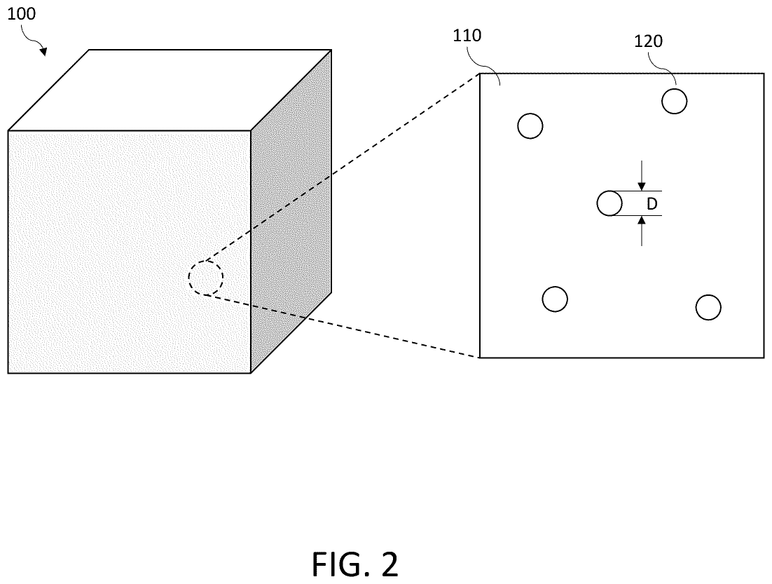

FIG. 2 shows a schematic ODS alloy 100 according to the inventive implementations disclosed herein. As shown, the ODS alloy 100 includes a matrix 110 with dispersoids 120 distributed throughout the matrix 110. The matrix 110 may be formed of a metal or a metallic alloy and the dispersoids 120 may be formed of an oxide material (e.g., a refractory material). The dispersoids 120 may further be inert in the sense that the dispersoids 120 do not react with any other materials to form another compound. The ODS alloy 100 may appreciably reduce the likelihood of frictional ignition or, in some instances, may be resistant to frictional ignition. This may be accomplished, in part, by the ODS alloy 100 forming an oxide tribolayer at its surface when subjected to a frictional force (e.g., when a component formed from the ODS alloy 100 rubs against another component).

The oxide tribolayer may protect the surface of the ODS alloy 100 from frictional ignition, in part, by decreasing the friction coefficient and/or preventing further oxidation of the ODS alloy 100. The inclusion of the dispersoids 120 may further increase the resistance of the ODS alloy 100 to frictional ignition. For example, the dispersoids 120 may pin the grain boundaries of the metallic material beneath the tribolayer, resulting in a fine recrystallized region that promotes the growth of a fine-grained oxide tribolayer. This, in turn, accelerates tribolayer growth through short circuit diffusion and leads to a thicker oxide tribolayer compared to materials without dispersoids. As a result, the dispersoids 120 may further decrease the friction coefficient, increase the ignition temperature, and/or suppress ignition by accelerating the growth of the protective tribolayer. Additionally, the dispersoids 120 may enhance interfacial toughness through dispersoid pegging and mitigate plastic deformation of the underlying metal through dispersion-strengthening.

In some implementations, the ODS alloy 100 may be a nickel-based alloy. For example, the ODS alloy 100 may comprise nickel (Ni), chromium (Cr), and yttria (Y₂O₃). In this example, the matrix 110 may be formed of an alloy of Ni and Cr and the dispersoids 120 may be formed of Y₂O₃. In another example, the ODS alloy 100 may comprise Ni, Cr, Y₂O₃, and aluminum (Al). In this example, the matrix 110 may be formed of an alloy of Ni and Cr and the dispersoids 120 may be formed of Y₂O₃ and Al.

Various concentrations of Ni are also contemplated herein. In one example, the concentration of Ni may range from about 65 wt % to about 90 wt %, including all values and sub-ranges in between. In another example, the concentration of Ni may range from about 75 wt % to about 85 wt %, including all values and sub-ranges in between. In yet another example, the concentration of Ni may be about 75 wt %, 76 wt %, 77 wt %, 78 wt %, 79 wt %, 80 wt %, 81 wt %, 82 wt %, 83 wt %, 84 wt %, or 85 wt %. More generally, the concentration of Ni may constitute the remainder of the ODS alloy 100. Said another way, the concentration of Ni may equal to the difference between 100 wt % and the sum of the concentrations of all other constituent elements in the ODS alloy 100.

Various concentrations of Cr are contemplated herein. In one example, the concentration of Cr may range from about 5 wt % to about 35 wt %, including all values and sub-ranges in between. In another example, the concentration of Cr may range from about 15 wt % to about 25 wt %, including all values and sub-ranges in between. In yet another example, the concentration of Cr may be about 15 wt %, 16 wt %, 17 wt %, 18 wt %, 19 wt %, 20 wt %, 21 wt %, 22 wt %, 23 wt %, 24 wt %, or 25 wt %.

Various concentrations of Y₂O₃ are also contemplated herein. In one example, the concentration of Y₂O₃ may range from about 0.1 wt % to about 1 wt %, including all values and sub-ranges in between. In another example, the concentration of Y₂O₃ may range from about 0.1 wt % to about 0.5 wt %, including all values and sub-ranges in between. In yet another example, the concentration of Y₂O₃ may range from about 0.5 wt % to about 1 wt %, including all values and sub-ranges in between. In yet another example, the concentration of Y₂O₃ may range from about 0.3 wt % to about 0.7 wt %, including all values and sub-ranges in between. In yet another example, the concentration of Y₂O₃ may be equal to about 0.1 wt %, 0.2 wt %, 0.3 wt %, 0.4 wt %, 0.5 wt %, 0.6 wt %, 0.7 wt %, 0.8 wt %, 0.9 wt %, or 1 wt %.

If Al is present in the ODS alloy 100, the Al may react with Y₂O₃ to form a low melting point Y—Al oxide. This oxide may promote coarsening and/or slag formation. Thus, in implementations where Al is present in the ODS alloy 100, the concentration of Al may be kept sufficiently low to reduce or, in some instances, mitigate undesirable reactions with Y₂O₃. In one example, the concentration of Al may be less than 0.3 wt %, including all values and sub-ranges in between. In another example, the concentration of Al may be less than about 0.1 wt %, including all values and sub-ranges in between. In yet another example, the concentration of Al may be equal to about 0.1 wt %, 0.15 wt %, 0.2 wt %, or 0.25 wt %.

In addition to the foregoing, the ODS alloy 100 may further comprise one or more strengthening elements. For example, the ODS alloy 100 may include iron (Fe), molybdenum (Mo), manganese (Mn), tungsten (W), cobalt (Co), niobium (Nb), tantalum (Ta), titanium (Ti), carbon (C), copper (Cu), silicon (Si), and/or sulfur(S). For example, the ODS alloy 100 may further comprise a concentration of Ti ranging from about 0.3 wt % to about 0.7 wt %, including all values and sub-ranges in between.

It should be appreciated that the ODS alloy 100 may include any combination of the constituent elements disclosed herein and the respective concentrations and/or concentration ranges. Furthermore, the term “about,” when used to describe the concentration of elemental constituents in the ODS alloy 100, is intended to cover any variations in composition that may arise during manufacture. For example, “about 1 wt %” may correspond to the following ranges: 0.95 wt % to 1.05 wt % (+/−5% variation), 0.98 wt % to 1.02 wt % (+/−2% variation), 0.99 wt % to 1.01 wt % (+/−1% variation), 0.992 wt % to 1.008 wt % (+/−0.8% variation), 0.994 wt % to 1.006 wt % (+/−0.6% variation), 0.996 wt % to 1.004 wt % (+/−0.4% variation), or 0.998 wt % to 1.002 wt % (+/−0.2% variation), including all values and sub-ranges in between.

The ODS alloys disclosed herein may be formed using an additive manufacturing (AM) process. In particular, a selective laser melting process, such as laser powder bed fusion (L-PBF) or directed energy deposition (DED), may be used to additively manufacture components from the ODS alloy 100 as described in further detail below. During fabrication, a feedstock powder containing constituent elements of the ODS alloy 100 may be melted to form the ODS alloy 100 with the matrix 110 and the dispersoids 120.

The ODS alloy 100 may have a grain structure indicative of the AM process, such as L-PBF. For example, the grain structure may be a columnar grain structure comprising a plurality of columnar grains. The columnar grains may generally have an elongated shape characterized by a length corresponding to the relatively longer dimension of the grain and a width corresponding to the relatively shorter dimension of the grain. It should be appreciated that the depth of each grain may be equal or substantially equal to the width. In some implementations, the ratio of the length to the width may range from about 3 to about 20, including all sub-ranges and values in between. In some implementations, the length of the columnar grains may range from about 10 μm to about 500 μm, including all sub-ranges and values in between. The term “about,” when used to describe the dimensions or a ratio of dimensions associated with the columnar grains of the ODS alloy 100, is intended to cover, for example, the relative error in measuring the dimensions of the grains, and/or any variations that may arise during manufacture. For example, “about 10 μm” may correspond to the following ranges: 9.5 μm to 10.5 μm (+/−5% variation), 9.8 μm to 10.2 μm (+/−2% variation), 9.9 μm to 10.1 μm (+/−1% variation), 9.92 μm to 10.08 μm (+/−0.8% variation), 9.94 μm to 10.06 μm (+/−0.6% variation), 9.96 μm to 10.04 μm (+/−0.4% variation), or 9.98 μm to 10.02 μm (+/−0.2% variation), including all values and sub-ranges in between.

In some implementations, the columnar grains may be oriented substantially parallel to a build direction. The build direction may correspond to a direction along which layers of the ODS alloy are deposited. The build direction may be perpendicular to a deposition direction, i.e., a direction along which a single layer of the ODS alloy is deposited. In one non-limiting example, the deposition direction may correspond to a horizontal axis and the build direction may correspond to a vertical axis. The term “substantially,” when used to describe the alignment of the columnar grains of the ODS alloy 100 with respect to a build direction, is intended to cover variations in grain formation that may cause some grains to deviate in direction with respect to the build direction. For example, “substantially parallel” may correspond to an angular deviation ranging from 0 degrees (i.e., the columnar grain is parallel to the build direction) to about 40 degrees, including any sub-ranges or values in between.

The AM process may further distribute the dispersoids 120 throughout the matrix 110 in the ODS alloy 100. In some implementations, the dispersoids 120 may be distributed uniformly throughout the matrix 110 in the formed ODS alloy 100. Said another way, the number density of the dispersoids 120 per unit volume may not vary appreciably across the ODS alloy 100. In some implementations, the number density of the dispersoids 120 per unit volume may vary less than 50% across the ODS alloy 100. In some implementations, the number density of the dispersoids 120 per unit volume may vary less than 30% across the ODS alloy 100.

The dispersoids 120 may generally vary in shape. For example, the dispersoids 120 may be spherical in shape particularly for smaller-sized dispersoids 120. Accordingly, the size of the dispersoids 120 may be characterized by a diameter. In another example, the dispersoids 120 may have a non-spherical and/or irregular shape particularly for larger-sized dispersoids 120. Here, the diameter of the dispersoids 120 may correspond, for example, to the largest diameter of the dispersoid 120, or a mean diameter of the dispersoid 120 based on multiple measurements of diameter along different directions.

The dispersoids 120 may generally vary in size. Said another way, the dispersoids 120 may have a size distribution where the number density of dispersoids 120 of a particular size spans a range of sizes within the ODS alloy 100. According to the inventive implementations disclosed herein, the dispersoids 120 in the ODS alloy 100 formed via an AM process may have dimensions smaller than previous ODS alloys formed by an AM process and/or comparable to or, in some instances, better than conventional wrought ODS alloys. For example, the mean diameter of the dispersoids 120 may be less than or equal to about 30 nm, including all values and sub-ranges in between. In another example, the mean diameter of the dispersoids 120 may be less than or equal to about 25 nm, including all values and sub-ranges in between. In yet another example, the mean diameter of the dispersoids 120 may be less than or equal to about 20 nm, including all values and sub-ranges in between.

The term “about,” when used to describe the dimensions of the dispersoids 120, is intended to cover variations across the multiple dispersoids 120 present in the ODS alloy 100. For example, “about 20 nm” may correspond to the following ranges: 19 nm to 21 nm (+/−5% variation), 19.6 nm to 20.4 nm (+/−2% variation), 19.8 nm to 20.2 nm (+/−1% variation), or 19.9 nm to 20.1 nm (+/−0.5% variation), including all values and sub-ranges in between.

The relative number of dispersoids 120 having smaller dimensions may also be appreciably increased in the ODS alloys disclosed herein. For example, the dispersoids 120 may be divided between a first subset of dispersoids 120 having a mean diameter less than or equal to a threshold diameter and a second subset of dispersoids 120 having a mean diameter greater than the threshold diameter. The number density of the first subset of dispersoids may be greater than the number density of the second subset of dispersoids.

In some implementations, the number density of the dispersoids 120 may be greater than or equal to about 600 μm⁻³. In some implementations, the number density of the dispersoids 120 may be greater than or equal to about 2000 μm⁻³. For reference, a number density of 2000 μm⁻³ is typical for wrought ODS alloys, such as MA754. Accordingly, the number density of the dispersoids 120 for the ODS alloy 100 may be similar to or greater than a wrought ODS alloy of the same composition.

The term “about,” when used to describe the number density of the dispersoids 120, is intended to cover variations across the multiple dispersoids 120 present in the ODS alloy 100. For example, “about 2000 μm⁻³” may correspond to the following ranges: 1900 μm⁻³ to 2100 μm⁻³ (+/−5% variation), 1960 μm⁻³ to 2040 μm⁻³ (+/−2% variation), 1980 μm⁻³ to 2020 μm⁻³ (+/−1% variation), or 1990 μm⁻³ to 2010 μm⁻³ (+/−0.5% variation), including all values and sub-ranges in between. Additionally, the dimensions and number density of the dispersoids 120 may correspond to values obtained from small angle neutron scattering (SANS).

In some implementations, the formation of slag in the ODS alloys 100 disclosed herein may be mitigated during formation via an AM process. In other words, the ODS alloys 100 disclosed herein may be slag free. In some implementations, the ODS alloy 100 may include slag, but the size of the slag particles may nevertheless remain small. For example, the slag particles may not have a diameter greater than about 0.5 μm, 0.6 μm, 0.7 μm, 0.8 μm, 0.9 μm, 1 μm, 1.5 μm, 2 μm, 2.5 μm, or 5 μm.

The ODS alloys disclosed herein may be used to form components via an AM process, such as a selective laser melting process (e.g., L-PBF, DED). For example, L-PBF involves using a feedstock powder comprising the constituent elements to form the ODS alloy. During fabrication, a laser may illuminate the feedstock powder to selectively melt a portion of the feedstock powder to form the ODS alloy. Said another way, the laser may sufficiently heat the portion of feedstock powder to a temperature greater than the melting point of the feedstock powder, thus forming a localized pool of molten metal.

The laser may move relative to the feedstock powder according to a predetermined pattern to form a component with a desired geometry. Additionally, components may be formed in layers. For example, the laser may move across the surface of a feedstock powder to form a first layer of the component. Thereafter, additional feedstock powder may be deposited onto the first layer. The laser may then move across the surface of the deposited feedstock powder to form a second layer of the component. These processes may be repeated until all the layers of the component are formed.

For the ODS alloys disclosed herein, the operating parameters of the additive manufacturing process (e.g., L-PBF, DED) may affect the coarsening of dispersoids and the formation of slag. These operating parameters include, but are not limited to, the laser beam power, the laser beam spot size, the scan speed of the laser speed relative to the feedstock powder, the thickness of the layer formed during fabrication, the hatch spacing, and the melt time associated with the AM process. For the ODS alloys disclosed herein, a higher intensity (i.e., ratio of power to beam spot size) and/or a slower scanning speed may be preferable to achieve full density. In some implementations, the ODS alloys disclosed herein may be formed using an EOS M100 LPBF printer or an EOS M290 printer. In the following, several example ranges and values for the foregoing operating parameters are provided. It should be appreciated that the AM process may incorporate any combination of the foregoing ranges and values for the foregoing operating parameters. For instance, in one non-limiting example, the AM process may include the following operating parameter values: a layer thickness equal to 40 microns, a hatch spacing equal to 60 microns, a beam power equal to 200 W, and a scan speed equal to about 1 m/s.

With respect to the beam power, in one example the beam power may range from about 100 W to about 250 W, including all values and sub-ranges in between. In another example, the beam power may range from about 120 W to about 250 W, including all values and sub-ranges in between. In another example, the beam power may range from about 160 W to about 270 W, including all values and sub-ranges in between. In yet another example, the beam power may be equal to about 120 W, about 130 W, about 140 W, about 150 W, about 160 W, about 170 W, about 180 W, about 190 W, about 200 W, about 210 W, about 220 W, about 230 W, about 240 W, or about 250 W.

The term “about,” when used to describe the laser beam power, is intended to cover variations in power output during operation. For example, “about 150 W” may correspond to the following ranges: 142.5 W to 157.5 W (+/−5% variation), 147 W to 153 W (+/−2% variation), 148.5 W to 151.5 W (+/−1% variation), or 149.25 W nm to 150.75 W (+/−0.5% variation), including all values and sub-ranges in between.

With respect to the spot size, in one example the beam radius may range from about 30 μm to about 60 μm, including all values and sub-ranges in between. In another example, the beam radius may range from about 35 μm to about 45 μm, including all values and sub-ranges in between. In yet another example, the beam radius may be equal to about 35 μm, about 36 μm, about 37 μm, about 38 μm, about 39 μm, about 40 μm, about 41 μm, about 42 μm, about 43 μm, about 44 μm, about 45 μm, about 46 μm, about 47 μm, about 48 μm, about 49 μm, about 50 μm, about 51 μm, about 52 μm, about 53 μm, about 54 μm, about 55 μm, about 56 μm, about 57 μm, about 58 μm, about 59 μm, or about 60 μm.

The term “about,” when used to describe the laser beam radius, is intended to cover variations in beam radius during setup of the AM system and/or operation. For example, “about 40 μm” may correspond to the following ranges: 38 μm to 42 μm (+/−5% variation), 39.2 μm to 40.8 μm (+/−2% variation), 39.6 μm to 40.4 μm (+/−1% variation), or 39.8 μm to 40.2μ m (+/−0.5% variation), including all values and sub-ranges in between.

With respect to the scan speed, in one example the scan speed may range from about 0.5 m/s to about 1.5 m/s, including all values and sub-ranges in between. In another example, the scan speed may range from about 0.8 m/s to about 1.2 m/s, including all values and sub-ranges in between. In yet another example, the scan speed may be equal to about 0.8 m/s, about 0.9 m/s, about 1 m/s, about 1.1 m/s, or about 1.2 m/s.

The term “about,” when used to describe the laser scan speed, is intended to cover variations in the scan speed during operation. For example, “about 1 m/s” may correspond to the following ranges: 0.95 m/s to 1.05 m/s (+/−5% variation), 0.98 m/s to 1.02 m/s (+/−2% variation), 0.99 m/s to 1.01 m/s (+/−1% variation), or 0.995 m/s to 1.005 m/s (+/−0.5% variation), including all values and sub-ranges in between.

With respect to the hatch spacing, in one example the hatch spacing may range from about 60 μm to about 100 μm, including all values and sub-ranges in between. In another example, the scan speed may be equal to about 60 μm, about 65 μm, about 70 μm, about 75 μm, about 80 μm, about 85 μm, about 90 μm, about 95 μm, about 100 μm.

The term “about,” when used to describe the hatch spacing, is intended to cover variations in the hatch spacing during setup of the AM system and/or operation. For example, “about 100 μm” may correspond to the following ranges: 95 μm to 105 μm (+/−5% variation), 98 μm to 102 μm (+/−2% variation), 99 μm to 101 μm (+/−1% variation), or 99.5 μm to 100.5 μm (+/−0.5% variation), including all values and sub-ranges in between.

With respect to the thickness of each layer of a component formed during one pass of the laser illuminating the feedstock powder, in one example the thickness of the layer may range from about 10 μm to about 50 μm, including all values and sub-ranges in between. In another example, the thickness may range from about 10 μm to about 40 μm, including all values and sub-ranges in between. In another example, the thickness may range from about 15 μm to about 25 μm, including all values and sub-ranges in between. In yet another example, the thickness may be equal to about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, about 31 μm, about 32 μm, about 33 μm, about 34 μm, about 35 μm, about 36 μm, about 37 μm, about 38 μm, about 39 μm, or about 40 μm.

The term “about,” when used to describe the thickness of the layer(s) used to form a component, is intended to cover variations during manufacture. For example, “about 20 μm” may correspond to the following ranges: 19 μm to 21 μm (+/−5% variation), 19.6 μm to 20.4 μm (+/−2% variation), 19.8 μm to 20.2 μm (+/−1% variation), or 19.9 μm to 20.1 μm (+/−0.5% variation), including all values and sub-ranges in between.

The melt time may be defined as the ratio of the diameter of the melt pool formed in the feedstock powder by the laser and the scan speed. The extent to which the dispersoids 120 coarsen and/or slag forms generally increases with longer melt times. Thus, it is often preferable to use an AM process with a relatively short melt time. For example, the diameter of the metal pool may be about 0.4 mm. In one example, the melt time may be less than about 1 millisecond (ms), including all values and sub-ranges in between. In another example, the melt time may range from about 0.25 milliseconds (ms) to about 0.8 ms, including all values and sub-ranges in between. In yet another example, the melt time may range from about 0.3 ms to about 0.5 ms, including all values and sub-ranges in between. In yet another example, the melt time may be equal to about 0.3 ms, about 0.35 ms, about 0.4 ms, or about 0.45 ms.

Various methods of forming a component from the ODS alloys disclosed herein using an AM process are contemplated. In one non-limiting example, a method for making a component from an ODS alloy comprises the following steps: (A) providing a feedstock powder where the feedstock comprises: a concentration of Ni ranging from about 70 wt % to about 90 wt %; a concentration of Cr ranging from about 10 wt % to about 30 wt %; a concentration of Y₂O₃ ranging from about 0.1 wt % to about 1 wt %; and a concentration of Al less than about 0.3 wt %; and (B) making, via an additive manufacturing process, the component from the feedstock powder.

As described above, the ODS alloys disclosed herein provide appreciable frictional ignition resistance. Additionally, the ODS alloys may readily be used to form components via an AM process. The combination of these features may allow more complex-shaped components to be readily formed from ODS alloys for a variety of applications. In one non-limiting example, the ODS alloys disclosed herein can be used to form one or more components in an oxygen-rich turbopump including, but not limited to, a preburner, a turbine, a nozzle, a casing, a housing, a shaft, a turbine blade, and the like. The components may operate in an environment where the temperature ranges from about 50 K to about 1200 K and/or the oxygen pressure ranges from about 1 atm to about 1200 atm. In some implementations, the turbopump may be incorporated into a rocket engine, such as an oxidizer-rich staged combustion rocket engine, or a full-flow staged combustion rocket engine. More generally, a rocket engine (e.g., an oxidizer-rich staged combustion rocket engine, or a full-flow staged combustion rocket engine) may include one or more components formed from the ODS alloys disclosed herein.

### 2. FRICTIONAL IGNITION OF ODS ALLOYS IN HIGH-PRESSURE OXYGEN ENVIRONMENTS

This section discloses experimental and theoretical analysis on the tribological phenomena that give rise to ignition-resistance in the ODS alloys disclosed herein. Specifically, the effects of Cr content and Y₂O₃ dispersoids on frictional ignition-resistance are evaluated through systematic frictional ignition experiments (i.e., high-speed sliding experiments in high-pressure oxygen) on binary Ni—Cr alloys as well as two ODS alloys, MA754 and MA758. The experimental results were combined with finite element simulations of frictional heating to determine ignition temperatures.

Structural characterization of the rubbing surfaces on recovered non-ignited samples revealed oxide tribolayers that formed in situ during sliding. An order of magnitude drop in friction coefficient during the early stages of sliding resulted from tribolayer growth. An abrupt increase in friction coefficient that preceded ignition was linked to tribolayer breakdown, which exposed the hot underlying metal to high-pressure oxygen. The oxide dispersion-strengthened alloy MA754 was the only material that did not ignite under any test conditions. Its specific content of Cr and Y₂O₃ dispersoids synergistically promote rapid growth of a thick, adherent oxide tribolayer strengthened by refractory Ni₂CrO₄ precipitates. These features collectively mitigate tribolayer breakdown, suppressing ignition. The present results highlight the importance of tribolayer stability in frictional ignition resistance and suggest alloy design strategies for tailoring oxidational wear behaviors to achieve intrinsically ignition-resistant materials.

### 2.1 Methods

### 2.1.1 Frictional Ignition Experiments

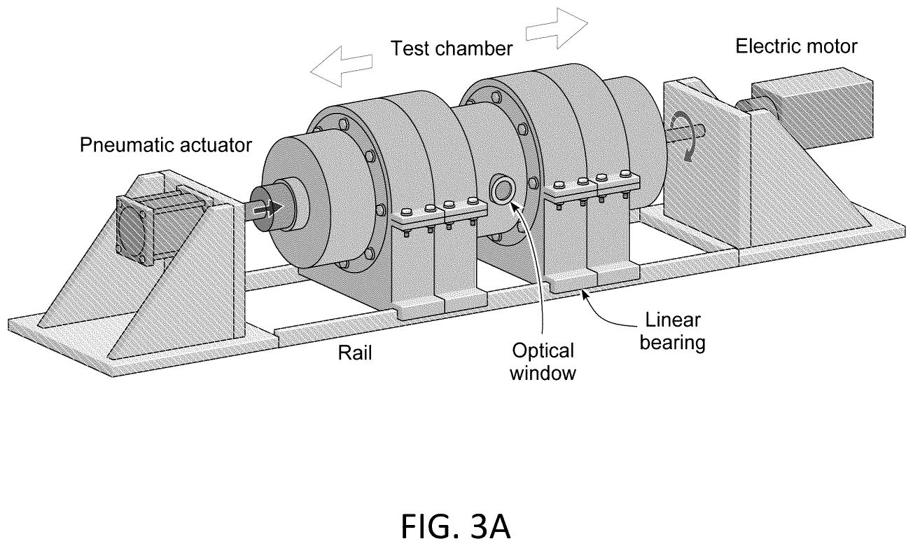

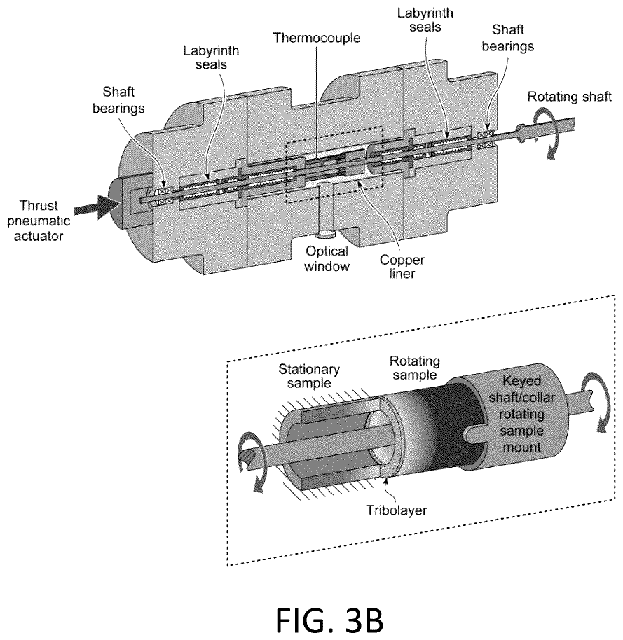

Frictional ignition experiments were performed using a specialized rig depicted in FIGS. 3A and 3B. During testing, a pair of identical cylindrical specimens (height=2.54 cm, outer diameter=2.54 cm, wall thickness=2.54 mm) were rubbed against the flat mating surface highlighted in FIGS. 3A and 3B. One sample (stator) was held fixed. The other (rotor) was attached to a shaft driven by an induction motor. The axial deformation of the specimens was measured with 10 nm accuracy using a laser displacement sensor. Frictional forces at the rubbing interface were measured using the torque-producing current output from the motor and accounting for losses at the labyrinth seals. The specimens were imaged in situ through a viewport using a high-speed camera with a 10 kHz frame rate. Ignition was detected by rapid excursions in axial displacement or gas pressure.

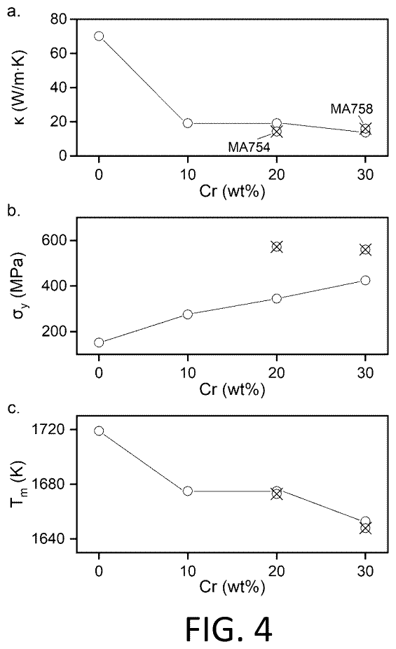

Tests were run on binary Ni—Cr alloys as well as two ODS alloys-MA754 (Ni-20Cr-0.3Al-1.0Fe-0.5Ti-0.6Y₂O₃, wt %) and MA758 (Ni-30Cr—Al-1.0Fe-0.5Ti-0.6Y₂O₃, wt %). The nominal purities of Ni and the Ni—Cr alloys were 99.6% and 99.9%. FIG. 4 shows the room-temperature thermal conductivity (κ), room-temperature yield strength (σ_{y}), and solidus temperature (Tₘ) of these materials. Prior to testing, the specimens were cleaned following ASTM G93-03. Ignition behaviors were assessed in dry O₂ under gas pressures of 3.4 and 6.9 MPa. All tests used a shaft speed of 17000 rpm, corresponding to a linear sliding speed (v) of 22 m/s. The contact load (L) was ramped linearly with time at 31 N/s, corresponding to 101 kPa/s. At the end of each test, the samples were immediately separated, rotation was stopped, and the test chamber was purged with N₂.

### 2.1.2 Tribolayer Characterization

Recovered specimens were inspected visually and with optical and electron microscopy. X-ray diffraction using a Co X-ray source was used to determine the phases at the rubbing interface. Non-ignited samples were mounted, cross-sectioned, mechanically polished, and imaged using a scanning electron microscope (SEM) equipped with energy dispersive X-ray spectroscopy (EDS). The hardness near the rubbing interface was characterized using nanoindentation with a diamond Berkovich tip under a fixed maximum load of 10 mN.

The rubbing surface of MA754 was imaged using scanning transmission electron microscopy (STEM). STEM lamella specimens were prepared using the focused ion beam (FIB) liftout technique. Decreasing ion beam energies of 30 kV, 16 kV, and 5 kV were used to thin the lamella. Final milling was performed at energies of 0.3 kV and 0.1 kV using an Ar ion mill to remove any Ga ion damage. STEM images were acquired with a probe-corrected Thermo Fisher Scientific Themis Z S/TEM using a probe convergence semi-angle of 18.8 mrad. STEM EDS was performed using a Thermo Fisher Scientific Super X detector using a beam current of 200 pA and processed using the Thermo Fisher Scientific Velox software.

### 2.1.3 Computational Modeling

Experimental measurements of friction coefficient and contact load were used in finite element simulations to compute the interfacial temperature at the rubbing surface. The simulations were carried out using COMSOL Multiphysics® software. The thermal conductivity and volumetric heat capacity of the alloys and O₂ gas were functions of temperature. Temperature-dependent properties were obtained over a given temperature range and linearly extrapolated for temperatures outside this range.

The simulation domain was assigned an initial temperature of 298 K. Frictional heating was modeled as a heat flux boundary condition (q) at the rubbing interface:

$$q = α μ P ω r \qquad ( 2.1 )$$

where ω is angular speed (1780 rad/s), r is radial distance, P is contact pressure, and a is the heat partition coefficient. Heat flux from the frictional heating was equally divided between the rotor and stator, i.e., α=0.5. The time-dependent friction coefficient was calculated using:

$${μ}_{fit} = a {e}^{- \frac{t}{τ}} + {μ}_{ss} \qquad ( 2.2 )$$

where α and τ are material-dependent constants, and μₛₛ is the steady-state friction coefficient. This function was fitted to the experimental friction coefficient data of each material. The simulations did not include enthalpy of oxidation because its effect on interfacial heating is negligible prior to ignition. The side surfaces of the simulation domain (i.e., the inner walls of the pressure vessel) were assigned fixed temperature boundary conditions (T=298 K) because of the large thermal mass of the MK500 pressure vessel.

Thermochemical calculations of alloy oxidation were carried out using the FactSage software with FTOxid, FactPS, and FSsteel databases. These calculations were used to corroborate the EDS and X-ray measurements, providing additional insight into phase equilibria at the rubbing interface.

### 2.2 Experimental Results and Discussion

### 2.2.1 Summary of Frictional Ignition Behaviors

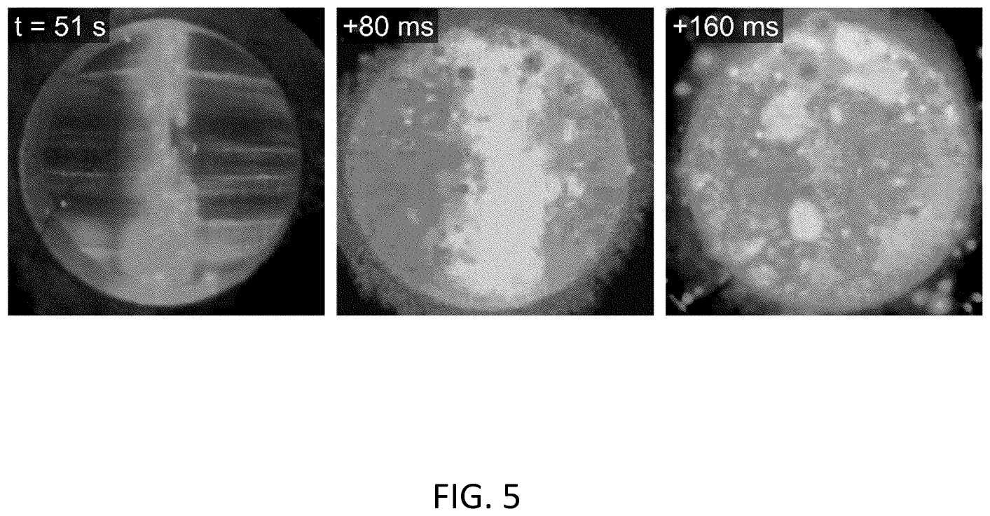

FIG. 5 shows representative time-series images of a frictional ignition event during a test on Ni-20Cr. Att=51 s the first signs of ignition were observed-sparks, molten metal, and oxide slag are ejected from the rubbing surface. After an additional 80 ms, ignition was detected through a spike in chamber pressure. Finally, after 160 ms, the test was shut down and the chamber purged with N₂. The other materials exhibited similar ignition behaviors.

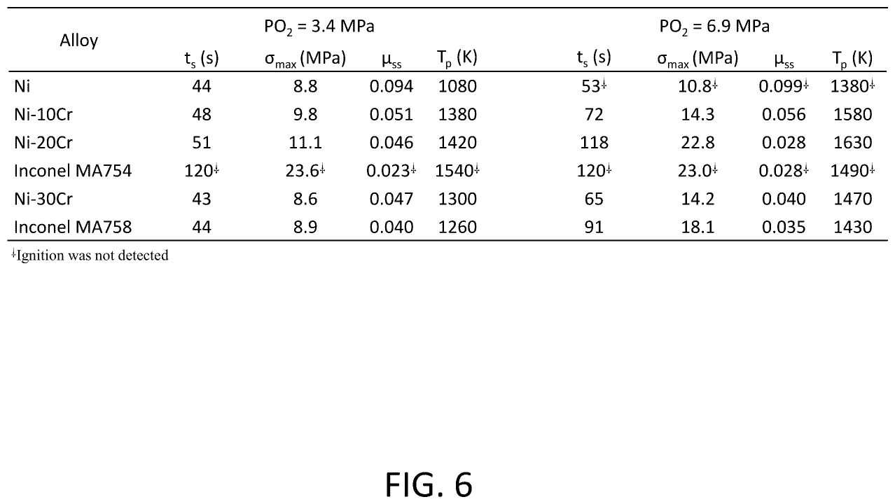

FIG. 6 summarizes the results from the frictional ignition experiments under the two different oxygen pressures. Under PO₂=3.4 MPa, all materials ignited except MA754. Among materials that ignited, ignition times (tₛ) were all similar, ranging from a minimum of 43 s for Ni-30Cr to a maximum of 51 s for Ni-20Cr. Under PO₂=6.9 MPa, all materials ignited except Ni and MA754. The Ni test terminated after 53 s because of excessive specimen deformation, while the MA754 test ran for 120 s. Ignition times under the higher PO₂ were roughly twice those observed under PO₂=3.4 MPa. This ignition delay with increasing PO₂ results from an increase in gas thermal conductivity, which helps remove heat from the rubbing surface. The maximum contact pressures (σₘₐₓ) in these different tests ranged from 8 to 23 MPa, the maximum contact pressure accessible with the present actuator and specimen geometry.

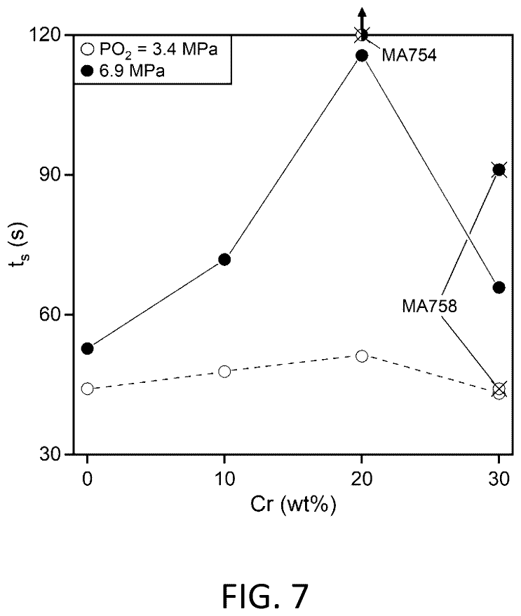

FIG. 7 shows ignition time as a function of Cr content. For non-ODS materials, ignition time is the longest for Ni-20Cr under both PO₂ test conditions. Comparing MA754 and MA758 with their non-ODS counterparts shows that Y₂O₃ additions improve ignition-resistance, though the benefit depends on PO₂ and Cr content. Under PO₂=3.4 MPa, MA758 has the same ignition time as Ni-30Cr whereas under PO₂=6.9 MPa the ignition time of MA758 is delayed 25 s. The benefit of Y₂O₃ additions is even more significant in MA754, highlighting a synergistic effect between 20 wt % Cr content and Y₂O₃.

### 2.2.2 Trends in Friction Coefficient

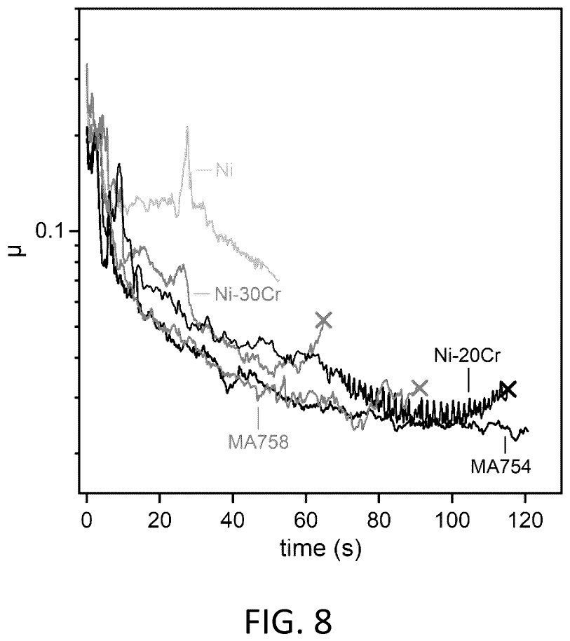

FIG. 8 shows the friction coefficient as a function of time for several exemplary tests. The time evolution of the friction coefficients follows a similar form for all materials: at first contact the friction coefficient ranges between 0.1-0.3, typical of low-speed sliding contact between metals, then it decays with time to a lower steady-state value which depends on material chemistry. The time constant of this exponential decay increases with Cr content, from 10 s for Ni to 35 s for Ni-20Cr. The form and magnitude of these friction coefficient curves were insensitive to PO₂. There are large random fluctuations at the beginning of the test that may result from specimen misalignment or running-in. Smaller periodic fluctuations with a frequency of ˜2 s⁻¹ are evident at later times in select curves.

The drop in friction coefficient in FIG. 8 is linked with the formation of a lubricating oxide tribolayer. For materials that ignited, the friction coefficient began to increase at the end of the test. It is hypothesized that the rise in friction coefficient prior to ignition results from oxide tribolayer breakdown, exposure of the underlying metal, and formation of metallurgical junctions. The unprotected hot metal then reacts with high-pressure oxygen resulting in metal ignition.

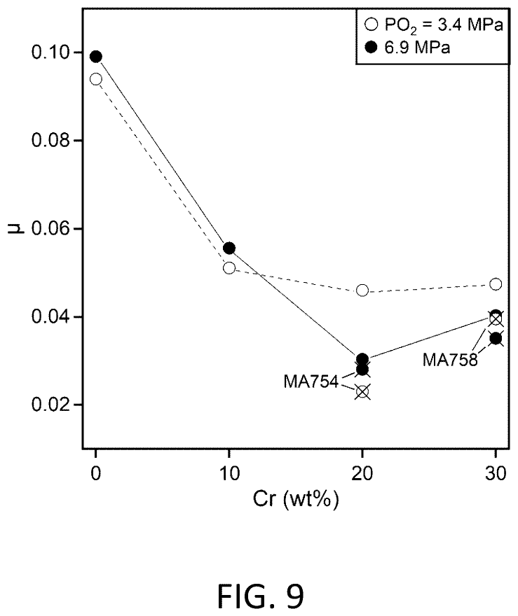

FIG. 9 shows the time-averaged steady-state friction coefficient uss as a function of Cr content. Among the non-ODS materials, the friction coefficient decreases with Cr content to a minimum value of 0.03 under 6.9 MPa for Ni-20Cr. A similar effect has been observed in low-speed, high-temperature sliding experiments of binary Ni—Cr alloys. MA754 and MA758 have slightly lower friction coefficients than Ni-20Cr and Ni-30Cr, respectively, suggesting another benefit of Y₂O₃ addition during high-speed sliding.

### 2.2.3 Trends in Ignition Temperature

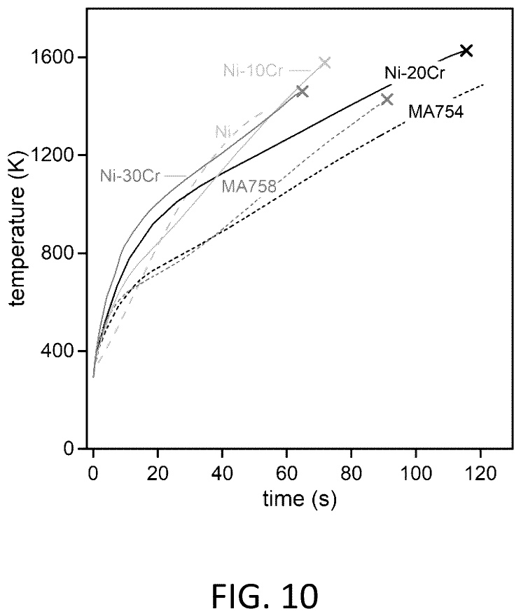

FIG. 10 shows interfacial temperature as a function of time under PO2=6.9 MPa, calculated using finite element analysis with smoothed friction coefficient data from FIG. 8. All the temperature-time curves have a similar form: the temperature increases rapidly over the first 10 s due to the initially high friction coefficient, then the heating rate slows as the friction coefficient decays and heat diffuses away from the rubbing surface. MA754 and MA758 exhibit an anomalously slow heating rate after their friction coefficients decay to a low steady-state value.

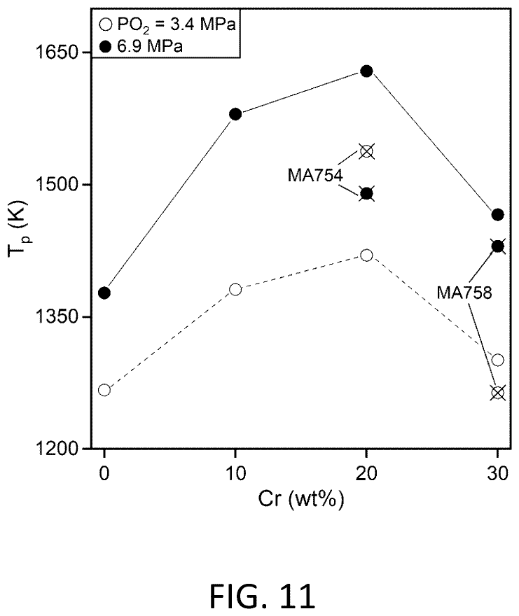

Peak interfacial temperatures (Tₚ) are plotted against Cr content in FIG. 11. These peak temperatures correspond to ignition temperatures, except for Ni under PO₂=6.9 MPa and MA754 under both pressures, since these specimens did not ignite. Comparing ignition temperatures under the two different pressures shows that lowering the pressure decreased the ignition temperature by 100-250 K across the full range of compositions. These ignition temperatures correspond to homologous temperatures of 0.87-0.97 under PO₂=6.9 and 0.73-0.85 under PO₂=3.4 MPa. Among non-ODS alloys, Ni-20Cr has the highest ignition temperature under all test conditions.

The effect of Y₂O₃ on ignition temperature depends on Cr content. In the MA758/Ni-30Cr material couple, Y₂O₃ has a marginal effect on ignition temperature. By contrast, in the MA754/Ni-20Cr couple, Y₂O₃ increases the ignition temperature under low PO₂, since the peak interfacial temperature in the MA754 test exceeds the ignition temperature of Ni-20Cr by 100 K. Under high PO₂, the MA754 and Ni-20Cr experiments ran for similar times, but the peak interfacial temperature in the MA754 test never reached the ignition temperature of Ni-20Cr because of the low steady-state friction coefficient of MA754.

A possible explanation for the discrepancy between the ignition temperatures under different PO₂ is localized flash heating at asperity contacts, which causes the local temperature at ignition to be the same under both pressures. Flash heating has been studied extensively in the context of wear. An extension of a simplified flash heating model for pin-on-disk contacts is used for this experimental setup by modifying the expressions for the number of asperities N and normalized sliding velocity v to account for specimen geometry. The modified flash heating model is,

$${T}_{f} = {T}_{b} + \frac{\sqrt{π}}{6} \frac{μ ω}{κ} \sqrt{\frac{PH}{N ( {r}_{o}^{2} - {r}_{i}^{2} )}} ( {r}_{o}^{3} - {r}_{i}^{3} ) \qquad ( 2.3 )$$

where T_{b} is the bulk interfacial temperature computed from the finite element simulations, μ is the friction coefficient, ω is the angular velocity, κ is the thermal conductivity of the material, P is the contact pressure, rₒ and rᵢ are the outer and inner radii of the sample, respectively. H is temperature-dependent hardness obtained from tabulated data and interpolated over the full temperature range. N is the number of contact asperities, given by the expression,

$$N = \frac{{r}_{o}^{2} - {r}_{i}^{2}}{{r}_{a}^{2}} ( 1 - \frac{P}{H} ) \frac{P}{H} + 1 , \qquad ( 2.4 )$$

where rₐ is the average asperity radius. Surface roughness measurements were used to determine an average asperity radius of 1 μm. However, the flash temperature at ignition is insensitive to asperity radius: under PO₂ of 6.9 MPa, the ignition temperature of Ni-20Cr is 1630 K with rₐ=1 μm versus 1660 K with rₐ=10 μm.

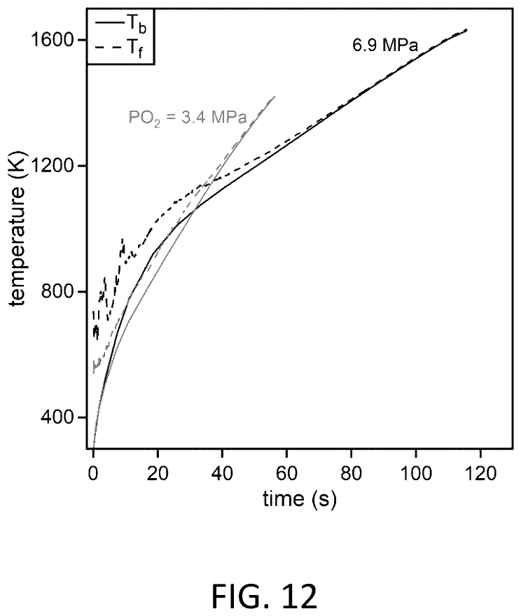

The results of the flash heating calculation for Ni-20Cr are shown in FIG. 12. Under both pressures, the flash heating increment over the bulk temperature decreases from ˜400 K to 20 K over the course of the experiment as the number of asperities decreases and the mean asperity radius increases. After accounting for flash heating effects, the final interfacial temperature of 1430 K under PO₂=3.4 MPa is still 200 K below the ignition temperature under PO₂=6.9 MPa. Clearly flash heating alone cannot explain the lower ignition temperatures observed under PO₂=3.4 MPa.

The drop in ignition temperature may instead reflect a transition in the dominant ignition mechanism. Under PO₂=6.9 MPa, ignition temperatures approach the melting point of each alloy suggesting that melting drives tribolayer breakdown and subsequent ignition. Under PO₂=3.4 MPa, ignition occurs at significantly lower temperatures and shorter times, suggesting a thermo-mechanical mechanism drives ignition. This transition in ignition mechanism with PO₂ may result from slower oxidation kinetics under low PO₂, leading to the growth of a thinner, less adherent oxide tribolayer that is more susceptible to mechanical breakdown.

### 2.2.4 Trends in Axial Displacement

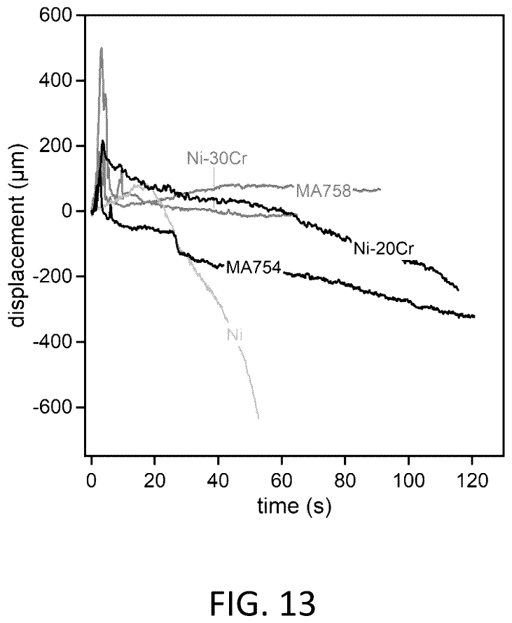

Axial displacement data from select tests is shown in FIG. 13. All materials except MA758 exhibited a brief initial period of thermal expansion followed by compressive plastic deformation as a result of thermal softening under the increasing contact load. MA758 exhibited initial gradual thermal expansion which plateaued towards the end of the test. Comparing the axial displacement data shows that Cr addition imparted high-temperature strength which suppressed plastic deformation.

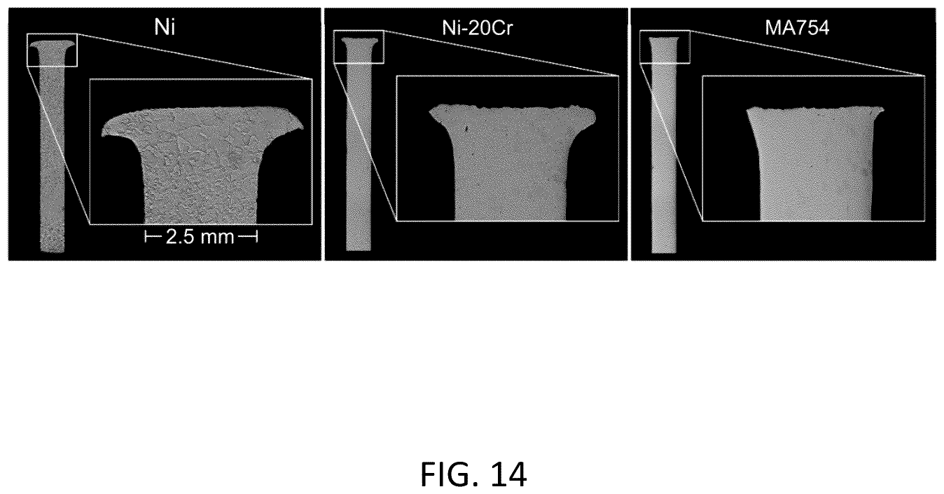

FIG. 14 compares the recovered Ni, Ni-20Cr, and MA754 test specimens to highlight their different deformation behaviors. All recovered materials, including those not shown in FIG. 14, exhibited plastic deformation near the rubbing surface where material was extruded outward. Recovered samples also featured discoloration near the rubbing surface because of high-temperature oxidation. Comparing the Ni specimen with the Ni-20Cr specimen, which ran twice as long, achieved a ˜100 K higher interfacial temperature, and experienced a 12 MPa higher contact stress, shows how Cr addition suppresses plastic deformation. Comparing the Ni-20Cr and MA754 specimens, which both ran for ˜120 s, highlights how Y₂O₃ further reduces the extent of plastic deformation via dispersion-strengthening.

The rubbing surface of all recovered specimens featured an oxide tribolayer that formed in situ.

### 2.3 Quantification of Frictional Ignition Resistance

The relative frictional ignition-resistance of these different materials may be assessed using a material index, i.e., a grouping of material properties whose extremal value leads to increased performance in a given application.

An advantage of using material indices in material selection is they are not limited to a specific set of test conditions. As an example, test data can be used to determine a material index for ignition resistance under one set of conditions, which is then easily generalized to other conditions without further experiments. To develop a material index for frictional ignition resistance, it is first recognized that the objective is to increase the ignition time, tₛ, regardless of the sliding conditions. Approximating the frictional ignition specimen as a 1D semi-infinite body with a constant heat flux boundary condition q, the time to a reach a given increment in interfacial temperature ΔT is:

$$t = {( \frac{1}{q} ( Δ T ) \sqrt{ρ {C}_{p} κ} )}^{2} \qquad ( 2.5 )$$

where \sqrt{ρCₚκ} is the thermal effusivity. The frictional heat flux q is given by:

$$q = αμ Pv \qquad ( 2.6 )$$

where α is the heat partition coefficient. Assuming the specimen has an initial uniform temperature T₀ and a material-specific ignition temperature T_{ign}, the temperature increment at ignition is:

$$Δ T = ( {T}_{ign} - {T}_{0} ) \qquad ( 2.7 )$$

Combining Eqs. 2.5-2.7 gives the objective function:

$${t}_{s} = {{( \frac{1}{aPv} )}^{2} [ \frac{( {T}_{ign} - {τ}_{0} ) \sqrt{ρ {C}_{p} κ}}{μ} ]}^{2} \qquad ( 2.8 )$$

Inspection of Eq. 2.8 shows that tₛ may be increased by increasing the material index, which may be expressed as follows:

$$MI = {[ \frac{1}{μ} ( {T}_{ign} - {T}_{0} ) \sqrt{ρ {C}_{p} κ} ]}^{2} \qquad ( 2.9 )$$

where \sqrt{ρCₚκ} is the thermal effusivity, μ is the friction coefficient, T₀ is the initial specimen temperature (298 K), and T_{ign} is a material-specific ignition temperature. This material index is directly proportional to ignition time, meaning materials with a high MI will take longer to ignite. The material index increases with a higher ignition temperature, a higher thermal effusivity, and a lower friction coefficient.

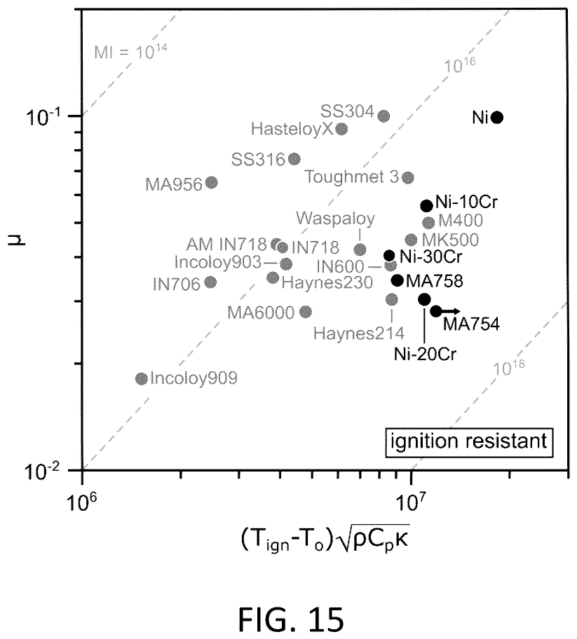

FIG. 15 uses this material index to compare the frictional ignition-resistance of the alloys tested against previous results. Because MA754 did not ignite under any test conditions, its ignition temperature is assumed to equal its solidus temperature. The dashed lines in FIG. 15 indicate material index iso-contours. Ignition-resistance increases moving towards the bottom-right corner of FIG. 15. Ferrous alloys and alloys with high Fe concentrations (e.g., Inconel 718, Inconel 706) are the least ignition-resistant, consistent with their extreme flammability in promoted combustion testing. Ni-base alloys with low Fe content, including some of the alloys disclosed herein, are the most ignition-resistant. The high friction coefficient of Ni makes it the least ignition resistant of the materials tested here. At the opposite extreme, the low friction coefficient and high ignition temperature of MA754 results in exceptional ignition resistance, outperforming other alloys commonly used in high pressure O₂ environments.

In the following sections, the rubbing surfaces of recovered specimens are characterized, focusing specifically on the oxide tribolayer that forms in situ, to link the trends in friction coefficient and ignition temperature highlighted in FIG. 15 with microstructural features.

### 2.4 Structural Characterization of Oxide Tribolayers

### 2.4.1 Overview of Structure at the Sliding Interface

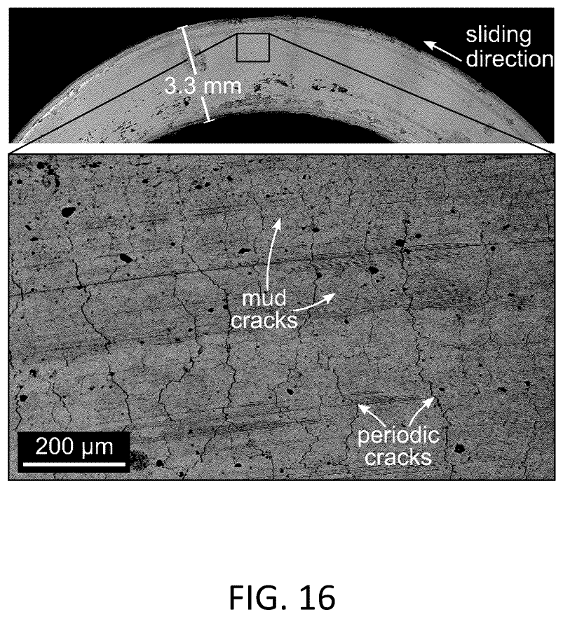

Inspection of the rubbing surfaces on all non-ignited samples revealed wear marks aligned with the sliding direction and thin interconnected mud cracks, as shown in FIG. 16. The rubbing surfaces of the Ni-20Cr and MA754 specimens also featured periodic radial cracks with a mean spacing of ˜150 μm. These periodic cracks likely resulted from tensile hoop stresses caused by the thermal expansion mismatch between the oxide tribolayer and metal substrate. In select specimens, fragments of the oxide tribolayer spalled due to buckling delamination from compressive stresses that developed during rapid cooling following test shutdown.

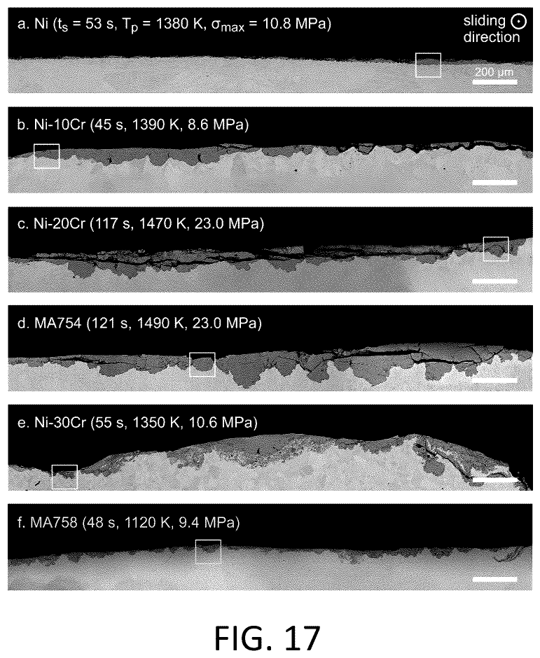

Cross-sections of the rubbing surfaces of non-ignited samples are shown in FIG. 17. The Ni—Cr alloys developed a thicker, less porous oxide tribolayer compared to Ni. MA754 and Ni-20Cr have the thickest tribolayers, reflecting the longer test times and higher interfacial temperatures. While Ni-20Cr and MA754 ran for similar times and reached comparable interfacial temperatures, the tribolayer on MA754 is substantially thicker and less porous than the tribolayer on Ni-20Cr, suggesting Y₂O₃ accelerates oxide growth under high-speed sliding conditions. These features-thicker and less porous tribolayer are not directly translated to Ni-30Cr, as the addition of Y₂O₃ led to a thinner tribolayer in MA758.

All samples show signs of extensive plastic deformation near the rubbing surface. In the Ni and MA754 specimens, there are fine grained regions below the metal/oxide interface which formed through dynamic recrystallization. In the MA758 and Ni-30Cr specimens, there is mechanical mixing of the tribolayer and underlying metal due to thermal softening and shearing during sliding.

The oxide tribolayers on Ni-10Cr, Ni-20Cr and MA754 (FIG. 17) exhibit extensive cracking, both parallel and perpendicular to the oxide/metal interface, and signs of buckling delamination due to compressive stresses during cooling at test shutdown. The channel cracks that develop in the tribolayer result from high contact loads, high thermal stresses, and incompatible deformation between the brittle oxide tribolayer and ductile underlying metal. The metal/oxide interfaces of Ni-20Cr and MA754 also feature large oxide nodules which likely result from breakaway oxidation caused by Cr depletion in the underlying metal. The wavelength of the nodules roughly matches the spacing of periodic cracks on the rubbing surface. The effects of this corrugated interface on interfacial fracture toughness, oxide delamination, and frictional ignition resistance are discussed below.

### 2.4.2 Effects of Cr Content

### 2.4.2.1 Oxide Tribolayer on Commercially Pure Ni

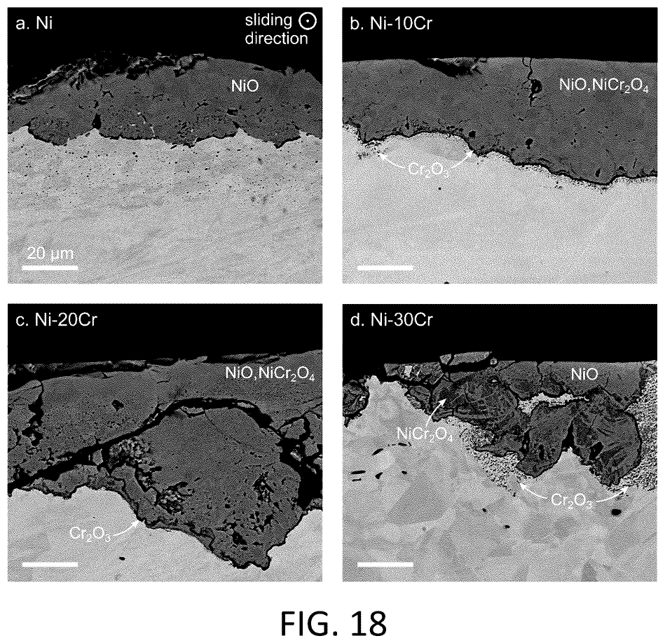

The Ni tribolayer and underlying metal are shown in FIG. 18(a). The tribolayer comprises a 13 μm thick layer of single-phase NiO, with equiaxed micron-scale grains near the free surface and nanograins with high porosity near the metal/oxide interface. In the underlying metal, there is porosity near the metal/oxide interface as well as a 20 μm thick layer of recrystallized micron-scale grains. There is no microstructural evidence of melting in either the tribolayer or base metal, consistent with the peak interfacial temperature of 1380 K, which is well below the melting points of Ni (1710 K) and NiO (2230 K). Based on the tribolayer thickness and the thermal conductivity of NiO, it is estimated that a temperature drop of only 2 K across the tribolayer occurred during testing.

Comparing the tribolayer in FIG. 18(a) with oxide overlayers grown under static conditions indicates suggests oxidation is much faster during high-speed sliding. As an example, a 10 μm thick NiO scale takes longer than 10 minutes to grow during static oxidation at 1273 K, whereas a similarly thick overlayer forms in 1 minute during frictional ignition testing. One possible explanation for the faster oxidation rates during frictional ignition is the high oxygen partial pressures. However, previous high-temperature Ni oxidation studies have shown that the oxidation rate is insensitive to oxygen pressure above 0.1 MPa. The more likely explanation is that the fine grain structure in the oxide tribolayer enhances oxidation kinetics by allowing short-circuit diffusion of Ni ions along grain boundaries.

The fine grain structure in the NiO tribolayer (FIG. 18(a)) likely arises from a combination of effects. First, the extent of grain growth is limited by the short test duration and by chemical impurities, which drag oxide grain boundaries. In addition, the tribolayer may inherit the fine grain structure of the underlying metal. Such behavior has been observed in static oxidation experiments which showed that NiO overlayers grown on coldworked Ni had finer grains than oxide scales grown on annealed samples.

Ni exhibits poor frictional ignition resistance despite having a high thermal effusivity because of its high friction coefficient, which results in a high frictional heating rate (see FIG. 15). Based on the present microstructural observations, it is hypothesized that its high friction coefficient stems from the low yield strength of Ni and the thin, porous tribolayer. During sliding, the underlying metal thermally softens and deforms, rupturing the thin NiO tribolayer, exposing soft Ni, and promoting the formation of metallurgical junctions that increase the friction coefficient.

### 2.4.2.2 Oxide Tribolayer on Ni—Cr Alloys

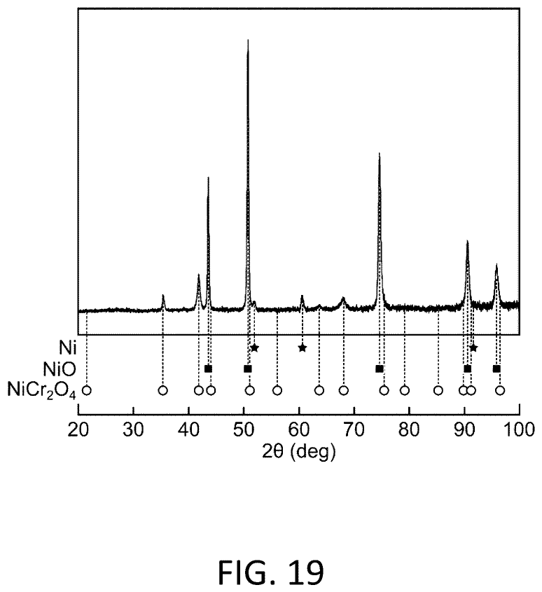

FIG. 19 presents an XRD pattern collected from the Ni-20Cr tribolayer, revealing a mixture of two phases—NiO and NiCr₂O₄. XRD patterns from the tribolayers on the other Ni—Cr alloys were similar.

FIGS. 18(b)-(d) show the oxide tribolayers on Ni-10Cr, Ni-20Cr, and Ni-30Cr. EDS maps of the oxide tribolayers agree with XRD results, revealing a dense upper layer of NiO at the gas/oxide interface, a middle layer of NiO with sub-micron NiCr₂O₄ precipitates (mean size ˜500 nm), followed by a 1-5 μm thick Cr₂O₃ layer at the metal/oxide interface. The Ni-10Cr and Ni-30Cr tribolayers also feature a region of internal oxidation near the metal/oxide interface. NiCr₂O₄ islands form during the early stages of static oxidation of Ni—Cr alloys via a solid-state reaction between NiO and Cr₂O₃. During extended oxidation experiments these islands typically join into a thin continuous interlayer below the NiO outer layer. This NiCr₂O₄ interlayer is absent from the tribolayer because the spinel precipitates do not have time to coalesce during the brief frictional ignition experiments. The Cr₂O₃ interlayer at the metal/oxide interface appears in static oxidation experiments of Ni—Cr alloys with more than 10 wt % Cr. This phase was absent from the XRD patterns because X-rays could not penetrate the thick Ni-rich layers near the free surface. In all non-ODS Ni—Cr alloys, porosity in the middle NiCr₂O₄/NiO layer was observed, with larger pores closer to the Cr₂O₃ interlayer.

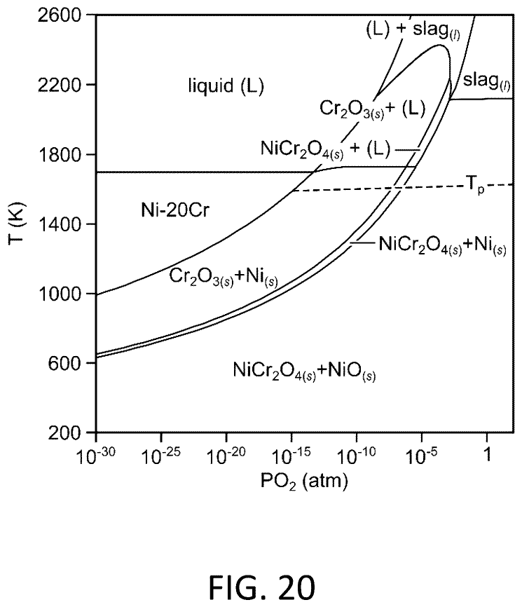

FIG. 20 shows an O₂ pressure-temperature predominance diagram for Ni-20Cr. This diagram indicates that NiO and NiCr₂O₄ form closer to the oxide/gas interface, followed by a layer of metallic Ni and NiCr₂O₄, then a mixture of Cr₂O₃ and metallic Ni at the metal/oxide interface. Metallic Ni was not observed in the NiO/NiCr₂O₄ and Cr₂O₃ layers in FIG. 18 because they were too small to be resolved with SEM. There is generally good agreement between the predominance diagram and the observed oxide structures, suggesting equilibrium calculations can describe the phases within oxide tribolayers. Such calculations predict that the NiCr₂O₄ content within the tribolayer increases from 13 vol % for Ni-10Cr to 42 vol % for Ni-30Cr.

Similar to Ni, the non-ODS Ni—Cr alloys exhibit faster oxidation kinetics during high-speed sliding compared to static oxidation. Under static oxidation conditions (T=1473 K, PO₂=101 kPa), Ni-20Cr grows an 8 μm thick oxide over an exposure time of ˜72 hours. The Ni-20Cr tribolayer formed during frictional ignition experiments reached an average thickness of 52 μm in 117 s at similar temperatures. The high PO₂ in the present study may have an effect on oxidation kinetics, but it is unlikely to explain this dramatic difference in oxide thickness given the brief test duration. It is hypothesized that the faster oxidation rates are in part due to the small NiCr₂O₄ particles in the NiO scale, which increase the mobility of Ni ions through the tribolayer by increasing the cation vacancy concentration. In addition, NiCr₂O₄ particles pin NiO grain boundaries, resulting in a fine grain structure in the NiO layer that facilitates short-circuit diffusion of the Ni ions through grain boundaries. Channel cracks in the tribolayer facilitate O₂ ingress as well.

Despite the difference in oxidation kinetics, the microstructures of the Ni-10Cr and Ni-20Cr tribolayers are qualitatively similar to the structure of oxides grown on these alloys under static oxidation conditions (T=1073-1473 K, PO₂=101 kPa). The close resemblance suggests that for these compositions, the dominant oxidation mechanisms under high-speed sliding and static oxidation are similar. This parallel breaks down at high Cr concentrations, as the Ni-30Cr tribolayer differs strongly from the oxide overlayer grown on Ni-30Cr during static oxidation. Internal oxidation like that seen in the Ni-30Cr tribolayer is typically absent from oxide overlayers formed on Ni-30Cr alloys (T=1423 K, PO₂=0.1 kPa). Instead, the Ni-30Cr oxide tribolayer resembles oxide scales formed during static oxidation of low-Cr alloys (<10 wt % Cr). This difference may have resulted from mechanical mixing of the tribolayer and underlying metal, which is evident from the tortuous metal/oxide interface and the large islands of metallic Ni embedded within the oxide (FIGS. 17(e) and 18(d)). Plastic deformation of the thin Ni-30Cr tribolayer may have disturbed the protective Cr₂O₃ interlayer, facilitating internal oxidation.

A key feature of the Ni-20Cr tribolayer is the wavy metal/oxide interface since this increases the interfacial fracture toughness of the tribolayer. The interfacial toughening increment depends on the interface geometry (amplitude A and wavelength λ of the corrugations) and the ratio of bulk oxide toughness to interface toughness, G_{b}/Gᵢ. From stereological measurements of the wavy interface on the Ni-20Cr tribolayer, a mean aspect ratio A/λ of 0.2 is calculated. Using reported toughness values of bulk NiO and Cr₂O₃ (10-15 J/m²) and interfacial toughness values of NiO, Cr₂O₃, Al₂O₃ on Ni-based alloys (˜10-200 J/m²), a G_{b}/Gᵢ of 0.1-1.2 is estimated. Based, in part, on G_{b}/Gᵢ, A/λ, a 30% increment in the toughness at the crests and troughs of the wavy interface is expected and a 60% increment near the rising and falling regions is expected. The higher increment near the rising and falling regions results from an increase in mode-mixity as the crack propagates through the interface. At the crests and troughs, the mode-mix phase angle (¢) is 0° such that the crack propagates under pure mode I. As the crack moves away from these regions, ϕ increases to ˜40° indicative of a mixed-mode behavior, which hinders the crack from propagating through the interface, causing it to kink into the oxide. Such kinking of interfacial cracks from the metal/oxide interface into the bulk oxide is clearly visible in the Ni-20Cr tribolayer (FIG. 17(c)). This preferred kinking behavior combined with a higher effective interface toughness prevents the oxide tribolayer from delaminating along the metal/oxide interface.

Comparing the flat thin tribolayer on Ni with the thicker corrugated tribolayers on the non-ODS Ni—Cr alloys reveals distinct microstructural features that enhance frictional ignition resistance. In particular, the continuous Cr₂O₃ interlayer and corrugated metal/oxide interface in the Ni-10Cr and Ni-20Cr alloys improve tribolayer adhesion and interfacial toughness, mitigating tribolayer breakdown, lowering the friction coefficient, and increasing the ignition temperature. Among the non-ODS Ni—Cr alloys, Ni-20Cr was the most ignition-resistant because it grew the thickest oxide and had the most corrugated interface—e.g., the oxide nodules in Ni-20Cr are 120-140 μm thick while those in Ni-10Cr are only 60-100 μm thick.

2.4.3 Effects of Y₂O₃ Dispersoids

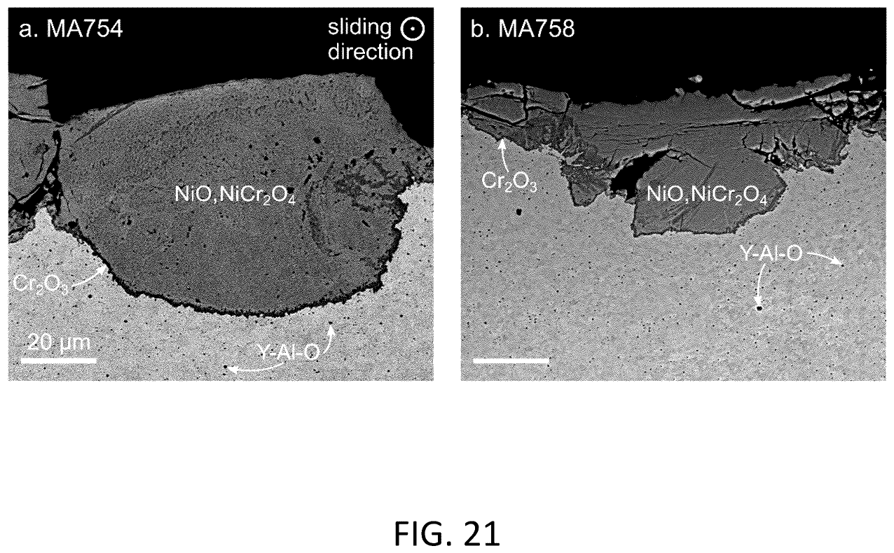

FIG. 21 compares high-magnification SEM micrographs of the oxide tribolayers on MA754 and MA758. The MA754 tribolayer has an average thickness of 80 μm, which is substantially thicker than the Ni-20Cr tribolayer (50 μm), despite running for the same time and achieving similar interfacial temperatures. In contrast, the mean thickness of the MA758 tribolayer is only 30 μm, which is thinner than that of Ni-30Cr (45 μm). The MA754 and MA758 tribolayers comprise multiple layers—a 10-20 μm thick layer of NiO closest to the rubbing surface, a 20-60 μm thick middle layer consisting of a NiO matrix with NiCr₂O₄ precipitates, and a 1 μm thick continuous Cr₂O₃ layer at the metal/oxide interface. Both tribolayers feature a gradient in grain size, with small equiaxed grains (˜500 nm) near the Cr₂O₃/Ni-rich oxide interface and larger micron-scale grains at the oxide/gas interface. The tribolayers also have a corrugated metal/oxide interface, similar to that observed in Ni-20Cr. The tribolayers contain pores and crack-like defects at the metal/oxide interface due to incompatible plastic deformation. In MA754, the metal adjacent to the tribolayer has an equiaxed, recrystallized grain structure, with a mean grain size of ˜1 μm. This is orders of magnitude smaller than the initial average grain size of several hundred microns. The fine grain size results from a combination of dynamic recrystallization during plastic deformation and Zener pinning by the oxide dispersoids. The MA758 feedstock had a fine grain structure at the start of the test, which was preserved during sliding.

Similar to their non-ODS counterparts, ODS Ni—Cr alloys oxidize more rapidly during frictional ignition tests than under static oxidation conditions. Comparing the non-ODS and ODS tribolayers shows that the effect of Y₂O₃ on oxidation rate varies with Cr content. The MA758 tribolayer is thinner than that of Ni-30Cr, suggesting Y₂O₃ slows oxidation. Conversely, MA754 forms a much thicker oxide than Ni-20Cr—80 μm v. 50 μm—despite similar test durations.

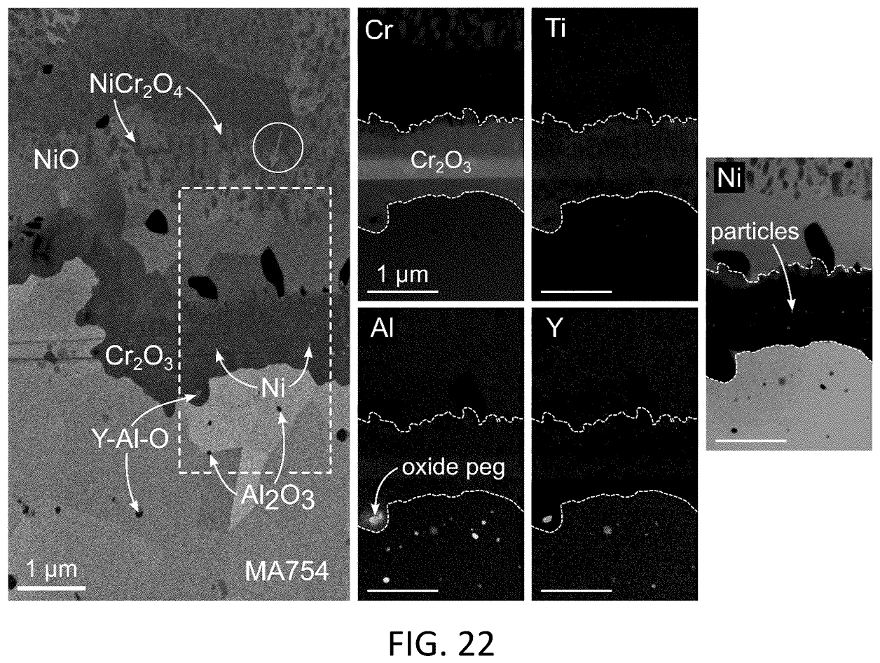

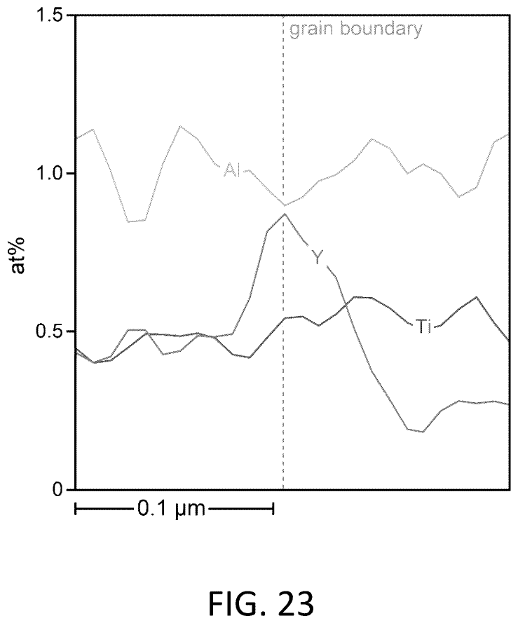

FIG. 22 presents a STEM high-angle annular dark-field (HAADF) micrograph of the metal/oxide interface in MA754 and STEM EDS maps of a select region. The Cr₂O₃ interlayer has a fine grain structure with 250-500 nm grains, appreciably smaller than the grains in the underlying metal or in the Ni-rich oxide layer. This fine grain structure results from Zener pinning by metallic Ni particles seen in the EDS maps. Pores (0.5-1 μm in diameter) are observed at the interface between the Cr₂O₃ interlayer and the Ni-rich oxide. Y in the Cr₂O₃ interlayer is sequestered in Y—Al oxide particles that peg the oxide tribolayer, improving metal/oxide adhesion. FIG. 23 shows an EDS linescan across a NiO grain boundary (magenta arrow in FIG. 22), revealing Y grain boundary segregation which may retard grain growth via solute drag.

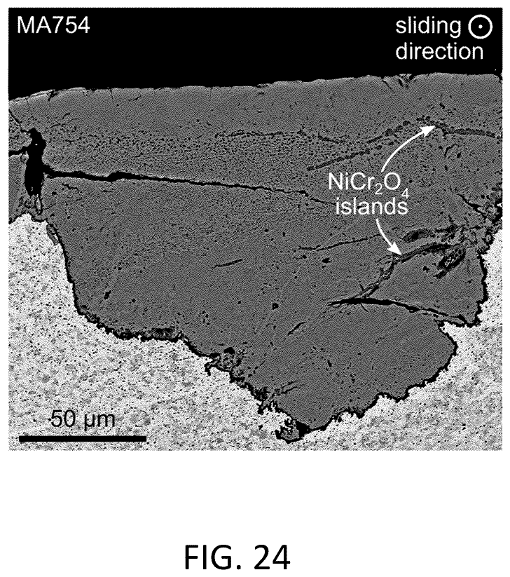

The Cr EDS map in FIG. 22 reveals Cr depletion within ˜1 μm of the metal/oxide interface, confirming that the large oxide nodules form via breakaway oxidation. Further evidence of breakaway oxidation is the large NiCr₂O₄ islands in the NiO matrix shown in FIG. 24. These islands were part of a continuous Cr₂O₃ layer prior to breakaway oxidation. Once the growth instability occurred, the Cr₂O₃ reacted with NiO to form the NiCr₂O₄ islands. As discussed above, the wavy interface generated by this growth instability increases interfacial fracture toughness helping to suppress oxide breakdown.

In FIG. 22, the oxide particles in the underlying metal are mostly Y—Al mixed oxides (Y₃Al₅O₁₂, YAlO₃, Y₄Al₂O₉) which form via reactions between Y₂O₃ dispersoids and Al. These oxide particles are much larger than the initial dispersoid size of ˜20 nm presumably because their low melting points result in a high solubility in the Ni-matrix, which promotes coarsening. While coarsening of the Y—Al dispersoids degrades high-temperature mechanical properties, the present results indicate that it does not affect ignition resistance. This conclusion suggests that dispersoid chemistry may have a weak effect on frictional ignition resistance.

Comparing the tribolayers on the Ni-20Cr/MA754 pair reveals distinct microstructural features resulting from Y₂O₃ addition that enhance frictional ignition resistance. Oxide pegs in the Cr₂O₃ interlayer in MA754 improve metal/oxide adhesion. Y₂O₃ also refines the grain structure in the underlying metal, which in turn promotes a fine grain structure in the oxide tribolayer. Grain size refinement of the oxide accelerates tribolayer growth through short-circuit diffusion. Considered together, faster oxidation kinetics enable MA754 to grow a thick tribolayer while an adherent metal/oxide interface mitigates tribolayer breakdown, lowering the friction coefficient and increasing the ignition temperature.

In the Ni-30Cr/MA758 pair, Y₂O₃ addition had only a minor impact on ignition resistance. The lack of a synergistic effect between Y₂O₃ and 30 wt % Cr is likely due to slower oxidation kinetics observed in Ni-30Cr v. Ni-20Cr. Under high-temperature static conditions, Ni-30Cr quickly forms a continuous Cr₂O₃ interlayer, resulting in slower oxidation kinetics and a thinner oxide than Ni-20Cr. This effect is also observed in the present frictional ignition experiments when comparing the Ni-20Cr and Ni-30Cr tribolayers (FIGS. 17(c) and 17(e)). Close inspection of the MA748 tribolayer suggests that Y₂O₃ addition further slows tribolayer growth (FIGS. 17(e) and 17(f)). As noted above, this behavior contrasts with that of MA754, where Y₂O₃ accelerates tribolayer growth, but is consistent with conventional static oxidation results, where Y₂O₃ catalyzes formation of a slow-diffusing Cr₂O₃ interlayer and blocks short-circuit diffusion by segregating to oxide grain boundaries. Thus, while Y₂O₃ imparts MA758 with high-temperature strength, the thin MA758 tribolayer is susceptible to breakdown, resulting in a marginal increase in ignition resistance from Y₂O₃ addition.

### 2.5 Alloying Effects on Tribolayer Mechanical Properties

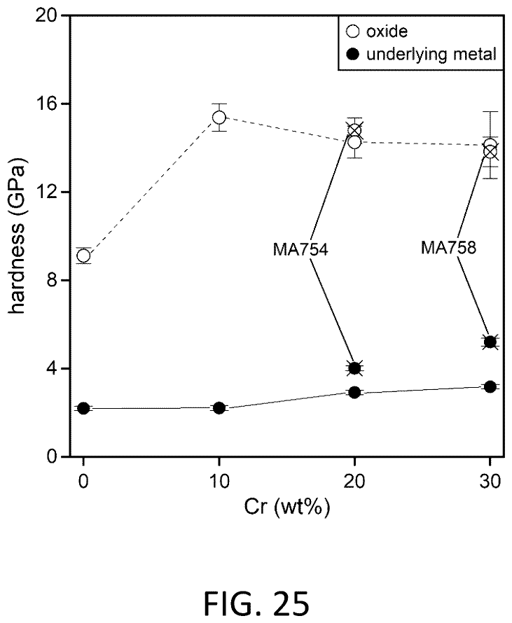

FIG. 25 shows the nanoindentation hardness of the oxide and underlying metal near the metal/oxide interface as a function of Cr content. The hardness values of the underlying metal and oxide are consistent with typical hardness values for Ni—Cr alloys and oxide ceramics, respectively. Comparing the hardness of the non-ODS alloys shows that Cr addition increases the room-temperature hardness of the underlying metal through solid solution strengthening. Cr addition also increases the oxide hardness via formation of NiCr₂O₄ spinel precipitates within the NiO matrix. While the oxide tribolayer will thermally soften, it is expected that the trend of increasing oxide hardness with Cr content will persist to high temperatures because the strength of Ni₂CrO₄ is less temperature-sensitive than that of NiO. The increase in hardness with Cr addition reduces the likelihood of junction growth during sliding, resulting in a lower friction coefficient, consistent with the trend in FIG. 9.

Comparing the hardness of the ODS alloys with their non-ODS counterparts, the addition of Y₂O₃ was observed to have a negligible effect on oxide hardness. However, Y₂O₃ addition appreciably strengthens the underlying metal, making the underlying metal more resistant to plastic deformation and providing greater support to the tribolayer-effects which mitigate oxide breakdown.

### 2.6 Alloying Effects on Tribolayer Stability

Cr addition enhances the ignition resistance of non-ODS Ni—Cr alloys by: (i) improving oxide tribolayer adhesion through the growth of a continuous, adherent Cr₂O₃ interlayer; (ii) increasing interfacial toughness through the formation of corrugated metal/oxide interface; and (iii) reducing the extent of plastic deformation during sliding by strengthening the underlying metal and the oxide tribolayer. While increasing Cr content helps mitigate tribolayer breakdown by strengthening the oxide and underlying metal, it also slows down oxidation kinetics by promoting the formation of the slow-diffusing Cr₂O₃ interlayer, which results in a thinner tribolayer that is more susceptible to breakdown. Ni-20Cr has the desired Cr content that balances these competing effects, achieving a tribolayer structure that provides tribolayer growth and resistance to tribolayer breakdown and frictional ignition.

Addition of Y₂O₃ dispersoids may further improve ignition resistance, as demonstrated in the Ni-20Cr/MA754 material pair. The oxide dispersoids accelerate growth of the oxide tribolayer by refining the grain structure in the underlying metal via Zener pinning. This in turn promotes formation of a fine-grained oxide tribolayer that increases oxidation kinetics via short-circuit diffusion. The dispersoids also improve oxide adhesion by pegging the Cr₂O₃ interlayer, which increases the interfacial fracture toughness. Finally, the dispersoids strengthen the underlying metal, lessening the extent of plastic deformation. In the case of MA754, this combination of faster oxidation kinetics, a more adherent oxide tribolayer, and less plastic deformation of the underlying metal augments the beneficial effects of Cr.

The material index presented in Section 2.3 shows that ignition-resistant alloys should have a high thermal effusivity, low friction coefficient, and high ignition temperature. Improving the friction coefficient and ignition temperature requires quickly forming an adherent, strong, and dense oxide tribolayer; toughening the metal/oxide interface, e.g., via corrugations in the oxidation front; and resisting plastic deformation at high temperatures. While these behaviors are all observed in MA754, similar results may be achieved in other dispersion-strengthened alloys. The STEM analysis indicates that the formation of mixed Y—Al oxides does not degrade ignition resistance, suggesting other dispersoid chemistries may be equally effective at enhancing frictional ignition resistance.

### 2.7 Section Summary

High-speed sliding experiments in high-pressure gaseous O₂ were used to assess the frictional ignition behaviors of binary Ni—Cr alloys and two ODS alloys (MA754, MA758). In situ measurements of friction coefficient and axial displacement were used along with calculations of the interfacial temperature at the rubbing surface to understand the effects of Cr additions and Y₂O₃ dispersoids on the mechanisms of tribolayer growth and frictional ignition. Complementary structural characterization of the rubbing surfaces of non-ignited recovered samples revealed the role of material chemistry on the composition, morphology, and spatial distribution of oxide phases within the tribolayer.

The results are as follows:

All materials exhibited a decay in friction coefficient with time due to the in situ growth of a lubricating oxide tribolayer. The friction coefficient increased prior to ignition due to oxide tribolayer breakdown, exposing the hot underlying metal to high pressure O₂ and triggering ignition.

Comparing the ignition behaviors of the non-ODS alloys with their ODS counterparts reveals that Y₂O₃ additions decrease the friction coefficient and the extent of plastic deformation. MA754 is the only material that did not ignite in any test. These results point towards a synergistic interplay between 20 wt % Cr content and Y₂O₃ dispersoids in MA754.

The microstructure of the oxide tribolayers varied strongly with Cr content in the binary Ni—Cr alloys. All Ni—Cr alloys except Ni-30Cr developed a continuous 1 μm thick Cr₂O₃ interlayer at the metal/oxide interface. Above the Cr₂O₃ interlayer, there was a thicker overlayer that comprised a mixture of NiO and nanoscale NiCr₂O₄ precipitates.

Ni-20Cr was the most ignition-resistant of the binary Ni—Cr alloys, with the lowest friction coefficient, highest ignition temperature, and longest ignition time. The unique behavior of Ni-20Cr is linked to key features of its tribolayer. Rapid oxidation kinetics result in a thick protective oxide with an adherent Cr₂O₃ interlayer. Large amplitude oscillations of the metal/oxide interface prevent metal exposure under oxide delamination. NiCr₂O₄ precipitates in the NiO matrix strengthen the oxide tribolayer, lowering the friction coefficient.

The oxide tribolayer on MA754 exhibited many of the same features as the Ni-20Cr tribolayer. However, the Y₂O₃ addition affected the tribolayer chemistry and the microstructure underneath the tribolayer. Coarse Y—Al oxide dispersoids in the underlying metal pinned grain boundaries in the metal underneath the tribolayer, resulting in a fine recrystallized region. This grain structure promotes the growth of a fine-grained oxide tribolayer that accelerates tribolayer growth through short circuit diffusion. The more rapid oxidation in MA754 v. Ni-20Cr results in a thicker oxide tribolayer at a fixed time.

Comparing the MA754 and Ni-20Cr tribolayers indicates that the addition of Y₂O₃ accelerates growth of the protective tribolayer, enhances interfacial toughness through dispersoid pegging, and mitigates plastic deformation of the underlying metal through dispersion-strengthening. These features collectively lower the friction coefficient, increase the ignition temperature, and suppress frictional ignition.

### 3. DISSOLUTION ZONE MODEL OF THE OXIDE STRUCTURE IN ADDITIVELY MANUFACTURED DISPERSION-STRENGTHENED ALLOYS

This section discloses experimental and theoretical study on the manufacture of oxide dispersion-strengthened (ODS) alloys via laser-powder bed fusion (L-PBF), which is an additive manufacturing process. This following study provides a complete physical description of dispersoid evolution during L-PBF considering: (i) time-temperature trajectories experienced by individual fluid elements as they traverse the melt; (ii) thermochemistry-related effects such as reactions between alloying elements and dispersoids; and (iii) cyclic dissolution and growth in regions subjected to multiple melt cycles.

Specifically, a modeling framework is developed and experimentally validated to consider the foregoing aspects of dispersoid evolution.

First, an L-PBF parameter study is conducted using a model alloy, Ni-20Cr, doped with varying concentrations of Y₂O₃ and Al, to assess the effects of material chemistry and print parameters on final dispersoid size. Small angle neutron scattering (SANS) is used to characterize the dispersoid size distribution in the as-printed materials. SANS can probe macroscale volumes, thus providing statistically accurate measurements of the entire dispersoid size distribution.

These experimental measurements then serve as the basis for a quantitative model of dispersoid evolution during L-PBF, accounting for the physics described above. Computational fluid dynamics simulations are used to calibrate a reduced order model of location-specific time-temperature trajectories within the melt pool. This model is then coupled to chemistry-sensitive structural evolution models of dispersoid dissolution, nucleation, growth, and coarsening. The resulting framework can predict whether dispersoids fully dissolve based on the combination of initial size, initial location, alloy chemistry, and printing parameters. For parameter combinations that result in full dissolution, the framework predicts the final dispersoid size after precipitation and cooling in the tail of the melt pool. Conversely, when the dispersoids do not dissolve, the framework indicates when the dispersoids may agglomerate into larger slag inclusions. These results are synthesized into process diagrams which can be used for alloy design and parameter selection, with a view towards printing fully dense, slag-free materials featuring uniformly distributed nanoscale dispersoids.

It should be appreciated the inventive aspects of the ODS alloys disclosed in this section may be readily combined with inventive aspects disclosed in Sections 1 and 2 of the present application. For example, the ODS alloys disclosed in this section may form oxide tribolayers that provide increased ignition resistance when deployed in oxygen-rich environments, such as high-pressure oxygen rich environments in oxygen-rich turbopumps.

### 3.1 Materials and Methods

### 3.1.1 Powder Feedstock

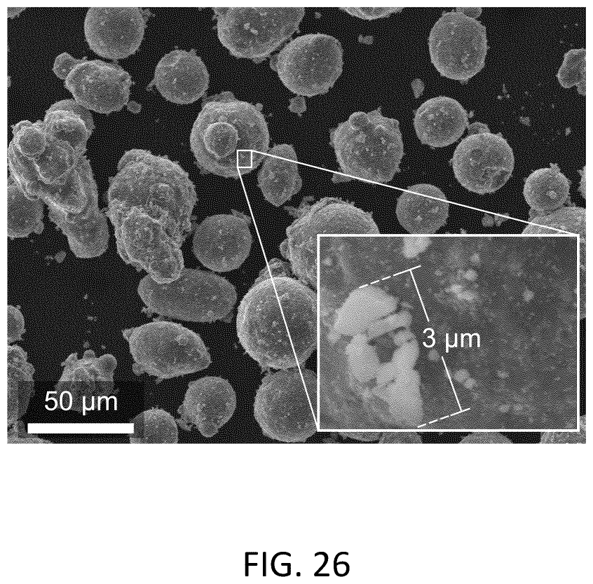

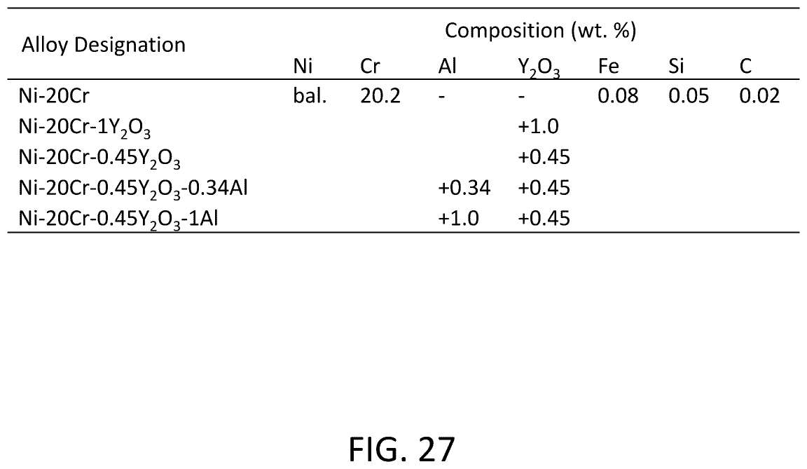

ODS powder feedstocks were prepared by decorating gas-atomized Ni-20Cr, wt % powder with Y₂O₃ nanopowder via resonant acoustic mixing (RAM). FIG. 26 shows Ni-20Cr powder coated with Y₂O₃ dispersoids. The high-magnification inset shows larger micron-scale Y₂O₃ clusters as well as nanoparticles, likely formed through comminution of larger clusters during RAM. The Ni-20Cr powder had a size distribution between 10 and 54 μm, with a mean particle size of 20 μm and a mean circularity of 0.83. RAM-coating with Y₂O₃ preserved the size distribution, spheroidal shape, and flowability of the powder feedstock. Al alloying was accomplished by mechanically blending gas-atomized equiatomic NiAl powder with the ODS feedstock. The different powder compositions are summarized in FIG. 27.

### 3.1.2 Printing Parameters

Test cubes (1×1×1 cm³) were printed using an EOS M100 L-PBF printer equipped with a ˜1040 nm Yb fiber laser (beam power: 200 W; beam radius: 20 μm) in an inert Ar atmosphere (˜0.1% O₂). All samples were produced with a 5 mm striped scanning strategy, 67° interlayer rotation, 40 μm hatch spacing, and 20 μm layer thickness. Parameter studies were conducted in which the laser power and scan speed were independently varied over the ranges 0.6-2.2 m/s and 60-170 W.

### 3.1.3 Structural Characterization

The relative density of the test cubes was assessed using Archimedes' method as well as stereological techniques. Select specimens were mounted, cross-sectioned, polished (9 and 3 μm diamond suspensions followed by 0.02 μm colloidal silica), and imaged using optical and electron microscopy. Optical microscopy was used to assess lack of fusion defects, porosity, cracks, and the presence of slag inclusions. Scanning electron microscopy (SEM) was used to characterize larger oxide dispersoids as well as slag inclusions. Wavelength dispersive spectroscopy (WDS) measurements were used to compare the composition of the as-printed material with the composition of the feedstock.

Thin lamellar specimens were extracted from the as-printed material, ground, then thinned via electropolishing and imaged in a Talos F200X G2 scanning transmission electron microscope (STEM) equipped with a Super-X EDS system. These STEM measurements were used to characterize the shape, size distribution, and composition of nanoscale dispersoids.

### 3.1.4 Small Angle Neutron Scattering (SANS)

SANS was used to characterize the dispersoid structure in the as-printed specimens. The samples were analyzed on the HFIR CG2 (GP-SANS) beamline at Oak Ridge National Laboratory. Each scattering spectrum was collected over two hours using standard configurations: collimation 17m/SDD 19m/12 Å; collimation 6m/SDD 6m/4.75 Å; and collimation 6m/SDD 1m/4.75 Å. The scattering spectra were analyzed using IRENA to determine the dispersoid size distributions, assuming spherical dispersoids, and the dispersoid volume fraction, assuming the scattering length density contrast between Y₂O₃ and Ni-20Cr was |Δρ|²=1.2×10²¹ cm⁻⁴.

### 3.2 Experimental Results and Discussion

### 3.2.1 L-PBF Parameter Studies

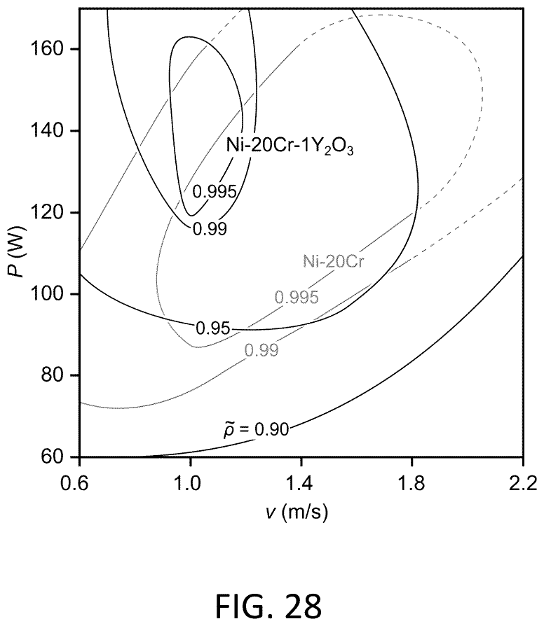

Viable printing conditions for the Ni-20Cr and Ni-20Cr-1Y₂O₃ materials were determined through parameter studies in which the beam power and scan speed were independently varied. FIG. 28 summarizes the relative density (P) measurements from these parameter studies. The baseline Ni-20Cr material achieved full density over a wide processing window—scan speeds between 0.9 and 1.8 m/s and laser powers between 90 and 160 W. The ODS material had a narrower processing window (0.8-1.2 m/s; 120-160 W) with slower scan speeds and higher powers to achieve full density. This result is consistent with findings where successful consolidation of Y₂O₃-coated materials required higher energy densities than their non-ODS counterparts. This trend was linked to a reduction in laser absorptivity from the oxide nanoparticles on the powder feedstock surface. Parameters within the Ni-20Cr-1Y₂O₃ processing window (0.8-1.6 m/s; 100-170 W) were used to print materials with varying Al and Y₂O₃ concentrations. Modifying the composition did not affect printability or degrade density; however, it did affect the dispersoid size distribution as discussed below.

### 3.2.2 Structural Characterization

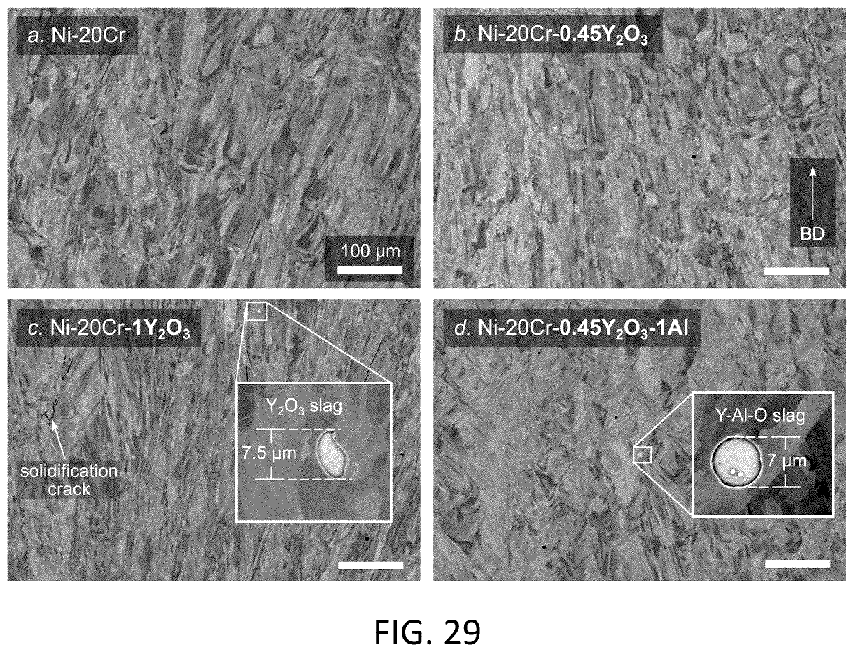

To illustrate the effect of alloy composition, FIG. 29 compares backscatter electron micrographs of Ni-20Cr, ODS Ni-20Cr, and ODS Ni-20Cr alloyed with 1 wt % Al printed using similar parameters. The baseline Ni-20Cr and ODS variant with 0.45 wt % Y₂O₃ were fully dense and defect-free. The ODS variants with 1 wt % Y₂O₃ and with 1 wt % Al contained micron-scale oxide slag inclusions (cf. insets, where the bright inclusions were confirmed through EDS measurements to be Y₂O₃ in FIG. 29(c) and mixed Y—Al—O in FIG. 29(d)). Formation of Y—Al—O slag is consistent with reactions between Y₂O₃ and Al during L-PBF, where they form low melting point mixed oxides (YAlO₃, Y₃Al₅O₁₂) that rapidly coarsen and agglomerate. Ni-20Cr-1Y₂O₃ also contained solidification cracks, possibly linked to Y segregation to grain boundaries above a threshold Y₂O₃ content. All materials featured columnar grains aligned with the build direction except for the variant with 1 wt % Al, which had more equiaxed grains. The ODS variant with 0.34 wt % Al is not shown, but was nearly defect-free, with a columnar grain structure similar to Ni-20Cr-0.45Y₂O₃. These observations suggest a change in oxide structural evolution behaviors above a threshold Al content.

The bulk-averaged Y concentration in the 0.45 wt % Y₂O₃ alloy was 0.12 wt %, as measured with WDS. Assuming Y is sequestered in Y₂O₃, this corresponds to a retained Y₂O₃ concentration of 0.16 wt % (0.2 at %), substantially less than the Y₂O₃ concentration in the powder feedstock. Y₂O₃ loss was also observed in the other ODS materials. Y₂O₃ loss may be attributed, in part, to slag formation and material loss. WDS measurements of the alloys doped with Al showed identical Al content in the powder feedstock and as-printed material, indicating a lack of Al volatilization.

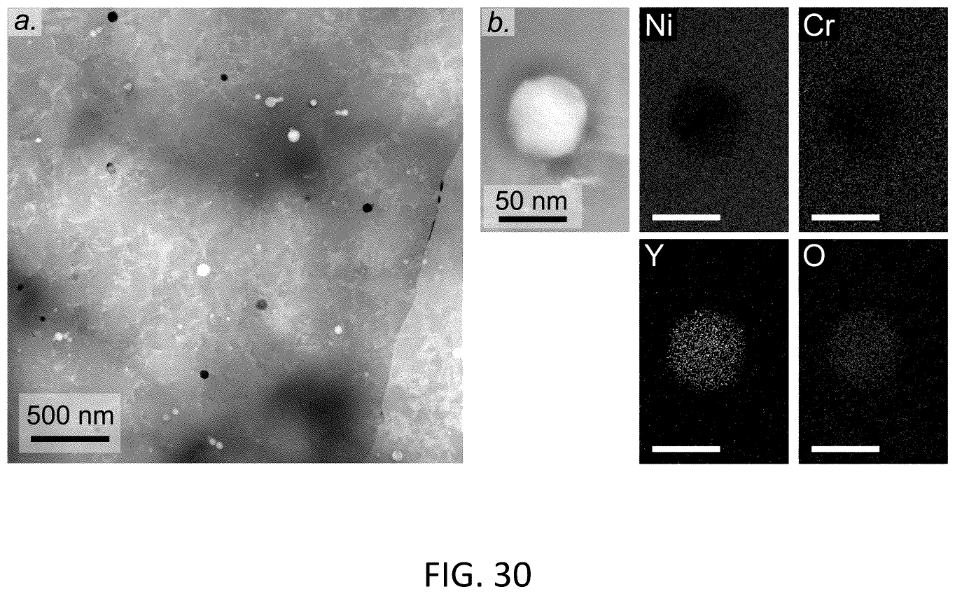

FIG. 30 presents a STEM HAADF micrograph of the as-printed Ni-20Cr-0.45Y₂O₃ material as well as EDS measurements of an exemplary nanoscale dispersoid. The bright circular features in FIG. 30 are Y₂O₃ dispersoids, confirmed through EDS measurements. The dark circular features exhibit no EDS signal and are therefore assumed to be voids from dispersoid pullout during sample preparation. Dispersoids with diameters between 8 and 115 nm were observed. Resolving dispersoids smaller than 20 nm was challenging because they had low contrast against the matrix and were obscured by the dense dislocation network.

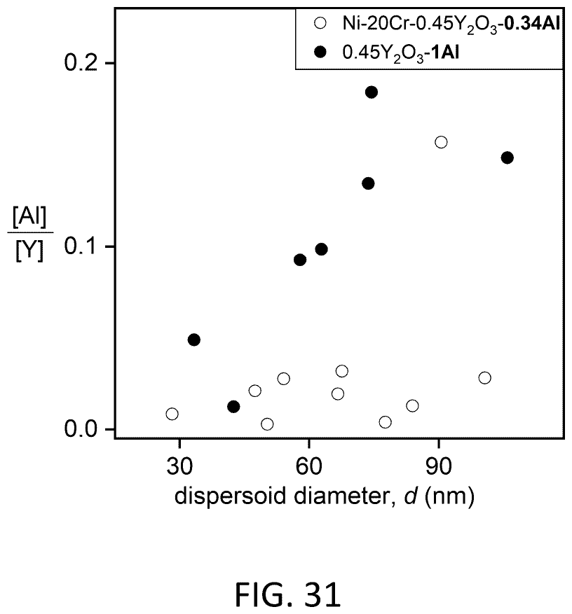

STEM micrographs of the ODS materials alloyed with Al were qualitatively similar to that in FIG. 30, except the dispersoids were slightly larger, suggesting accelerated coarsening kinetics in the presence of Al. EDS measurements of dispersoid chemistry which might indicate reactions between Y₂O₃ and Al were complicated by the fact that the interaction volume includes the metal matrix surrounding the particle. Thus, to estimate the atomic ratio of Al to Y in each dispersoid, the following expression was used to subtract the matrix signal:

$$\frac{[ Al ]}{[ Y ]} = \frac{{[ Al ]}_{d}}{{[ Y ]}_{d}} - \frac{{[ Al ]}_{m}}{{[ Y ]}_{d}} \frac{{[ Ni ]}_{d}}{{[ Ni ]}_{m}} \qquad ( 3.1 )$$

where terms in brackets are atomic concentrations measured through EDS, and the subscripts d and m refer to measurements of the embedded dispersoid and of the baseline metal matrix at a dispersoid-free location. The atomic ratio of Al to Y measured this way is plotted against dispersoid size in FIG. 31. The dispersoids in the 0.3 wt % Al alloy have negligible Al content. By contrast in the 1 wt % Al alloy there is significant Al enrichment, with the Al content increasing with dispersoid size. The largest dispersoids have an Al to Y ratio of ˜0.2. For comparison, the Al to Y ratio is 0.33 at the Y₂O₃/Y₄Al₂O₉ eutectic. These findings indicate that Al can react with nanoscale dispersoids, potentially having an important role in the earliest stages of oxide structural evolution.

The above results reveal three key features of oxide structural evolution during L-PBF of ODS alloys, informing the models in Section 3.3. First, the as-printed material contains spherical nanoscale dispersoids that are uniformly dispersed throughout the metal matrix. Second, the volume fraction of these dispersoids is less than anticipated based on the feedstock composition. This is potentially because of slag formation and spatter. Third, Al reacts with Y₂O₃, concentrating in larger Y₂O₃ dispersoids and promoting slag formation. The latter finding further emphasizes the role of material chemistry in oxide structural evolution.

### 3.2.3 SANS Measurements of Dispersoid Size Distribution

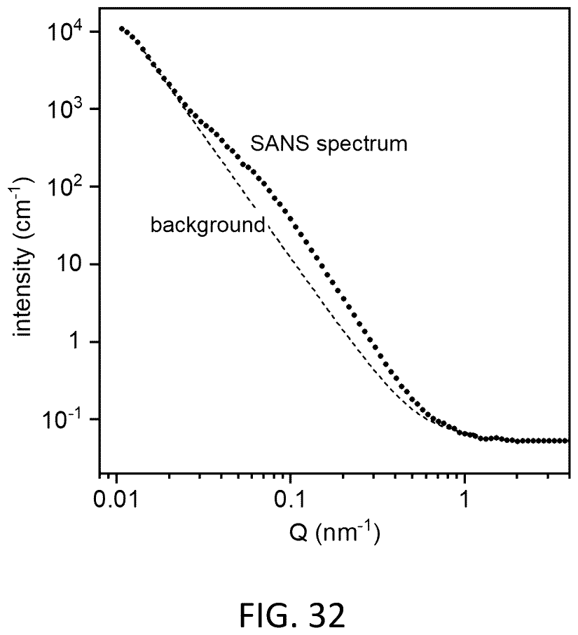

Two limitations of using electron microscopy to measure the dispersoid size distribution are the small sample volumes and the difficulty of resolving sub-10 nm dispersoids. Here, these challenges were overcame using SANS, which benefits from large interaction volumes (˜5 mm³) and can resolve dispersoids over the complete anticipated size range. FIG. 32 shows the SANS spectrum collected from a Ni-20Cr-0.45Y₂O₃ specimen, printed using P=140 W, v=1.2 m/s. The form of the spectrum within the Q-range 0.02-0.6 nm⁻¹ indicates a nanoscale second phase, with diameters between 7 and 100 nm, in line with our STEM measurements.

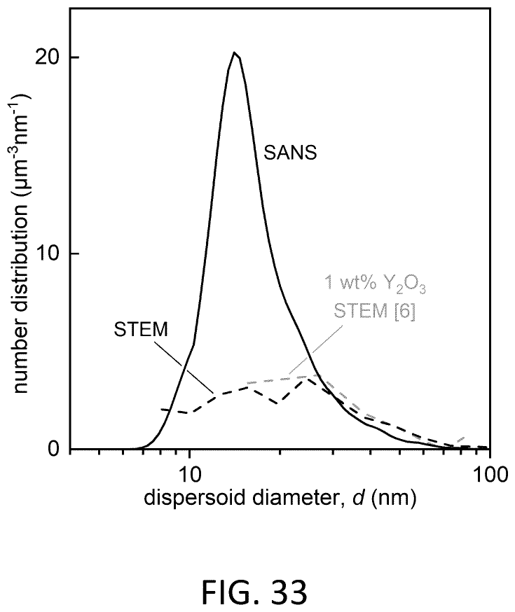

FIG. 33 shows the dispersoid size distribution calculated using the SANS spectrum in FIG. 32. For comparison purposes, STEM measurements of the dispersoid size distribution and data for a similar alloy (Ni-20Cr-1Y₂O₃) processed under comparable conditions (P=200 W, v=0.9 m/s, r_{B}=50 μm) are included. The STEM number density is calculated assuming a mean lamella thickness of 100 nm. The SANS distribution is approximately log-normal, with a mean dispersoid size of 21 nm. The volume percent of Y₂O₃ dispersoids is 0.24%, in line with the WDS measurement of 0.27 vol %, confirming Y is present as Y₂O₃. While there is good agreement between our STEM measurements and the data for Ni-20Cr-1Y₂O₃, comparing the SANS and STEM dispersoid size distributions shows that STEM undercounts dispersoid sizes smaller than 25 nm. This systematic error in the STEM data arises from the aforementioned challenges with resolving dispersoids (cf. Section 3.2.2). As a result, the STEM measurements yield a larger mean dispersoid size (21 nm in SANS vs. 28 nm in STEM) and lower dispersoid number density (230 vs. 120 μm⁻³). Additionally, SANS has a statistically significant sampling volume of order 5 mm³, which corresponds to roughly 10¹¹ dispersoids, roughly nine orders of magnitude greater than the sample sizes in STEM.

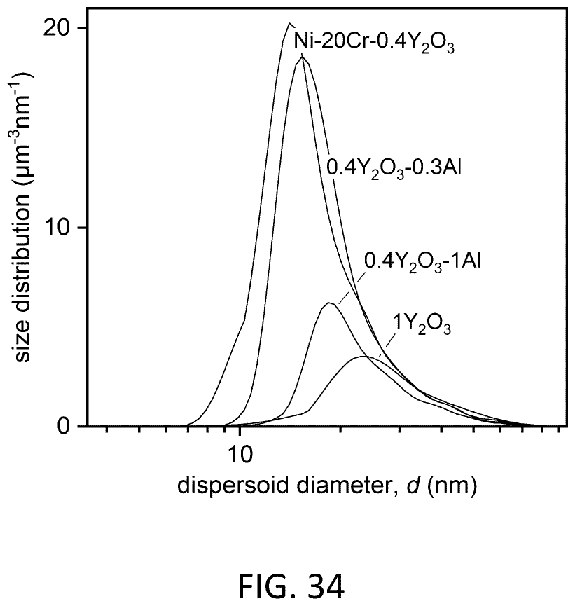

FIG. 34 compares the SANS dispersoid size distribution of specimens with varying Al and Y₂O₃ content, all printed with the same parameters (P=140 W, v=1.2 m/s). Increasing the Al content to 1 wt % caused the mean dispersoid size to increase from 21 to 27 nm and the volume percent of dispersoids to decrease from 0.24 to 0.15 vol %. Al additions decreased dispersoid concentration across the full range of dispersoid sizes, and in the 1 wt % Al material, essentially eliminated sub-20 nm dispersoids. These missing dispersoids were likely incorporated into slag. Increasing the Y₂O₃ concentration also resulted in a larger mean dispersoid size. The mean dispersoid size of the 1 wt % Y₂O₃ material was 33 nm, nearly twice that of the baseline material with 0.45 wt % Y₂O₃. Interestingly, both materials had the same final Y₂O₃ volume percent of 0.24%.

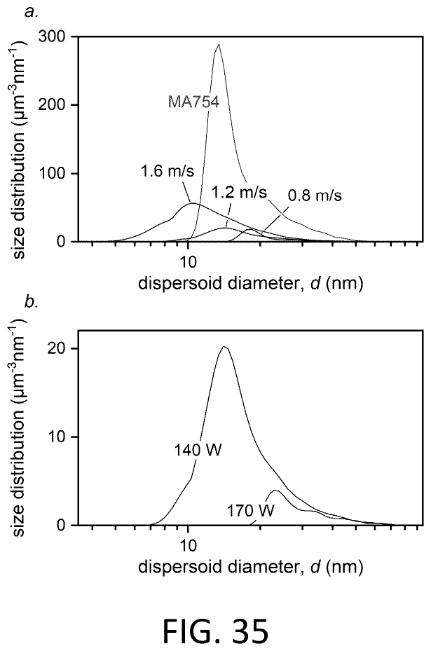

FIG. 35 shows the effects of beam power and scan speed on the dispersoid size distribution. The trends in FIG. 35 show increasing the beam power and decreasing the scan speed increased the dispersoid size and lowered the dispersoid number density. Y₂O₃ content varied from 0.17 to 0.25 vol % and was generally lower for parameter combinations that prolonged the melt time.

For comparison FIG. 35(a) includes SANS measurements of the dispersoid size distribution in wrought MA754 (Ni-20Cr-0.34Al-0.43Ti-0.6Y₂O₃), an ODS alloy with a similar composition to the alloys of present interest. MA754 had a mean dispersoid size of 19 nm, dispersoid number density of 2000 μm⁻³, and dispersoid volume fraction of 1.45%. The L-PBF ODS material printed with the fastest beam speed (1.6 m/s) had a mean dispersoid size of 16 nm, a dispersoid number density of 600 μm⁻³, and a dispersoid volume fraction of 0.25%. Thus, while the L-PBF and wrought materials can achieve similar dispersoid sizes, the number density and volume fraction of dispersoids in the L-PBF material are an order of magnitude lower, pointing towards a smaller strengthening increment in L-PBF materials.

### 3.2.4 Overview of Experimental Observations

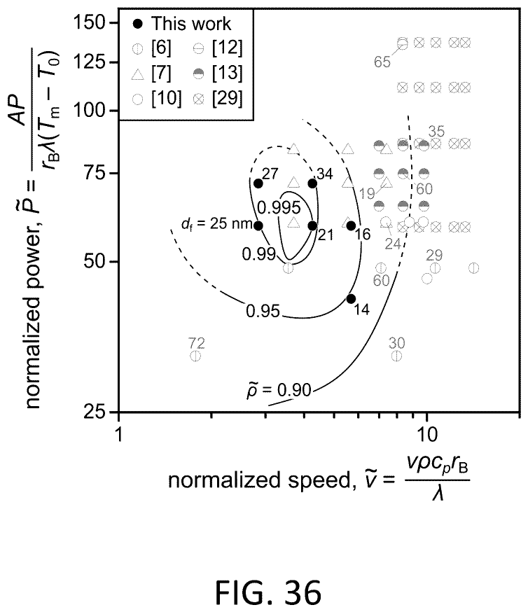

The experimental results can be understood in the context of other work on L-PBF ODS Ni-base alloys using FIG. 36, an L-PBF process diagram which aggregates the data from this study and other related studies. Generally, different studies use different processing conditions, L-PBF printers, etc. To facilitate direct comparisons, FIG. 36 has axes of dimensionless laser power \tilde{P} and scan speed \tilde{v}, defined as:

$$\tilde{P} = \frac{AP}{{r}_{B} λ ( {T}_{m} - {T}_{0} )} \qquad ( 3.2 )$$

$$\tilde{v} = \frac{v ρ {c}_{p} {r}_{B}}{λ} \qquad ( 3.3 )$$

where r_{B} is the beam radius, A is absorptivity (assumed to be 0.3), λ is thermal conductivity, and ρcₚ is volumetric heat capacity (3×10⁶ J/m³K). The aggregated data is clustered in \tilde{P}-\tilde{v} space, near the transition between melting and vaporization, where keyhole melting dominates.

The labels in FIG. 36 indicate mean dispersoid size. The measurements of dispersoid size are the smallest reported to date, likely because past studies assessed dispersoid size using electron microscopy, while this study used SANS, which has the advantages mentioned above. The lack of clear trends in the aggregated dispersoid size data reflects variations in hatch spacing and alloy chemistry. However, in the two datasets that contain multiple dispersoid size measurements, which includes this study, it is clear that increasing scan speed and decreasing beam power result in smaller dispersoids.

Ultimately, scan speed and beam power should fully densify the feedstock, thus limiting the practical processing window and the smallest achievable dispersoid size. To illustrate this point, FIG. 36 is overlaid with the relative density isocontours of FIG. 28. Comparing these datasets shows that ˜20 nm is the smallest achievable dispersoid size in fully-dense as-printed material. However, there may be multi-step processing routes that unlock smaller dispersoids; e.g., printing 95% dense material with a 14 nm dispersoid size, then eliminating residual porosity through post-process hot isostatic pressing.

The experimental results provide direct quantitative evidence of several trends. They also highlight key differences between wrought ODS alloys and their L-PBF counterparts that may limit the creep resistance of L-PBF ODS alloys. Specifically, wrought and L-PBF materials have similar dispersoid sizes, but the dispersoid density of wrought materials is an order of magnitude higher. Furthermore, wrought ODS materials such as MA6000 can benefit from y′-strengthening through Al alloying additions, whereas L-PBF ODS alloys develop slag when alloyed with Al, even in small quantities around 1 wt %. In the following section, a quantitative physics-based model of dispersoid structural evolution is developed to identify strategies for achieving wrought-like dispersoid structures via melt-based additive manufacturing.

### 3.3 Modeling Dispersoid Structural Evolution

### 3.3.1 Scaling Analysis

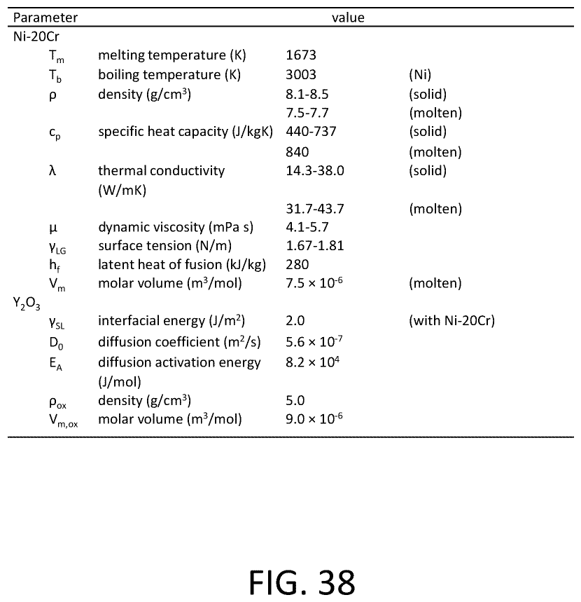

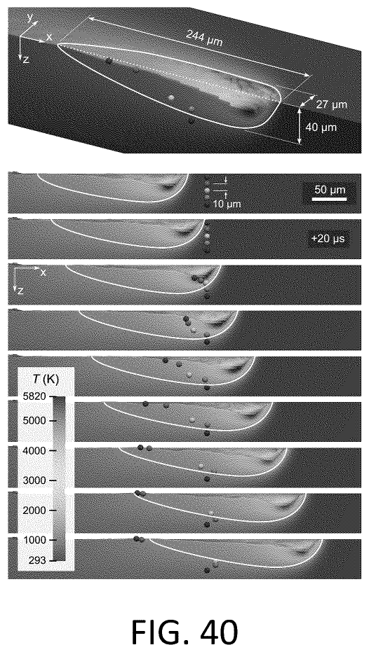

Developing a quantitative model of oxide structural evolution requires knowledge of the dominant oxide coarsening mechanisms, which vary with processing conditions, alloy chemistry, and dispersoid size. To determine which mechanisms dominate under specific conditions, a scaling analysis of momentum and mass transport may be used. First, flow behaviors within the melt pool and in the vicinity of the dispersoids are assessed by computing their respective Reynolds numbers,

$$Re = \frac{ρ vl}{μ} ,$$

where μ is dynamic viscosity, ρ is fluid density, and l and v are characteristic length scale and fluid velocity. The characteristic length scale and velocity of the melt pool are the melt pool dimensions, defined in FIG. 40, and the Marangoni-driven fluid velocity vₘₑₗₜ. The present calculations assume a melt pool length (l) of 240 μm and depth (h) of 40 μm, typical values in L-PBF. The characteristic fluid velocity of surface tension-driven flow is (see Section 3.6):

$${v}_{melt} = \frac{Δ {T}_{VM} ( d {γ}_{LG} / dT )}{4 μ} \frac{h}{l} \qquad ( 3.4 )$$

where ΔT_{VM} is the difference between the alloy vaporization and melting temperatures, dγ_{LG}/dT is the surface tension coefficient, and h/l is the melt pool aspect ratio. Inserting values for L-PBF of Ni-20Cr from FIG. 38 into Eq. 3.4 gives vₘₑₗₜ=5 m/s. This value gives a Re number of order ˜2000, suggesting that at least in the tail of the melt pool the flow is borderline laminar.

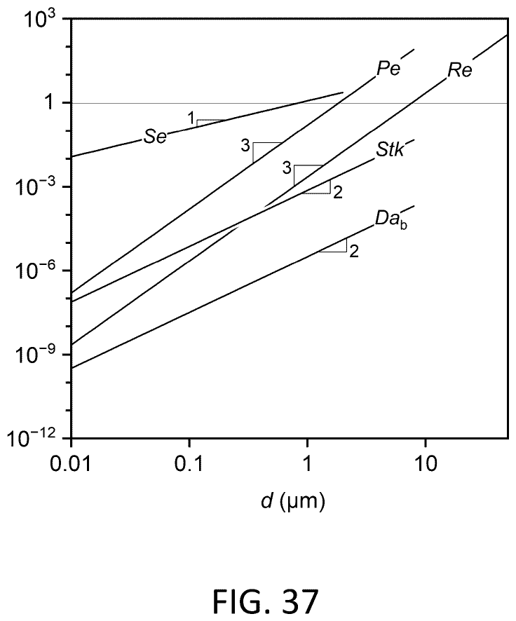

Dispersoids may move relative to the surrounding flow due to the large density difference between the metal matrix (˜8-9 g/cm³ for Ni-base superalloys) and the dispersoid (5 g/cm³ for Y₂O₃). Relative motion of the dispersoids is associated with a local disturbance in the flow field which transitions from the dispersoid velocity, vₚ, at the interface (i.e., no slip) to vₘₑₗₜ in the far field. The characteristic length scale and velocity of the local Re number near an oxide are the oxide diameter, d, and a local relative velocity between the oxide and the bulk fluid velocity, vᵣₑₗ=vₚ−vₘₑₗₜ, which depends on the flow regime (e.g., creeping vs. inviscid). If it is assumed that the nanoscale dispersoids experience creeping flow, their vᵣₑₗ can be estimated using Stokes law (see Section 3.6):

$${v}_{rel} = \frac{Δ ρ {v}_{melt} {d}^{2}}{9 μ {t}_{res}} \qquad ( 3.5 )$$

where Δρ is the density difference between the oxide and the melt, and tᵣₑₛ is the residence time of a fluid element (˜100 us for L-PBF). Values of local Re, calculated using Eq. 3.5, are plotted as a function of oxide diameter in FIG. 37, which shows that Re is less than unity for oxide particles smaller than 8 μm and is of order 10⁻⁹-10⁻⁶ for nanoscale dispersoids, justifying the earlier assumption of creeping flow.

Recognizing that nanoscale dispersoids experience creeping flow, the significance of coarsening via mechanical impingement is assessed by computing two additional dimensionless quantities: the buoyancy number

$$( {Da}_{b} = \frac{4 {t}_{res} Δρ {gd}^{2}}{27 μ h} )$$

which compares residence time to the particle floatation timescale, and the Stokes number

$$( Stk = \frac{Δ ρ {v}_{melt} {d}^{2}}{18 μ l} )$$

which compares the timescale for a suspended particle to match the velocity of the surrounding flow to the melt pool flow timescale

$$( \frac{{v}_{melt}}{l} ) .$$

FIG. 37 shows that the buoyancy and Stokes numbers are both much less than unity for dispersoids smaller than 5 μm, indicating that small particles will follow streamlines and avoid agglomeration via floatation. In addition, the time reversibility of Stokes flow guarantees particles that are initially separated will remain separated. Taken together, these results indicate that oxide particle coarsening via impingement of particles is unlikely for oxides smaller than 5 μm.

Dimensionless quantities are also computed, which provide insight into diffusion-mediated structural evolution mechanisms. To assess the significance of mass-transport via advection, the Peclet number

$$( Pe = \frac{{v}_{rel} d}{2 D} )$$

is calculated, where D is the chemical diffusivity of dissolved oxide (of order 8×10⁻⁹ m²/s [34]). FIG. 37 shows Pe<<1 for dispersoids smaller than 800 nm, indicating advection is insignificant for nanoscale dispersoids. Further, the separation number

$$( Se = \frac{1}{4 \sqrt{{Dt}_{res}}} \frac{d}{{V}_{f , ox}^{1 / 3}} ) ,$$

i.e., the ratio of the mean dispersoid separation distance to the diffusion length scale, is less than unity for oxides smaller than 100 nm, establishing that nanoscale dispersoids are sufficiently close for local diffusive mass transport between neighboring particles.

Considering the various dimensionless numbers FIG. 37, it may be concluded that nanoscale dispersoids experience creeping flow, with limited motion relative to the local environment, and evolve through diffusion-mediated structural evolution processes. By contrast, micron-scale oxides experience additional coarsening mechanisms. Oxides larger than 2 μm have Peclet numbers greater than unity and grow primarily through advection. Advection is generally faster than diffusion and may accelerate coarsening in oxides that have grown to this threshold size. Oxides larger than 10 μm are no longer bound by creeping flow and may coarsen via impingement or by agglomerating at the surface, further accelerating coarsening. The model focuses on the 10-100 nm dispersoids (see Section 3.3), where diffusion is the dominant mass transfer mechanism and which impart the most creep resistance. Based on the dispersoid evolution behavior in this size range, however, the set of conditions that permit dispersoids to grow to the accelerated coarsening regime and form slag is predicted (see Section 3.4).

### 3.3.2 Model Framework

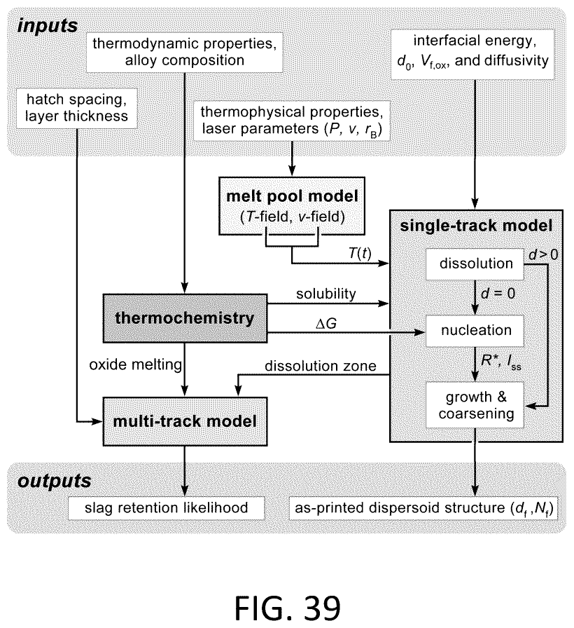

Motivated by the preceding scaling analysis, a modeling framework is developed, summarized in FIG. 39, for predicting the oxide structure in L-PBF ODS alloys. First, a reduced order model is used, calibrated with computational fluid dynamics, to compute the time-temperature trajectories of fluid elements throughout the melt pool. Next these time-temperature trajectories are fed into numerical simulations which track dispersoid size and number density as they evolve through dissolution, nucleation, growth, and coarsening over a single melt cycle. Two other key inputs for the numerical simulations are temperature-dependent solubility and the free energy change of the oxide upon precipitation, which come from a thermochemical model which takes into account alloy composition. For processing conditions that fully dissolve the dispersoids in the feedstock, the dispersoid size and number density after the single melt cycle are representative of the bulk as-printed dispersoid structure and are thus the desired output. Processing conditions that only dissolve a fraction of the dispersoids in the feedstock are assessed for likelihood of slag retention through a multi-track model, i.e., the dissolution zone model, developed in Section 3.4.

The present framework implements simplified, computationally efficient models that capture the essential physics. For instance, classical mean field theory is used to describe the particle growth kinetics, rather than population tracking models. This approach sacrifices some precision for the ability to capture major trends and allows for the high-throughput parametric calculations needed for the dissolution zone model in Section 3.4.

### 3.3.3 Thermal Excursions in the L-PBF Melt Pool

Computational fluid dynamics (CFD) is used to obtain the thermal excursion of fluid elements as they translate with the flow, replicating the time-temperature history that oxides experience from initial melting through solidification. Detailed modeling of the thermal excursion is critical because quantities that govern dispersoid evolution—e.g., diffusivity, solubility, nucleation rate-vary strongly with temperature. After an initial analysis following from the CFD model, simplifying assumptions are used in Section 3.3.7 to develop an analytical reduced order model of the temperature field for high-throughput calculations.

Single-track L-PBF simulations were performed using the commercial CFD package Flow-3D. Temperature-dependent thermophysical properties of Ni-20Cr used for the simulations are listed in FIG. 38. The low oxide concentration in the present ODS alloys (˜0.24 vol %) is expected to have a negligible effect on the melt pool flow behavior. Most thermophysical properties of the melt are insensitive to nanoscale dispersoids. An exception is melt viscosity, which can be affected by the presence of nanoparticles. However, the dispersoid volume fraction in the present study is an order of magnitude lower than when such effects become significant. Moreover, oxides influence bulk viscosity when present as a dispersed second phase, which exists only in cooler regions of the melt pool (see Section 3.3.4), where convection is less significant. Thus, omitting dispersoid effects on viscosity maintains the underlying physics and is unlikely to affect the results.

Equations for heat conduction, mass conservation, and momentum conservation were solved numerically using implicit first order schemes. The free surface at the top of the melt pool is tracked using the split Lagrangian method. Additional physics modeled include: energy loss and recoil pressure from vaporization; latent heat effects during melting and solidification; and Marangoni convection, using temperature-dependent surface tension data of Ni-20Cr.

The simulation domain, which encompassed half of the symmetrical melt track (FIG. 40), was 1.2 mm long, 120 μm wide, and 120 μm deep, with a 20 μm gap above the fluid region to allow surface deformation. The center plane of the melt track was assigned a symmetry boundary condition. The top boundary was set to maintain constant ambient pressure and temperature. All remaining surfaces were assigned wall boundary conditions with constant ambient temperature. The mesh contained 205,000 cells and was graded with fine cells (1 μm) at the center of the melt track, where there are large fluid velocities and thermal gradients, transitioning to coarse cells (10 μm) at the periphery. The simulation was run for 850 μs. After approximately 400 μs, the melt pool reaches steady state. The steady-state melt boundary, temperature field, and velocity field were used to model dispersoid evolution.

FIG. 40 presents time series images of a melt pool during L-PBF with laser parameters P=140 W, v=1.2 m/s, and r_{B}=20 μm. The temperature field is non-uniform, exceeding the Ni-20Cr boiling temperature directly under the laser. The melt pool is defined as the region where the temperature is higher than the Ni-20Cr solidus (Tₘ=1673 K). For this and subsequent analyses, it is assumed there is a single melting temperature, equal to the solidus because of the narrow melting range of Ni-20Cr (1673-1690 K). The steady-state melt pool is 244 μm long, 54 μm wide, and 40 μm deep. The Eagar-Tsai model for conduction-mode melting by a Gaussian heat source predicts a shorter, wider melt pool (175 μm long, 82 μm wide, 35 μm deep). This discrepancy arises because the CFD model accounts for Marangoni-driven flow while Eagar-Tsai does not.

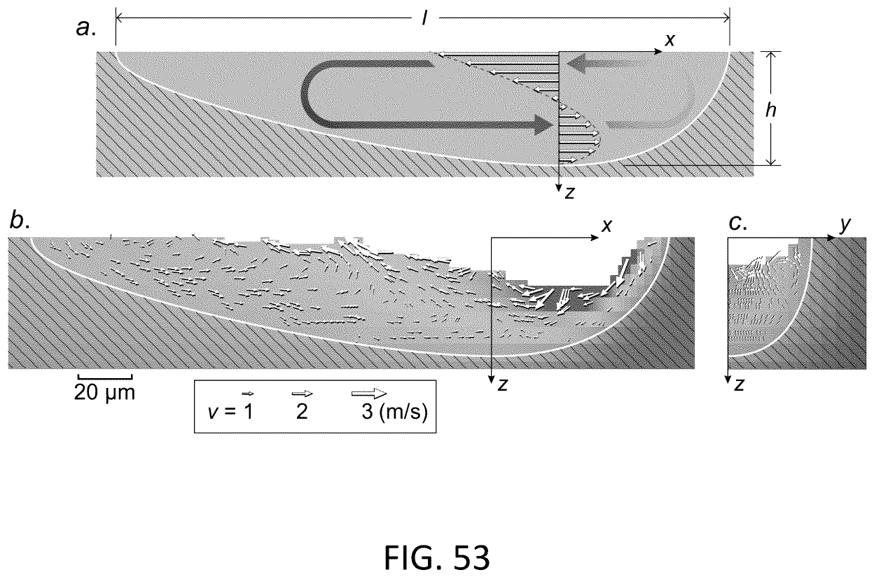

A thermal gradient on the melt pool surface, of order 107 K/m, creates a gradient in surface tension that accelerates fluid away from the laser spot, towards the melt pool periphery. The resulting velocity field is shown in Section 3.6 (see FIG. 53), which shows that the dominant fluid motion is along the x-axis, opposite the scan direction, with a maximum velocity of 4.1 m/s and mean velocity (v̅ₓ) of 0.45 m/s. The maximum velocity agrees well with the analytical order-of-magnitude estimate of 5 m/s (see Section 3.6). There is also motion in the transverse directions, with y- and z-components attaining maximum speeds of 4.1 m/s and 8.1 m/s, respectively. However, transverse motion is only significant near the vapor depression. As a result, the average velocities along the y- and z-directions are relatively slow −0.04 and 0.1 m/s, respectively.

FIG. 40 shows tracer particles placed at various depths along the melt pool symmetry plane. These tracer particles were used to measure thermal excursions of fluid elements traversing the melt pool. The particles primarily move in the x-direction, with the largest displacements near the surface. The tracers exited the melt pool via solidification before re-entering the convection cell, experiencing a single thermal excursion during the melt cycle. In general, full recirculation at the melt-pool scale is unlikely in L-PBF because the average residence time (l/vₗₐₛₑᵣ≈200 μs) is less than the time required to complete a single convection cycle (2 l/v̅ₓ≈1 ms). A simulation performed with a large array of tracer particles shows that while circulatory mixing occurs in the y-z plane, individual particles do not recirculate. This is consistent with previous experimental results: although the maximum fluid velocity is of the same order as the laser scan velocity near the vapor depression, the median velocity is significantly slower, precluding full recirculation of individual fluid elements. Consequently, typical L-PBF thermal excursions are expected to feature a single peak in temperature, in contrast with the oscillating thermal cycles observed in large, slow-moving weld pools.

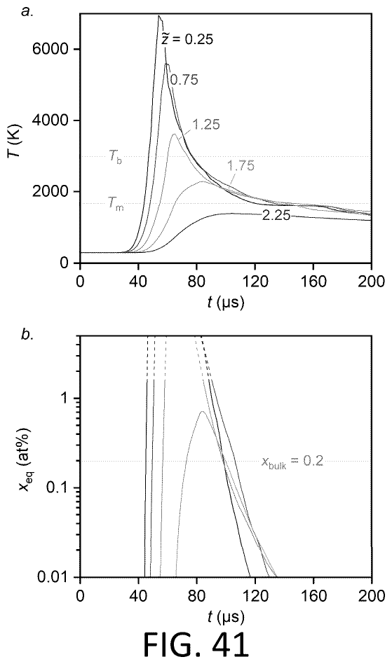

The thermal excursions experienced by the tracer particles are shown in FIG. 41(a). The labels indicate the initial depth of each tracer particle normalized by the beam radius

$$\tilde{Z} = \frac{z}{{r}_{B}} .$$

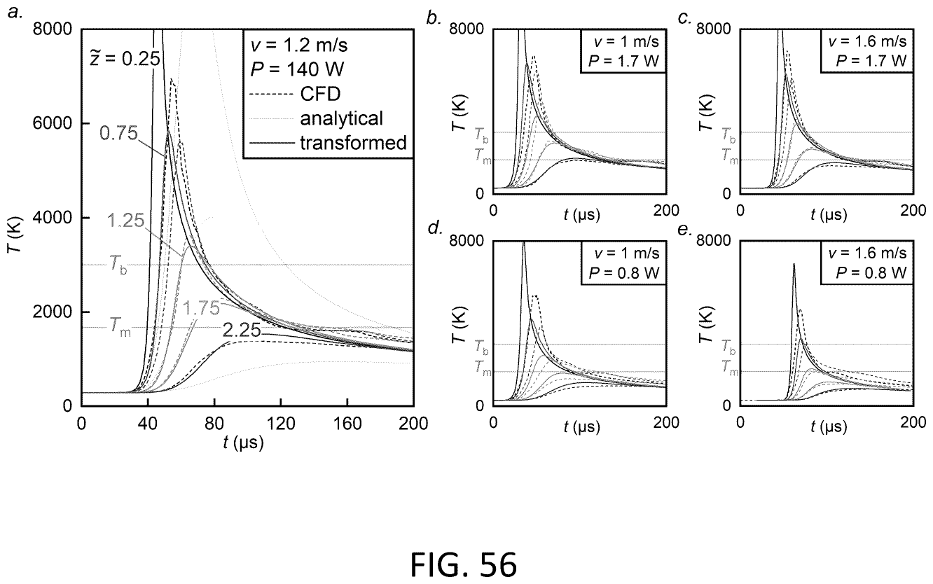

While the thermal excursions are qualitatively similar to those expected from the Eagar-Tsai solution (see comparison in see Section 3.8, FIG. 56(a)), there are two differences. First, for trajectories near the surface, the peak of the thermal excursion in the CFD simulations is narrower due to rapid acceleration from the laser spot by the surface tension-driven flow. Second, trajectories underneath the surface experience higher temperatures in CFD because of heat redistribution via convection as well as depression of the melt pool from the vapor recoil pressure.

The wide temperature range in the melt pool reinforces the need for a detailed treatment of dispersoid evolution at the sub-melt pool scale. At the same time, the present observations also motivate a reduced order heat conduction model modified to reproduce the time-temperature profiles from CFD. This is developed in Section 3.3.7.

### 3.3.4 Oxide Solubility

Another key input for modeling dispersoid evolution is the solubility of the oxide in the alloy melt. Assuming thermodynamic equilibrium at the oxide-metal interface, the solubility of Y₂O₃ follows from the reaction:

$$〈 {Y}_{2} {O}_{3} 〉 ↔ {2 [ Y ]}_{Ni} + {3 [ O ]}_{Ni} \qquad ( 3.6 )$$

where angled brackets indicate pure states and square brackets indicate chemical species dissolved in the alloy matrix. The free energy change associated with this reaction is:

$$Δ G ° ( T ) = - Δ G {°}_{{Y}_{2} {O}_{3}}^{f} + 2 Δ G {°}_{Y}^{sol} + 3 Δ G {°}_{O}^{sol} \qquad ( 3.7 )$$

where the temperature-dependent energies of the constituent reactions are as follows: ΔG°_{Y}_{₂}_{O}_{₃}^{f} is the energy of formation of Y₂O₃, ΔG°_{Y}^{Sol} is the heat of solution of Y in Ni, and ΔG°_{O}^{Sol} is the heat of solution of O in Ni. The equilibrium constant for this reaction is:

$$\frac{{a}_{Y}^{2} {a}_{O}^{3}}{{a}_{{Y}_{2} {O}_{3}}} = {K}_{c} ( T ) = exp ( - \frac{Δ G °}{RT} ) \qquad ( 3.8 )$$

where a is the activity. The activity of pure Y₂O₃, a_{Y}_{₂}_{O}_{₃}, is approximated as unity. The activities of dissolved Y and O (a_{Y}, a_{O}) are approximated as their respective mole fractions x_{Y} and x_{O} (e.g., activity coefficients f_{Y} and f_{O} are set to unity) due to the lack of thermodynamic data for the Ni—Y—O ternary over the temperature range of interest.

Following these approximations, Eq. 3.8 simplifies to x_{Y}²x_{O}³═K_{c}(T). Stoichiometric dissolution of Y and O dictates that

$${x}_{Y} = \frac{2}{3} {x}_{O} ,$$

providing the constraint necessary to solve Eq. 3.8:

$${x}_{Y} = {( \frac{8}{27} {K}_{c} ( T ) )}^{1 / 5} and {x}_{O} = {( \frac{9}{4} {K}_{c} ( T ) )}^{1 / 5} \qquad ( 3.9 )$$

The quantity

$${x}_{eq} = {x}_{Y} + {x}_{O} = 5 {( \frac{{K}_{c} ( T )}{108} )}^{1 / 5}$$

is the solubility of Y₂O₃, i.e., the combined mole fraction of Y and O atoms dissolved in the alloy matrix at equilibrium. For the discussion of oxide dissolution, growth, and coarsening kinetics that follows, Y₂O₃ is treated as a monatomic substance, with Y and O having the same diffusivity and proportional solubility. This simplifying assumption is warranted given uncertainty in other model inputs (e.g., surface energy, chemical diffusivity) at the melt pool temperatures.

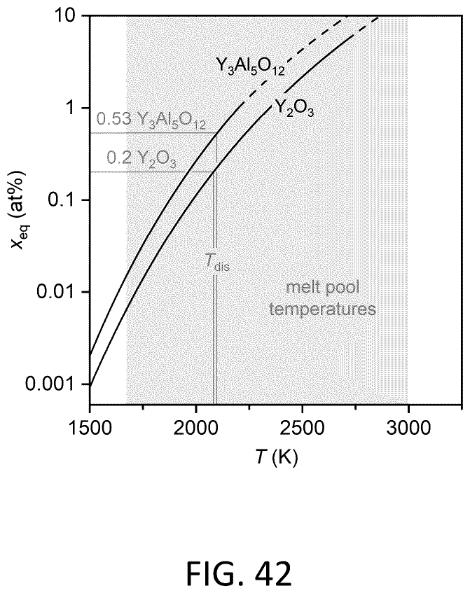

Y₂O₃ solubility is plotted against temperature in FIG. 42, which shows oxide solubility is negligible (<0.01 at %) at the Ni-20Cr melting temperature then rises sharply to the bulk Y₂O₃ content of 0.2 at % at 2080K. At 2345 K, the solubility of Y₂O₃ exceeds 1 at %, the maximum Y₂O₃ content in conventional ODS alloys. When the peak melt pool temperature exceeds this threshold, dissolution of oxide dispersoids is thermodynamically feasible. In the case of L-PBF ODS Ni-20Cr, 2345 K is well below the peak temperatures predicted by our CFD simulations, suggesting dispersoids can fully dissolve within the melt.

The temperature for full dissolution (T_{dis}) is several 100K below the Y₂O₃ melting temperature (2711 K). Nanoscale oxides, which dissolve quickly, should therefore dissolve while still solid. However, larger oxides, whose dissolution rate is diffusion-limited, may melt prior to dissolving, as shown analytically in Section 3.7. This is consistent with the solidification structures in slag and other evidence of Y₂O₃ melting. Section 3.3.5 discusses the kinetics of dissolution and whether an oxide of a given size fully dissolves.

To assess the effect of Al, the same solubility calculations were performed, supposing that the Y₂O₃ in the alloy reacted completely with Al and O to form either YAlO₃ or Y₃Al₅O₁₂. The equilibria for oxide dissolution become:

$$〈 {YAlO}_{3} 〉 ↔ {[ Y ]}_{Ni} + {[ Al ]}_{Ni} + {3 [ O ]}_{Ni} \qquad ( 3.1 )$$

$$〈 {Y}_{3} {Al}_{5} {O}_{12} 〉 ↔ {3 [ Y ]}_{Ni} + {5 [ Al ]}_{Ni} + {12 [ O ]}_{Ni} \qquad ( 3.11 )$$

These mixed Y—Al—O phases (i.e., YAlO₃ and Y₃Al₅O₁₂) are less stable than Y₂O₃, with lower melting temperatures (see FIG. 42) and free energies of dissolution. The analysis given by Eqs. 3.7-3.9 is repeated with the added Al component. The resulting solubilities are compared with that of Y₂O₃ in FIG. 42, which shows that alloying with Al doubles the solubility of the Y—Al—O phases as compared to Y₂O₃. This increased solubility accelerates several diffusion-controlled processes, with important implications for dispersoid structure. Furthermore, because of the lower melting temperatures of YAlO₃ or Y₃Al₅O₁₂, oxide structural evolution processes (e.g., oxide dissolution, nucleation) that occur while Y₂O₃ is solid may instead happen while the oxide is molten after reacting with Al.

### 3.3.5 Oxide Dissolution Kinetics

The degree to which oxide particles dissolve is controlled by the thermal excursion, bulk oxide content, and oxide size. FIG. 41(b) tracks the oxide solubilities for the thermal excursions in FIG. 41(a). The Y₂O₃ solubility along several trajectories far exceeds the maximum Y₂O₃ content of ˜1-2 at % in conventional ODS alloys. Although such high Y₂O₃ concentrations are never attained in the far-field melt, there may be local transient enrichment of Y₂O₃ near the oxide-metal interface as the oxides dissolve. The timescale over which the solubility exceeds the bulk Y₂O₃ concentration is of order 50 μs, providing a characteristic timescale for dispersoid dissolution.

The dissolution kinetics of Y₂O₃ in Ni are not well characterized. However, the dissolution reaction is expected to proceed rapidly at the elevated temperatures in the melt pool, suggesting that the overall oxide dissolution process will be rate-limited by diffusion. Accordingly, it is assumed that the concentration of dissolved Y₂O₃ at the oxide-alloy interface instantaneously reaches the equilibrium value determined by Eq. 3.9 and the local temperature. Given a lack of data on temperature-dependent diffusion in liquid Ni, the diffusivity of all species is approximated as

$$D = {D}_{0} exp ( - \frac{{E}_{A}}{RT} ) ,$$

with D₀ and E_{A} taken from the diffusion of O in liquid Fe. This simplification is justified since chemical diffusivities in liquid alloys are typically of order 10⁻⁹ m²/s near the alloy melting temperature. D ranges from 1.6×10⁻⁹ to 2.1×10⁻⁸ m²/s between the melting and vaporization temperatures of Ni-20Cr.

To estimate the extent of oxide dissolution, it is recognized that the diffusion timescale around a spherical particle, r²/D, is of order 1 μs for 100 nm-scale dispersoids, much faster than the typical thermal excursion of order 100 μs. Accordingly, a quasi-steady state approximation is used to describe the concentration field around a dissolving particle. Solving the 1D diffusion equation in spherical coordinates gives:

$$\frac{dd}{dt} = - \frac{4 {V}_{m , ox} D ( {x}_{eq} - {x}_{∞} )}{{V}_{m} d} \qquad ( 3.12 )$$

where x_{eq} and x_{∞} are the equilibrium and far-field oxide concentrations, respectively. x_{∞} is tracked throughout the simulation via mass conservation as the oxide dissolves into and precipitates from the alloy matrix.

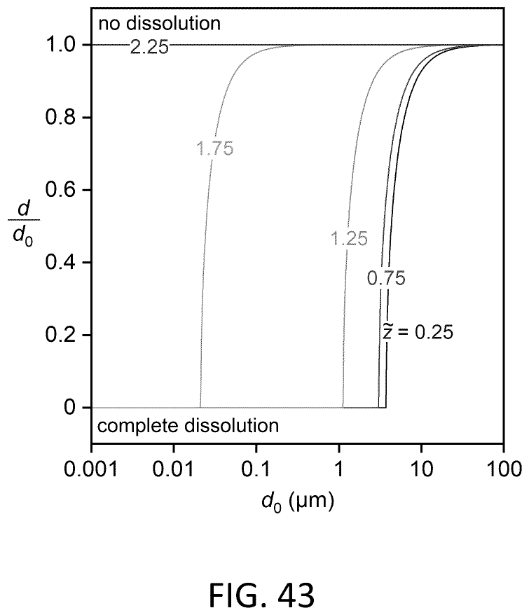

FIG. 43 shows reduction in oxide diameter post-dissolution for various initial oxide diameters (d₀), when exposed to the thermal excursions in FIG. 41, following the dissolution law in Eq. 3.12. The degree to which an oxide dissolves is strongly affected by both its initial size and the thermal excursion (e.g., its initial location within the melt track). As an example, the \tilde{z}=0.25 curve, which represents dispersoids traversing the center of the melt track, shows that oxides smaller than 4 μm fully dissolve whereas oxides larger than 6 μm are relatively unaffected. The transition from full dissolution to negligible dissolution occurs over a doubling of the oxide diameter, a relatively narrow size range compared to the range of oxide diameters observed in L-PBF ODS alloys. Thus, for a given thermal excursion, there is a critical initial dispersoid size below which oxide particles fully dissolve. This critical dissolution size (d_{dis}) shifts towards smaller diameters for trajectories farther from the laser spot, with faster, cooler thermal excursions. In FIG. 43, this critical size decreases from 5 μm to 20 nm as \tilde{z} increases from 0.25 to 1.75.

This critical dissolution size has important implications for dispersoid evolution and slag formation. Dispersoids smaller than 20 nm completely dissolve throughout most of the melt pool. Therefore, if all oxides are smaller than 20 nm prior to the melt cycle, none of the initial oxide dispersoid population is retained after a single melt pass, and the size of as-printed oxides is solely determined by precipitation phenomena upon cooling. However, the Y₂O₃ particles in AM ODS feedstock are typically larger than 20 nm. For example, the Y₂O₃ feedstock contains clusters ranging in size from several 100 nm to several μm. Through comminution during RAM, some clusters break down to form a coating of 10-100 nm diameter oxides, but, crucially, micron-scale clusters remain (see FIG. 26). Oxides in the size range of 100 nm to 1 μm dissolve if they pass through the hot core of the melt pool, but are retained if they pass through the cooler periphery. Oxides that fail to substantially dissolve after one melt cycle may continue to coarsen during subsequent melt cycles, leading to undesirable slag inclusions in the final part. Clearly, Y₂O₃ feedstock on the 10 nm-scale is preferred for achieving fine dispersoids. However, larger feedstock may be admissible given judicious selection of printing parameters as discussed in Section 3.4.1.

### 3.3.6 Oxide Nucleation, Growth, and Coarsening

After oxide dissolution during the heating and initial cooling stages of the thermal excursion, the alloy matrix is enriched with dissolved Y₂O₃. After the solubility decreases below the equilibrium concentration upon cooling, the dissolved oxide precipitates via homogeneous nucleation. Once nuclei have formed, two competing processes consume the remaining supersaturation of Y₂O₃: growth and continued nucleation. Growth is defined here as the accretion of dissolved Y₂O₃ onto existing oxides over the full-size range, consuming material from the supersaturated solution in the far field. Growth is distinct from coarsening, in which larger oxides coarsen at the expense of smaller oxides due to capillary effects. Fundamentally, oxide growth and coarsening are significant despite the brief melt cycle because the mean separation of sub-100 nm dispersoids is smaller than the characteristic chemical diffusion distance associated with the duration of the thermal excursion (cf. separation number in Section 3.3.1). This section discusses the modeling of nucleation, growth, and coarsening of oxides. These processes proceed concurrently when the alloy is supersaturated with dissolved oxides. For typical L-PBF thermal excursions, the excess Y₂O₃ in solution is consumed rapidly through growth, and the Y₂O₃ content approaches equilibrium values. Thereafter, oxides may still evolve through coarsening, until Y₂O₃ solubility and diffusivity become negligible, typically around the alloy solidification temperature.

Nucleation is modeled with classical nucleation theory. The free energy of precipitation, −ΔG° (T), is the negative of Eq. 3.7 in Section 3.3.4. Precipitate nuclei with a radius that increases the work of formation, i.e., the critical radius, will coarsen monotonically. The critical radius is:

$${R}^{*} = \frac{2 {γ}_{SL}}{- Δ G ° ( T ) / {V}_{m , ox}} \qquad ( 3.13 )$$

where γ_{SL} is the interfacial energy between the oxide and the liquid alloy matrix and V_{m,ox} is the oxide molar volume. The work of formation corresponding to the critical radius is:

$${W}_{R}^{*} = \frac{16 π {γ}_{SL}^{3}}{3 {( Δ G ° ( T ) / {V}_{m , ox} )}^{2}} \qquad ( 3.14 )$$

Nucleation rate can then be calculated as:

$${I}_{ss} = 4 π ZD ( T ) {{R}^{*} ( \frac{{N}_{A}}{{V}_{m}} )}^{2} ( {x}_{∞} - {x}_{eq} ) {x}_{∞} exp ( - \frac{{W}_{R}^{*}}{{k}_{B} T} ) \qquad ( 3.15 )$$

where N_{A} is Avogadro's constant and Z is the Zeldovich factor. Z is approximated as

$$\frac{3 {( Δ G ° ( T ) / {N}_{A} )}^{2}}{4 \sqrt{π {k}_{B} T} {( S {λ}_{SL} )}^{3 / 2}} ,$$

where S is a geometric factor equal to

$$\sqrt[3]{36 π {Ω}^{2}}$$

for spherical nuclei and Ω is the average atomic volume. Z is of order 0.2 in the present study.

The interfacial energy between the oxide and molten alloy matrix is difficult to estimate and may vary with temperature. If the oxide is pure Y₂O₃, then it likely nucleates directly as a solid in molten Ni-20Cr (the present model predicts nucleation occurring over the temperature range 2000-2400K, well below the Y₂O₃ melting temperature of 2711K). In this case, the interfacial energy can be estimated from sessile drop studies of liquid Ni-20Cr on a solid Y₂O₃ substrate, which give interfacial energies of 1.5-2 J/m² over the temperature range 2000-2400K.

If Y₂O₃ reacted with Al to form YAlO₃ or Y₃Al₅O₁₂, the oxide may nucleate as a liquid droplet, depending on the temperature at which nucleation sets on (˜T_{dis}) and is therefore influenced by the oxide concentration in the alloy. As an example, the retained 0.2 at % of Y₂O₃ in the experimental samples is expected to nucleate at 2070 K. If the Y₂O₃ content is increased to 0.5 at %, nucleation would begin at 2250K, where YAlO₃ or Y₃Al₅O₁₂ are molten. The interfacial energy between molten oxides and liquid Ni-20Cr is poorly characterized. Further research into interfacial chemistry of molten Y—Al—O phases and the alloy matrix is required for detailed modeling of the oxide evolution when the oxide concentration is in excess of ˜0.3 at % in an Al-bearing alloy. As a simplification in this study, the molten oxides are assumed to have the same interfacial energy as solid Y₂O₃.

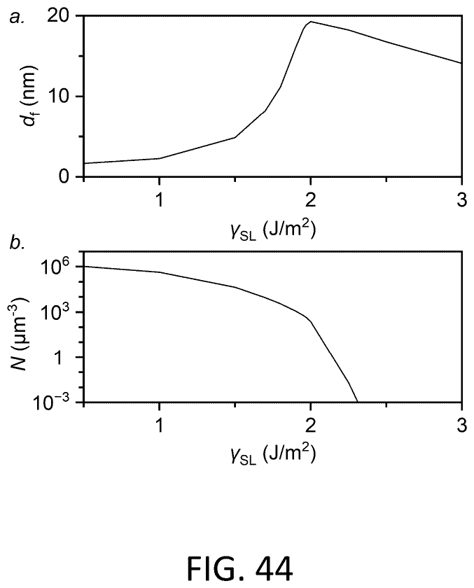

FIG. 44 is a sensitivity study on the effect of interfacial energy on final dispersoid diameter (d_{f}) and number density (N). When the interfacial energy is low, the energetic barrier to nucleation is small, and nucleation proceeds rapidly. Consequently, there are more nuclei on which dissolved Y₂O₃ precipitate, leading to a small final dispersoid size and a high dispersoid number density. If the interfacial energy is below 1 J/m², the as-printed dispersoid diameter may be smaller than 2 nm, much smaller than the dispersoid sizes in conventional materials or observed in the present SANS measurements. The largest final dispersoid size is around 20 nm, assuming an interfacial energy of 2 J/m². As the interfacial energy increases above 2 J/m², the alloy should cool to a lower temperature, approaching alloy solidification, for nuclei to form. At such low temperatures, Y₂O₃ diffusion becomes too slow for substantial nucleation and growth. For example, with 3 J/m², dispersoids grow to only 14 nm and have a number density orders of magnitude smaller than with 2 J/m². In addition, the alloy matrix remains supersaturated with dissolved Y₂O₃. Although there are reports of additional dispersoids precipitating during post-process heat treatments, there is no evidence that the oxides form a homogeneous metastable solid solution. Based on this discussion, γ_{SL}=2 J/m² is set as the sole fitted parameter in the following calculations because it gives predicted final dispersoid sizes that align well with experimental measurements and values for the interfacial energy between molten Ni-20Cr and solid Y₂O₃.

After dispersoids nucleate, their diameter increases via diffusional growth, according to Eq. 3.12, in the reverse of the dissolution process described in Section 3.3.5, and also via coarsening. Coarsening is modeled using classical coarsening theory:

$$\frac{dd}{dt} = \frac{16 {V}_{m , ox γ SL}^{2} {Dx}_{∞}}{3 {V}_{m} RT {d}^{2}} \qquad ( 3.16 )$$

Coarsening is found to have a minor impact on final dispersoid size because once the dispersoids nucleate, the diffusivity is too slow to support significant coarsening over the brief thermal excursion.

The dispersoid size on cooling was calculated by numerically evaluating Eqs. 3.12-3.16 along each particle trajectory, using a forward Euler scheme and accounting for concurrent nucleation, growth, and coarsening. These calculations used the local instantaneous values of temperature, oxide size, chemical diffusivity, and Y₂O₃ concentration within the melt at each timestep. Nuclei are assumed to enter the system at the critical radii defined in Eq. 3.13, at a rate determined by Eq. 3.15. Instead of tracking the full dispersoid size distribution, the volume average dispersoid size is computed for the combined population of existing oxides and new nuclei at the end of each timestep. This simplification allows fast calculations for the dissolution zone model and parameter studies developed in Section 3.4. A convergence study was used to select a timestep of 8 ns, corresponding to approximately 104 steps from melting to solidification.

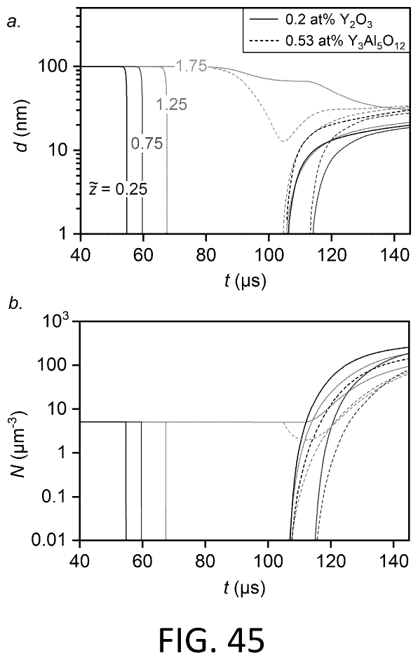

FIG. 45 tracks the size and number density of a dispersoid population with initial size d₀=100 nm, following the exemplary trajectories from FIG. 41. Trajectories near the center of the melt pool (\tilde{z}=0.25, 0.75, 1.25) exhibit complete dispersoid dissolution. Along these trajectories nucleation sets on when the temperature drops below 2080 K and is complete within ˜20 μs. During and after nucleation, dispersoids simultaneously grow and coarsen. All structural evolution processes halt after the alloy solidifies. The dispersoid size and number density remain constant thereafter.

For trajectories in which dispersoids fully dissolve, there are only minor differences in the final dispersoid size (˜20 nm) and dispersoid number density (˜100 μm⁻³). This is because all trajectories experience similar cooling profiles in the tail of the melt pool (see FIG. 41), resulting in similar oxide evolution behaviors after nucleation.

For trajectories near the edge of the melt track (e.g., \tilde{z}=1.75 in FIG. 45) 100 nm dispersoids do not fully dissolve. These dispersoids are retained through the hottest portion of the thermal excursion, shrinking to ˜70 nm then growing and coarsening upon cooling. Because the timescale for chemical diffusion between the undissolved dispersoids (8 μs) is similar to the dispersoid nucleation timescale (20 μs), the dissolved Y₂O₃ is expected to redistribute via two different pathways, plating onto the undissolved dispersoids and also forming new nanoscale dispersoids via nucleation. This results in a bimodal dispersoid size distribution, with one group near the initial size and another group determined by nucleation, growth, and coarsening. The present model only tracks average dispersoid sizes. The full dispersoid size distribution could be modeled using population tracking schemes; however, detailed population tracking is unnecessary for the central aim of modeling dispersoid evolution, because large dispersoids that resist dissolution eventually agglomerate into slag and exit the dispersoid evolution process, an insight used in Section 3.4.1 to determine conditions for slag formation.

When Al is incorporated into the oxide (broken lines in FIG. 45), the increased oxide solubility in the melt accelerates all diffusion-based structural evolution mechanisms. This leads to faster growth, resulting in a ˜60% increase in dispersoid size compared to an Al-free alloy processed under the same conditions. Effects of Al are expanded upon in Section 3.4.1 to explain slag formation.

To gauge the significance of collision coarsening due to Brownian motion, the expected time for a given dispersoid to collide with another dispersoid,

$${t}_{coll} = \frac{3 μ}{8 {k}_{B} TN} ,$$

is obtained by rearranging the Smoluchowski coagulation equation assuming monodisperse dispersoids. The collision timescale ranges from 1 ms to 1 s during the period from the onset of nucleation to solidification, longer than the time available for collisional coarsening (40 μs). Two factors limit the collision rate at different portions of the melt cycle. During initial nucleation (t=108 to 112 μs), when Brownian diffusion is fast, the particle concentration is limiting since most of the Y₂O₃ is still in solution. During continued nucleation and growth (t=112 to 145 μs), when the particle concentration is high, Brownian diffusion is slow due to the higher viscosity. Consequently, fewer than 5% of dispersoids are expected to collide during the melt cycle, and collisional coarsening is neglected in the model. This is consistent with analysis that shows collisions should not affect as-printed number density given the nucleation rates in the present study (of order 10²⁴-10²⁵ m⁻³s⁻¹), but may become significant when fabricating ODS alloys with high dispersoid number densities.

### 3.3.7 Dispersoid Evolution During Single-Pass Melting

The preceding results are integrated into a framework for assessing the oxide structure that results after a single melt pass. Instead of relying on computationally expensive CFD simulations to compute the thermal excursion of each fluid element, a reduced order model is introduced for the steady-state temperature field within the melt pool. The temperature field is calculated in two steps. First, the Eagar-Tsai model is used, which only considers heat conduction, to compute the temperature within a semi-infinite body subjected to a distributed heat flux Iₐ, scanning the free surface with speed v:

$$( 3.17 )$$

$$T ( x , y , z ) = {T}_{0} + \frac{1}{2 π λ} {\int }_{- ∞}^{∞} {\int }_{- ∞}^{∞} {I}_{a} \frac{exp [ \frac{v ρ {c}_{p}}{2 λ} ( ( x - {x}_{1} ) - \vert \vec{r} - {\vec{r}}_{1} \vert ) ]}{\vert \vec{r} - {\vec{r}}_{1} \vert} {dy}_{1} {dx}_{1}$$

where the origin is defined as the laser center. The heat flux for a gaussian beam is:

$${I}_{a} ( x , y ) = \frac{2 AP}{π {r}_{B}^{2} exp ( - 2 \frac{{x}^{2} + {y}^{2}}{{r}_{B}^{2}} )} \qquad ( 3.18 )$$

Next, the results from this calculation are scaled to account for surface tension-driven convection, following the procedure in Section 3.8. The thermal excursion predicted through this two-step procedure agrees reasonably well with the CFD results (cf. FIG. 56 in Section 3.8), especially during the cooling stages of the melt cycle which ultimately determine dispersoid size and number density. The most significant deviation occurs near the peak of the thermal excursion for trajectories close to the surface, where the scaled Eagar-Tsai solution is higher than the CFD result. This discrepancy does not seriously affect the oxide evolution because all oxides of interest (those initially smaller than 1 μm) are fully dissolved in both cases (cf. FIG. 43). Changes in effective absorptivity with degree of keyholing are not accounted for. Consequently, the framework slightly underpredicts the final dispersoid size at high laser powers and slow scan speeds in Section 3.4.3.

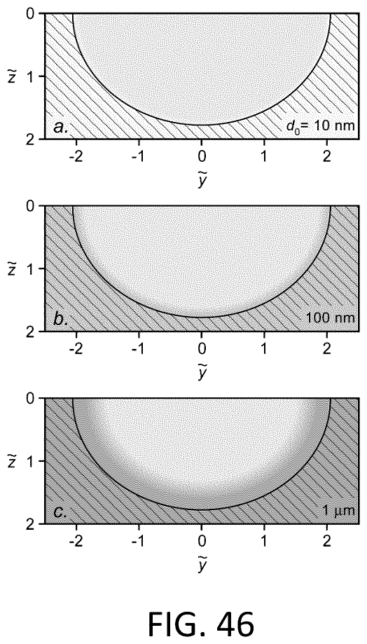

This reduced order model is used to compute thermal excursions along different locations across the melt pool cross-section. Dissolution, nucleation, growth, and coarsening are modeled over each thermal excursion to predict the final local dispersoid size. FIG. 46 summarizes results from these calculations, assuming P=140 W and v=1.2 m/s and varying initial dispersoid size. FIG. 46 shows that, over the standard range of Y₂O₃ feedstock sizes, there is a zone in the center of the melt track in which the oxide feedstock fully dissolves and the final Y₂O₃ diameter is independent of feedstock size. Within this dissolution zone, the final Y₂O₃ diameter is spatially uniform, varying by less than 5% between the center and the boundary. This homogenous dispersoid size results from the relatively uniform cooling rate. Outside the dissolution zone, dispersoid size increases with distance from the laser, approaching the feedstock size at the melt pool boundary.

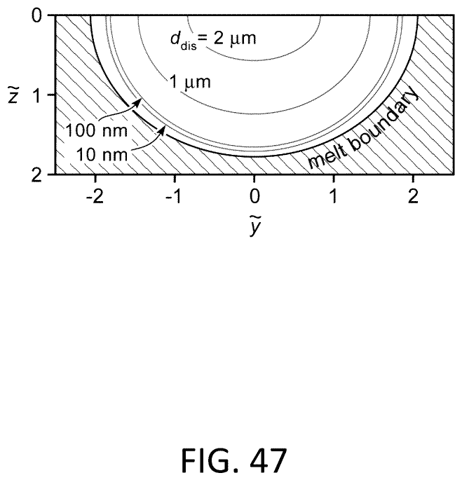

The present results demonstrate how dissolution can erase details of the initial Y₂O₃ feedstock from the final as-printed dispersoid structure. FIG. 47 presents the same melt track cross-section, overlaid with dissolution zones for varying initial dispersoid sizes. These results show that even 1 μm diameter dispersoids fully dissolve across 60% of the cross-section. With careful control of melt track overlap, as discussed in the following section, a nanoscale oxide dispersion may still be achieved. However, if the feedstock Y₂O₃ is much larger than 1 μm, the full dissolution region shrinks to less than half of the melt track, making it impractical to achieve nanoscale dispersoids through dissolution of larger oxide feedstock.

### 3.4 Implications for L-PBF of ODS Alloys

### 3.4.1 Dissolution Zone Model of Dispersoid Evolution and Slag Retention

The melt pool comprises two regions with disparate dispersoid evolution behaviors: inside the dissolution zone, where oxide particles fully dissolve and subsequently nucleate to form nanoscale dispersoids of spatially uniform diameter; and outside the dissolution zone, where oxide particles partially dissolve and the dispersoid sizes range between that within the dissolution zone and the initial size at the melt pool boundary (cf. FIG. 46). An important consequence of this finding is that an ensemble of dispersoids which formed in the dissolution zone after a single laser pass will recover to the same diameter during subsequent passes even if it lies outside the dissolution zone. It follows that if the dissolution zones of adjacent melt tracks overlap sufficiently with each other to dissolve large oxides that formed during printing or were present in the powder feedstock, then the dispersoid structure throughout the build volume is homogeneous and matches that from a single pass within the dissolution zone. A model simplification follows: assuming complete dissolution zone coverage, the dispersoid size in the bulk material is accurately predicted by tracking dispersoid evolution on a single trajectory passing through the center of the melt pool. The present results show that it is conditionally valid through modeling spatial variations in transport-driven dispersoid evolution across the melt pool cross section. This simplification serves as the basis for the dissolution zone model used to predict slag formation and generate process diagrams below.

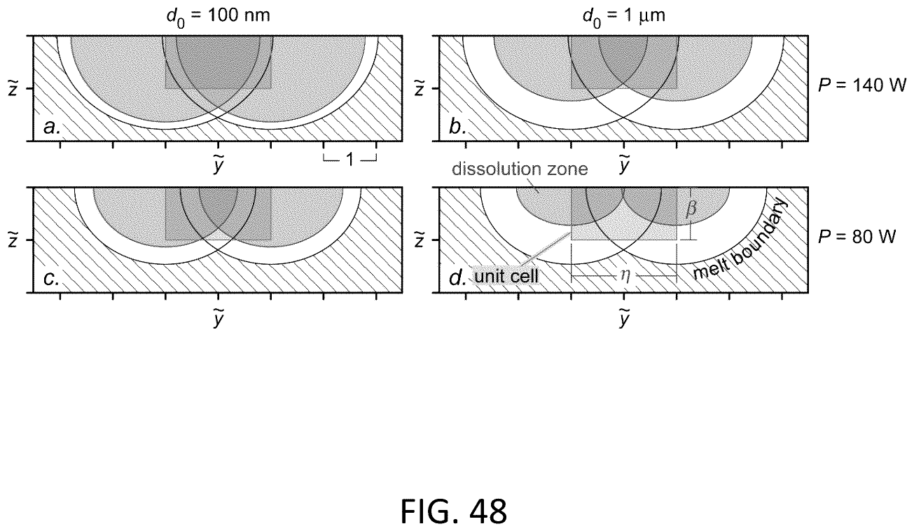

The volume fraction of printed material that passes through the dissolution zone depends on processing conditions and initial oxide size, and can be assessed using the melt track cross-sections shown in FIG. 48. A unit cell is first defined with cross-sectional dimensions given by the hatch spacing η and layer thickness β (yellow-shaded rectangle in FIG. 48). The build volume can be filled by stacking unit cells, with appropriate interlayer rotation to match the scanning strategy. The volume fraction of dissolution zone material corresponds to the area fraction of the unit cell covered by the dissolution zone (red-shaded area in FIG. 48).

In FIG. 48(a), dissolution zones from neighboring tracks completely cover the unit cell, resulting in a uniform distribution of ˜20 nm dispersoids, formed via nucleation. The dissolution zones in FIG. 48(a) are relatively large, covering most of the melt track, because the initial 100 nm dispersoids are readily dissolved by the thermal excursions throughout most of the melt pool. Increasing the initial dispersoid size to 1 μm as shown in FIG. 48(b) reduces the dissolution zone coverage. Decreasing the laser power has a similar effect, as shown in FIG. 48(c). Both of these adjustments decrease the size of the dissolution zone. With hatch spacing and layer thickness kept constant, i.e., unit cell size held fixed, the smaller dissolution zone translates directly to less coverage.

The dissolution zone model reveals how to select printing parameters (P, v, η, β) to ensure adequate dissolution zone overlap, given an initial feedstock Y₂O₃ size. This approach is analogous to how melt pool overlap was used to predict as-printed relative density. Gaps between dissolution zones will result in spatial variations in dispersoid size and multi-modal size distributions, potentially containing oxides large enough for advection-accelerated growth. For example, a feedstock containing micron-scale oxides processed with P=80 W, v=1.2 m/s, η=40 μm, and β=20 μm will produce a fully dense material but only achieve ˜50% dissolution zone coverage (FIG. 48(d)). Micron-scale oxides outside the dissolution zone will survive the dissolution portion of the thermal excursion and grow larger upon cooling. Micron-scale oxides are large enough to experience relative motion against the surrounding melt (i.e., Pe>1 for oxides larger than 1 μm in FIG. 37) and grow at a much faster rate through advection (see Section 3.3.1). The scaling analysis in FIG. 37 further shows that when these oxides grow to ˜10 μm, the Stokes number becomes larger than unity. Accordingly, the oxide will deviate from streamlines, impinge upon neighboring oxides, and grow rapidly through agglomeration. In this manner, the combination of the dual adverse conditions—large oxides in the feedstock and poor dissolution zone coverage—may cause runaway oxide coarsening, eventually resulting in slag formation.

### 3.4.2 Case Studies Based on the Dissolution Zone Model

Several case studies are presented below to illustrate the predictive ability of the dissolution zone model as well as its limitations. In each study, dissolution zone coverage is assessed using the reported values of experimental parameters (laser power, scan speed, beam radius, hatch spacing, layer thickness, initial oxide size).

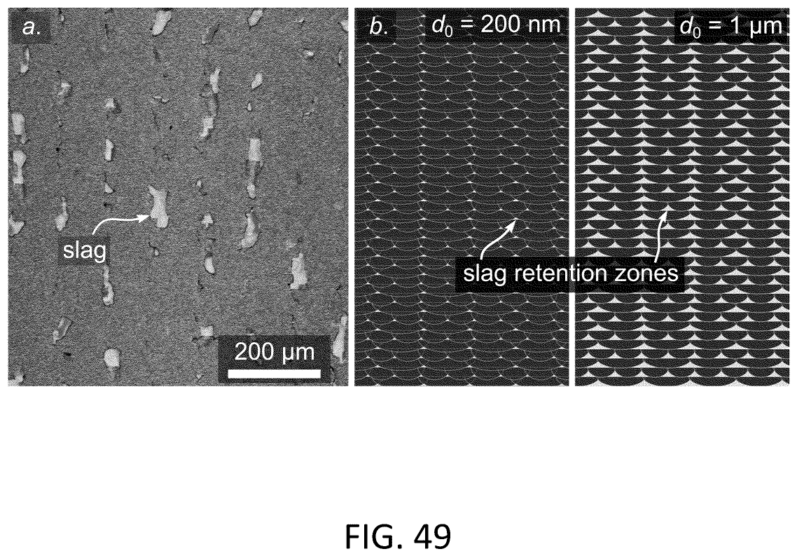

Smith et al., “Efficient production of a high-performance dispersion strengthened, multi-principal element alloy,” Sci. Rep. 10 (2020) 9663 (hereafter “Smith”) used L-PBF to consolidate equiatomic NiCoCr coated with Y₂O₃ through RAM. They observed that the as-printed material contained 10-100 μm-scale Y₂O₃ inclusions when printed with a large hatch spacing, as shown in FIG. 49a, whereas the same combination of hatch spacing and other parameters led to defect-free material for the non-ODS variant. In the vertical cross-section shown in FIG. 49, the scan direction is alternately angled either 30° or 120° laterally from page-normal. This scanning condition is recreated in the dissolution zone model by laterally stretching both the hatch spacing and dissolution zone by a factor of l/cos (θ) to account for the oblique viewing angle θ. The dissolution zone model predicts slag retention zones with periodicity equal to the hatch spacing, in good agreement with experimental observations.

Using the maximum oxide feedstock size of 200 nm reported in Smith as input, the dissolution zones are predicted to cover 98.5% of the bulk volume, as illustrated in the left simulation of FIG. 49b. The remaining 1.5% of the volume, where slag may be retained, is 1 μm tall and clearly too small to accommodate the large slag inclusions observed. The discrepancy may be due to the fact that the oxides are clustered together in the coating prior to L-PBF, similar to observations made in the RAM-coated Ni-20Cr material. Thus, the dissolution rate is governed by the size of oxide agglomerates rather than the size of individual particles. If the initial oxide size is increased to 1 μm to account for the agglomerated oxide in the feedstock, the slag retention zone grows to 12 μm tall (see right panel of FIG. 49b), large enough to explain the circular 10 μm-scale inclusions. Furthermore, with an initial oxide size of 1 μm, some slag retention zones in FIG. 49 are close to those in adjacent layers, which allows slag to grow across multiple layers. This facilitates the formation of 100 μm-tall inclusions. Smith eliminated the slag issue by decreasing the hatch spacing. Similarly, using this smaller hatch spacing in the dissolution zone model causes the slag retention zones to disappear.

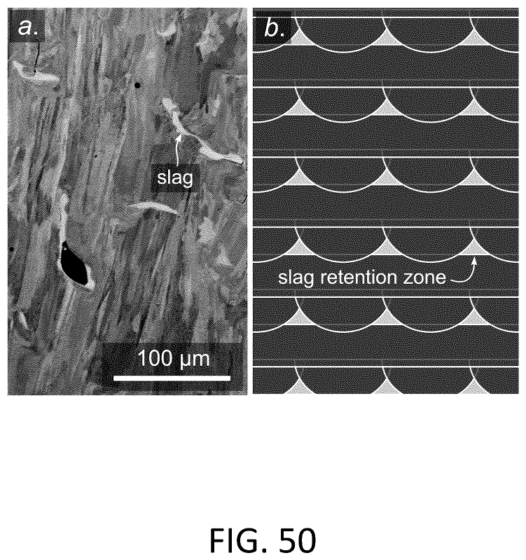

Kenel et al., “Evolution of Y₂O₃ dispersoids during laser powder bed fusion of oxide dispersion strengthened Ni—Cr—Al—Ti γ/γ′ superalloy,” Addit. Manuf. 47 (2021) 102224 (hereafter “Kenel”) performed L-PBF on Ni-8Cr-5.5Al-1Ti-0.5Y₂O₃ using 20 nm diameter Y₂O₃ feedstock incorporated through mechanical alloying. Because of the fine dispersoids in the mechanically alloyed feedstock, the dissolution zone is predicted to cover a larger fraction of the melt track compared to the previous example. However, despite the quality of Y₂O₃ feedstock, slag formed during the L-PBF process, as shown in FIG. 50(a). The explicit process by which nanoscale dispersoids agglomerate into micron-scale inclusions is not considered in the dissolution zone model. However, the dissolution zone model explains how slag is retained after it forms. The large hatch spacing used by Kenel led to only 93% dissolution zone coverage, allowing for slag retention in the remaining 7% of the bulk volume. This is in agreement with the general size and spacing of the slag inclusions observed in experiment. The dissolution zone model can also explain the observations of slag near lack of fusion defects in Kenel, since the lack of fusion zone will often border the slag retention zone. Thus, parameter sets producing slag defects in ODS alloys will also be susceptible to lack of fusion defects.

The dissolution zone model does not explain how the slag extends across multiple layers, as reported by Kenel. The same phenomenon was observed previously where it was evident from the eutectic solidification structure in the slag that the slag grew and deformed while molten. Alloying with Al likely exacerbates the slag issue by lowering the melting point of oxides. In Section 3.7, the oxide melting timescale (<1 μs) is shown analytically to be brief compared with the oxide dissolution timescale (100 μs for 1 μm oxides) and residence timescale (˜100 μs), establishing that micron-scale oxides are molten during a substantial portion of the thermal excursion. If the Y₂O₃ had reacted with Al, then the oxides would be molten even at the edge of the melt track, where they are deformed by shear flow and grow at accelerated rates. Parts of the molten slag may be transported to the surface and continue to grow in the subsequent layer into the large slag inclusions observed.

In summary, oxide slag in the bulk of as-printed ODS specimens can originate from micron-scale agglomerates of Y₂O₃ oxides in the feedstock or from lowering of the oxide melting point by reactions with Al. The present framework only considers slag inclusions formed from aggregation of oxides already present in the powder feedstock. The slag inclusions are distinct from surface slag formed through in situ oxidation, although oxygen entrainment models can be integrated with the dissolution zone model. Once micron-scale oxide inclusions are present, they persist and grow unless eliminated through adequate dissolution zone coverage between neighboring melt tracks. This criterion for slag mitigation explains why L-PBF ODS materials require smaller hatch spacings than are typically used with Ni base alloys. From an analysis of the references shown in FIG. 36, hatch spacings smaller than the beam diameter typically achieve adequate dissolution zone coverage to suppress slag.

### 3.4.3 Processing Maps for L-PBF of ODS Alloys

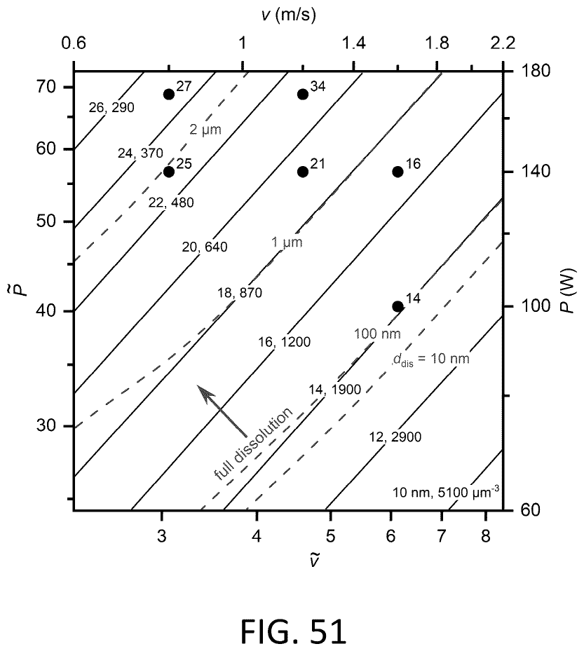

The dispersoid size calculations developed in Sections 3.3.3-3.3.7 were performed over a range of laser powers (60-180 W) and scan speeds (0.6-2.2 m/s), assuming constant beam radius (r_{B}=20 μm), hatch spacing (η=40 μm), layer thickness (β=20 μm), and Y₂O₃ content (0.16 wt %, consistent with our SANS and WDS measurements). The calculations assumed full dissolution of the initial dispersoids through overlap of dissolution zones. The predicted final dispersoid sizes are plotted as a function of dimensionless printing parameters in FIG. 51. There is excellent agreement between the predicted dispersoid sizes and the dispersoid sizes measured through SANS. Deviation at higher powers and lower velocities may result from increased absorptivity due to increased keyholing, an effect not considered in the thermal model.

FIG. 51 shows that the dispersoid diameter scales with \tilde{P}/\tilde{v}. Increasing the laser power \tilde{P} or decreasing the scan speed \tilde{v} results in slower cooling, allowing more time for dispersoid growth and coarsening and a larger final dispersoid size. The beam radius and material properties affect dispersoid size through the nondimensional parameters. Dispersoid number densities are indicated alongside corresponding dispersoid sizes in FIG. 51. The dispersoid number densities were calculated assuming monodisperse dispersoids, for which:

$$N = \frac{6 {V}_{f , ox}}{π {d}^{3}} \qquad ( 3.19 )$$

Despite the good agreement in dispersoid size, the number densities predicted by Eq. 3.19 are roughly three times larger than those measured through SANS. This discrepancy reflects differences in the dispersoid size distribution; e.g., Eq. 3.19 assumes monodisperse oxides in contrast with the log-normal size distribution seen experimentally. Nevertheless, the trends are consistent with experimental measurements, with relatively small increments in dispersoid size translating into large reductions in number density through the d³ dependence in Eq. 3.19.

FIG. 51 also indicates the lower bound (broken red contours) of processing windows for printing slag-free material for different initial oxide sizes, as predicted by the dissolution zone model. Parameter sets that lie above these bounds have at least 95% of their bulk volume covered by the dissolution zone for the indicated dispersoid size. The bounds approximately follow the final dispersoid size isocontours, although this alignment is coincidental. In the case of slag retention, \tilde{P} and \tilde{v} affect the peak temperature and duration of the thermal excursion, which in turn determine whether oxide particles of a given size can be dissolved. The dissolution zone model bounds predict slag formation in the experimental specimens when the oxide feedstock is larger than ˜2 μm, suggesting the slag inclusions shown in FIG. 29 result from the large Y₂O₃ agglomerates that decorate the powder feedstock in FIG. 26.

Comparing the slag-free bounds for different initial dispersoid sizes shows that decreasing the oxide feedstock size expands the processing window to lower powers and higher speeds, desirable for high volumetric throughput, high energy efficiency, and fine oxide dispersion. For example, assuming the Y₂O₃ feedstock size is 100 nm, the parameter set \tilde{P}=40, \tilde{v}=6 can produce slag-free material with a dispersoid size of 14 nm and a dispersoid number density of ˜2000 μm⁻³. Increasing the initial oxide size increases the minimum achievable dispersoid size and has a similarly deleterious effect on dispersoid number density.

### 3.4.4 Composition Effects on Oxide Structure

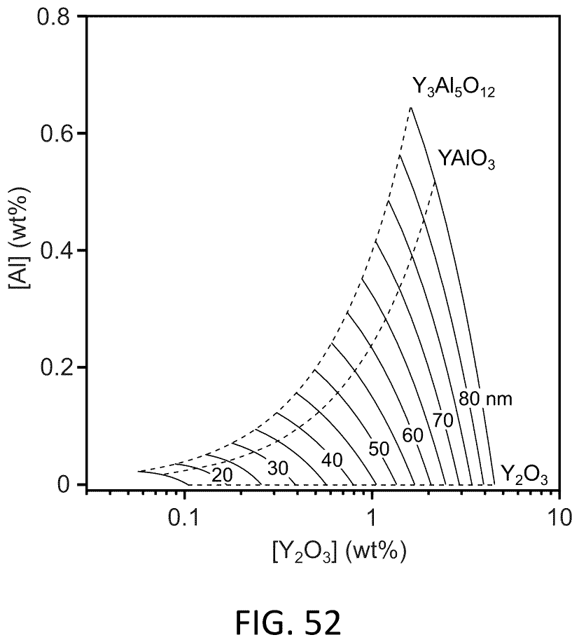

FIG. 52 shows the predicted final dispersoid size as a function of Y₂O₃ and Al concentration, assuming P=140 W, v=1.2 m/s. Increasing the concentration of Y₂O₃ increases the far-field dissolved oxide concentration (x_{∞} in Eq. 3.12), which affects dissolution and growth rates. The effect on dissolution rate, which is proportional to (X_{eq}−X_{∞}), is limited because x_{∞} is typically much smaller than x_{eq} at the high temperatures that drive dissolution. Consequently, the dissolution zone is marginally smaller.

The effect on growth rate is significant because x_{∞} is typically much larger than x_{eq} at the low temperatures in which growth takes place. Upon nucleating, dispersoids rapidly grow, consuming the dissolved oxide from the supersaturated melt and suppressing further nucleation. This results in a smaller number of dispersoids which grow to a larger final diameter. The present model predicts that increasing the Y₂O₃ concentration from 0.1 to 1 wt % leads to a three-fold increase in dispersoid diameter (15 to 45 nm along the Y₂O₃ contour in FIG. 52) and a 30% reduction in dispersoid number density. Thus, increasing the bulk Y₂O₃ concentration is not a viable strategy for increasing dispersoid number density.

If Al reacts with Y₂O₃ and dissolved O₂ to form Y—Al—O phases, the total oxide content increases, and the primary effect is the same as increasing the Y₂O₃ concentration. However, there are additional thermochemical effects: Y—Al—O phases have a smaller free energy of formation compared to pure Y₂O₃ (114 vs. 123 KJ/gram-atom). This decreases the nucleation rate, resulting in fewer, coarser dispersoids than with the same concentration of pure Y₂O₃. Following the earlier example, dispersoids predicted to grow to 45 nm with 1 wt % Y₂O₃ can grow an additional 20 nm when alloyed with 0.4 wt % Al.

For the retained 0.16 wt % of Y₂O₃ in the present experiment, the reaction with Al to form Y₃Al₅O₁₂ is predicted to increase dispersoid diameter from 19 to 28 nm. This is consistent with experimental observations of the mean as-printed diameter increasing from 21 to 27 nm upon alloying with 1 wt % Al. Similarly, doubling the nominal Y₂O₃ concentrations between Ni-20Cr-0.45Y₂O₃ and Ni-20Cr-1Y₂O₃ (0.16 and 0.36 wt % retained Y₂O₃, respectively, assuming similar retention rates) is predicted to increase dispersoid size to 29 nm, in good agreement with the experimentally measured value of 33 nm. Not captured in the present model are effects of Y—Al—O nucleating in molten form, which potentially affects the interfacial energy, as described in Section 3.3.6. Good agreement between experimental observations and modeling predictions suggest that the effect is minimal over the composition range tested (0.16 wt % Y₂O₃, 0-1 wt % Al).

Based on the above analysis, it can be concluded that Al increases the as-printed dispersoid size by increasing the total dissolvable oxide content and decreasing the nucleation rate. Predictions of the present modeling framework match the experimental observations; there is no obvious indication that Al fundamentally changes the mechanism of oxide evolution for nanoscale dispersoids. In contrast, Al has been linked to slag formation and retention, suggesting that Al activates alternative growth mechanisms at the larger micron-scale. From these observations, it is speculated that fluid mechanics effects and shear deformation become significant in oxide particles growing past the 10 nm-scale. Pure Y₂O₃ oxides remain solid and are unaffected, whereas Y—Al—O phases melt and deform under shear, causing runaway growth as described in Section 3.4.1.

### 3.5 Section Summary

Recent demonstrations of L-PBF consolidation of net-shaped ODS alloys have indicated important differences in the oxide structure of L-PBF ODS alloys versus their wrought counterparts. Specifically, L-PBF ODS alloys have larger dispersoids with lower number densities, and can develop slag inclusions under certain combinations of printing conditions and alloy chemistries. This study reveals the physics underlying these differences through a combination of systematic L-PBF experiments, scaling analysis, and physics-based modeling. Further, these insights are used to develop the dissolution zone model, which can predict dispersoid structure and slag tendency, providing a tool for co-optimization of alloy chemistry and L-PBF processing conditions to achieve wrought-like structure, properties, and performance.

The present SANS measurements of the full dispersoid size distribution in bulk L-PBF ODS specimens conclusively establish trends in oxide structure with printing conditions and alloy chemistry. It is found that the dispersoid size of L-PBF ODS alloys matches that of wrought ODS alloys, while the dispersoid volume fraction and number density are roughly an order of magnitude lower. The latter feature arises from dispersoid loss during printing, potentially because of spatter and slag formation. Our SANS measurements also established that Al alloying above a threshold level, between ˜0.34 and 1 at %, promotes reactions between Al and Y₂O₃, increases the final dispersoid size, and catalyzes slag formation. Increasing the scan speed and lowering the beam power both decrease the mean dispersoid size, but the processing window and minimum dispersoid size are constrained by the onset of lack-of-fusion defects.

Flow around dispersoids smaller than 100 nm is characterized by extremely small Stokes numbers below 10⁻⁵. Consequently, dispersoids follow streamlines and see no relative motion towards nearby dispersoids or surfaces. Thus, mechanical impingement is unlikely to be significant for dispersoid coarsening in L-PBF. Dispersoids attain their as-printed size primarily through diffusion-mediated growth from the supersaturated melt upon cooling. By contrast, larger micron-scale oxides—either present in the feedstock or coarsened from dispersoids—detach from the flow and experience accelerated coarsening due to mechanical impingement and advective transport of dissolved oxides.

In the modeling, the dispersoid behaviors are assessed by coupling a reduced order model of the thermal excursion within the melt pool with classical models of structural evolution processes—e.g., oxide dissolution, nucleation, growth, and coarsening. The analysis showed that the brief thermal excursion near the core of the melt pool can fully dissolve oxides smaller than ˜1 μm. Within this dissolution zone, the final dispersoid size is insensitive to initial location and can be estimated by tracking transport phenomena along a single representative thermal excursion. Upon cooling, nanoscale dispersoids nucleate from the super-saturated melt, explaining how as-printed dispersoids are sometimes smaller than the feedstock oxides. The dispersoid size in as-printed material is affected by cooling rate: fast cooling, achieved through increasing scan speed or decreasing laser power, produces smaller dispersoids and correspondingly greater number density. These model predictions are in quantitative agreement with the SANS measurements of dispersoid size and offer guidance for reducing as-printed dispersoid size in ODS alloys over most of the viable processing envelope.

The dissolution zone model also informs slag-free printing of ODS alloys: combining dissolution zones from neighboring melt pools and comparing with the melt track unit cell indicates when undissolved oxides retained in the outer portion of the melt track may grow further during subsequent laser passes to become slag inclusions. Based on several case studies on as-printed slag structure, it is shown that the dissolution zone model accurately predicts the periodicity and size of slag inclusions as a function of processing conditions and feedstock oxide size. Further, the dissolution zone model explains how judicious selection of sufficiently high laser power and slow scan speed for a given hatch spacing and initial Y₂O₃ size can ensure complete dissolution of oxides throughout the bulk material and thus mitigate slag formation. However, this reduces the viable processing envelope, particularly in the region that produces the smallest dispersoids, presenting a tradeoff between feedstock quality and dispersoid size.

The model shows that Y—Al—O phases, formed through in situ reactions between Y₂O₃ and Al, increase oxide solubility, thereby accelerating dispersoid growth and increasing the final dispersoid size. However, the increment in dispersoid size is relatively minor (of order ˜50%). This cannot by itself explain how small Al additions catalyze formation of micron-scale slag inclusions observed in the present study. A more likely explanation for how Al promotes slag, indicated by the present modeling, is that low melting point Y—Al—O phases nucleate as molten droplets, which are more susceptible to shearing and other behaviors that further accelerate oxide growth.

The study shows the central challenge of printing ODS alloys is selecting processing conditions that balance decreasing dispersoid size with full densification and slag mitigation. Given the initial Y₂O₃ diameter of 100 nm and retained Y₂O₃ concentration of 0.16 wt % in the present study, the smallest dispersoids achievable through L-PBF in the slag-free processing envelope is around 20 nm. Further decreasing laser power or increasing scan speed results in finer dispersoids at the expense of print defects (slag formation and lack-of-fusion); e.g., increasing scan speed to 1.6 m/s produced 97.5% dense specimens with dispersoid diameter of 16 nm and number density of 600 μm⁻³, still less than a third as many dispersoids as in wrought MA754. Closing the gap in dispersoid number density between L-PBF and wrought ODS alloys requires addressing two issues: mitigating loss of retained oxides due to slag and spatter, and offsetting the increased growth rate resulting from the increased oxide content. Spatter loss may potentially be reduced by using feedstock in which the oxide is bonded to or embedded within powder particles (e.g., through gas atomized reaction synthesis or through mechanical alloying followed by plasma spheroidization). The second issue may be addressed through the addition of alloying elements, such as Ti, that decrease the interfacial energy between the alloy matrix and the oxide particle. For example, Ti was observed to decorate dispersoid surfaces on L-PBF MA754 samples, perhaps modifying interfacial chemistry and growth kinetics. Implementing this approach requires a deeper understanding of nucleation kinetics and fluid mechanics of molten oxides suspended within the alloy melt.

### 3.6 Appendix A—Approximation Formulae for Melt Pool Velocities

The characteristic fluid velocity in the melt pool can be approximated using an idealized unidirectional flow field along the scan direction, a reasonable assumption due to the high aspect ratio of the melt pool. The bottom boundary is stationary from the no-slip condition. The top boundary experiences tractions from the Marangoni effect:

$$τ = \frac{d {γ}_{LG}}{dT} \frac{dT}{dx} \qquad ( 3.2 )$$

The temperature gradient

$$\frac{dT}{dx}$$

is of order

$$\frac{{T}_{b} - {T}_{m}}{l} .$$

The surface tension coefficient

$$\frac{d {γ}_{LG}}{dT}$$

is of order 5×10⁻⁴ N m⁻¹ K⁻¹ for Ni-20Cr. Accordingly, the velocity gradient

$$\frac{{dv}_{x}}{dz}$$

is negative at the surface of the melt pool, and the flow is opposite the scan direction at the surface, as shown in FIG. 53(a). After imposing the condition of zero net flow in the scan direction, the flow field can be solved analytically. For the scaling analysis, the speed in the melt pool was maximized, which represents a worst case for the onset of accelerated coarsening through advection. The maximum speed occurs at the surface and is:

$${v}_{melt} = \frac{τ h}{4 μ} = \frac{( {T}_{b} - {T}_{m} ) ( d {γ}_{LG} / dT )}{4 μ} \frac{h}{l} \qquad ( 3.21 )$$

Note that vₘₑₗₜ scales with the melt pool aspect ratio h/l and has no other geometric dependence. If it is assumed DED melt pools have roughly the same aspect ratio as L-PBF, then the speed of convection is of the same order given the same materials properties (˜5 m/s for Ni-20Cr). The scaling analysis is in good agreement with the CFD result in FIG. 53(b).

To model the effect of melt pool-scale flow on local flow around a dispersoid particle, a characteristic acceleration of melt pool-scale flow is introduced with the following:

$${a}_{melt} = \frac{2 {v}_{melt}}{{t}_{res}} \qquad ( 3.22 )$$

This is the average acceleration required to bring fluid parcels from stationary to vₘₑₗₜ over half the melt pool residence time. A particle suspended in the accelerating fluid may move relative to the fluid due to inertia. For a solid spherical particle, the relative velocity is given by Stokes' law:

$${v}_{rel} = \frac{Δρ {a}_{melt} {d}^{2}}{18 μ} \qquad ( 3.23 )$$

where Δρ is the density difference between the particle and the matrix.

### 3.7 Appendix B—Timescale of Oxide Melting

The timescale for complete melting of a spherical oxide particle can be estimated by considering heat conduction through the molten oxide layer to the solid oxide core. Assuming quasi-steady state (i.e., the melt front velocity is slower than the heat conduction velocity), the 1-D heat equation in spherical coordinates is:

$$\frac{d}{dr} ( {r}^{2} \frac{dT}{dr} ) = 0 \qquad ( 3.24 )$$

The boundary conditions are that: the temperature at the melt front (r=rₘ) is maintained at the oxide melting temperature (T_{m,ox}) and the temperature at the surface of the oxide particle (r=r₀) is maintained at the instantaneous alloy temperature (T_{∞}). Solving Eq. 3.24 subject to these boundary conditions and applying Fourier's law gives the heat flux at the melt front:

$$q = - {λ}_{ox} \frac{{T}_{∞} - {T}_{m , ox}}{{r}_{o} - {r}_{m}} \frac{{r}_{o}}{{r}_{m}} \qquad ( 3.25 )$$

Assuming the incident heat flux at r=rₘ is entirely consumed through the latent heat of fusion due to oxide melting Δh_{f}, the velocity of the melt front is related to the heat flux through:

$$\frac{{dr}_{m}}{dt} = \frac{{V}_{m , ox}}{Δ {h}_{f , ox}} q \qquad ( 3.26 )$$

Combining Eqs. 3.25 and 3.26 and integrating from r₀ to 0 gives the oxide melting timescale:

$${t}_{melt} = \frac{Δ {h}_{f , ox} {ρ}_{ox} {r}_{0}^{2}}{6 {λ}_{ox} ( {T}_{∞} - {T}_{m , ox} )} \qquad ( 3.27 )$$

The oxide melting timescale can be compared to the oxide dissolution timescale, which can be obtained by integrating Eq. 3.12 from Section 3.3.5:

$${t}_{dis} = \frac{{V}_{m} {r}_{0}^{2}}{2 {DV}_{m , ox} ( {x}_{eq} - {x}_{∞} )} \qquad ( 3.28 )$$

The oxide dissolution and melting timescales both scale with rₒ, so their ratio is independent of oxide size:

$$\frac{{t}_{dis}}{{t}_{melt}} = \frac{3 {V}_{m} {λ}_{ox} ( {T}_{∞} - {T}_{m , ox} )}{{V}_{m , ox} D Δ {h}_{f , ox} {ρ}_{ox} ( {x}_{eq} - {x}_{∞} )} \qquad ( 3.29 )$$

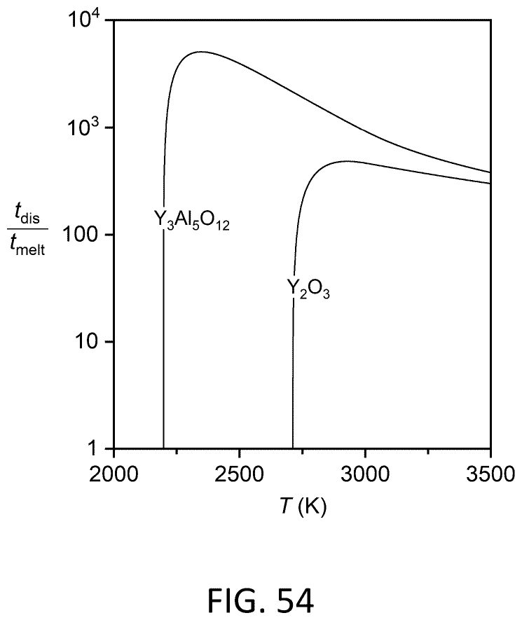

Evaluating Eqs. 3.27 and 3.28 using typical values for Y₂O₃ (λₒₓ=5 Wm⁻¹K⁻¹, Δh_{f,ox}=550 kJ kg⁻¹) shows that the melt timescale is shorter than 1 μs for oxides smaller than 1 μm and much faster than the dissolution timescale for all temperatures above melting, establishing that oxides are in the molten state essentially as soon as the surrounding alloy matrix exceeds the oxide melting temperature. This trend is highlighted in FIG. 54, which shows that t_{dis}/tₘₑₗₜ is much greater than unity above the oxide melting temperature.

### 3.8 Appendix C—Time-Temperature Scaling of Analytical Thermal Excursion

A reduced order model is developed to assess the temperature within the melt pool by applying the following empirical transformations to the time-temperature histories predicted by Eq. 3.17:

$${T}_{transformed} = {T}_{0} + B ( T - {T}_{0} ) \qquad ( 3.2 )$$

$$B = \{ \begin{matrix}{B}_{1} & T < {T}_{1} \\ {B}_{1} + {( \frac{T - {T}_{1}}{{T}_{2} - {T}_{1}} )}^{2} ( {B}_{2} - {B}_{1} ) & {T}_{1} \leq T \leq {T}_{2} \\ {B}_{2} & T > {T}_{2}\end{matrix} \qquad ( 3.31 )$$

$${dt}_{transformed} = dt / C \qquad ( 3.3 )$$

$$C = \{ \begin{matrix}{C}_{3} & T < {T}_{3} \\ {C}_{3} + {( \frac{T - {T}_{3}}{{T}_{4} - {T}_{3}} )}^{2} ( {C}_{4} - {C}_{3} ) & {T}_{3} \leq T \leq {T}_{4} \\ {C}_{4} & T > {T}_{4}\end{matrix} \qquad ( 3.33 )$$

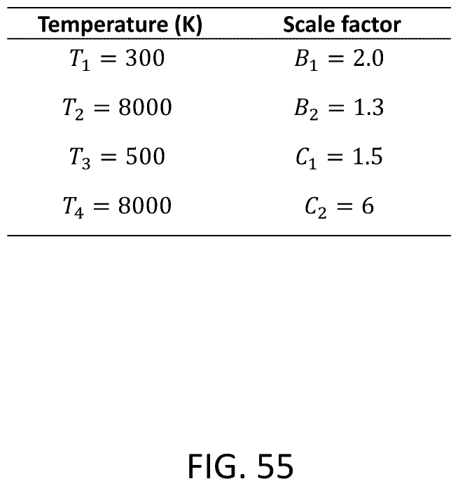

Eqs. 3.30-3.31 are applied to temperature while Eqs. 3.32-3.33 transform the time. FIG. 55 lists the best fit parameters for matching the CFD thermal excursions with those predicted through the reduced order model. FIG. 56 compares the CFD and the reduced order model predictions showing they are in good agreement, especially during the later stages of cooling.

### 4. CONCLUSION

All parameters, dimensions, materials, and configurations described herein are meant to be exemplary and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions and arrangement of respective elements of the exemplary implementations without departing from the scope of the present disclosure. The use of a numerical range does not preclude equivalents that fall outside the range that fulfill the same function, in the same way, to produce the same result.

Also, various inventive concepts may be embodied as one or more methods, of which at least one example has been provided. The acts performed as part of the method may in some instances be ordered in different ways. Accordingly, in some inventive implementations, respective acts of a given method may be performed in an order different than specifically illustrated, which may include performing some acts simultaneously (even if such acts are shown as sequential acts in illustrative embodiments).

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures. Section 2111.03.

1. An oxide dispersion-strengthened (ODS) alloy, comprising:
a concentration of nickel (Ni) ranging from about 65 wt % to about 90 wt %;
a concentration of chromium (Cr) ranging from about 5 wt % to about 35 wt %;
a concentration of yttria (Y₂O₃) ranging from about 0.1 wt % to about 0.5 wt %; and
a concentration of aluminum (Al) less than 0.3 wt %.

2. The ODS alloy of claim 1, wherein the concentration of Al is less than or equal to about 0.1 wt %.

3. The ODS alloy of claim 1, wherein:
the concentration of Ni ranges from about 75 wt % to about 85 wt %; and
the concentration of Cr ranges from about 15 wt % to about 25 wt %.

4. The ODS alloy of claim 1, wherein the concentration of Cr is about 20 wt %.

5. The ODS alloy of claim 1, further comprising:
a concentration of titanium (Ti) ranging from about 0.3 wt % to about 0.7 wt %.

6. The ODS alloy of claim 1, wherein:
the Y₂O₃ and the Al form a plurality of dispersoids;
the plurality of dispersoids has a mean diameter less than or equal to 30 nm; and
the mean diameter of the plurality of dispersoids is measured using small angle neutron scattering (SANS).

7. The ODS alloy of claim 6, wherein the plurality of dispersoids has a number density greater than or equal to about 600 μm⁻³.

8. The ODS alloy of claim 7, wherein the plurality of dispersoids has a number density greater than or equal to about 2000 μm⁻³.

9. The ODS alloy of claim 1, wherein the ODS alloy has a grain structure indicative of an additive manufacturing process.

10. The ODS alloy of claim 9, wherein the grain structure comprises a plurality of columnar grains aligned substantially parallel with a build direction associated with the additive manufacturing process.

11. The ODS alloy of claim 10, wherein:
each columnar grain of the plurality of columnar grains has a length and a width; and
a ratio of the length and the width ranges from about 3 to about 20.

12. The ODS alloy of claim 1, wherein the ODS alloy does not comprise slag particles having a diameter greater than 1 μm.

13. An oxygen-rich turbopump, comprising:
at least one component formed from the ODS alloy of claim 1,
wherein the turbopump is configured to operate at a temperature ranging from about 50 K to about 1200 K and an oxygen pressure ranging from about 1 atm to about 1200 atm.

14. An oxide dispersion-strengthened (ODS) alloy, comprising:
nickel (Ni);
chromium (Cr);
yttria (Y₂O₃); and
aluminum (Al),
wherein the ODS alloy has a grain structure indicative of an additive manufacturing process.

15. The ODS alloy of claim 14, wherein the grain structure comprises a plurality of columnar grains aligned substantially parallel with a build direction associated with the additive manufacturing process.

16. The ODS alloy of claim 15, wherein:
each columnar grain of the plurality of columnar grains has a length and a width; and
a ratio of the length and the width ranges from about 3 to about 20.

17. The ODS alloy of claim 15, wherein:
the Y₂O₃ and the Al form a plurality of dispersoids;
the plurality of dispersoids has a number density greater than or equal to about 600 μm⁻³;
the plurality of dispersoids has a mean diameter less than or equal to 30 nm; and
the mean diameter of the plurality of dispersoids is measured using small angle neutron scattering (SANS).

18. The ODS alloy of claim 17, wherein a concentration of Al is less than 0.3 wt %.

19. The ODS alloy of claim 15, wherein the ODS alloy does not comprise slag particles having a diameter greater than 1 μm.

20. A method for making a component from an oxide dispersion-strengthened (ODS) alloy, the method comprising:
providing a feedstock powder, the feedstock powder comprising:
a concentration of nickel (Ni) ranging from about 65 wt % to about 90 wt %;
a concentration of chromium (Cr) ranging from about 5 wt % to about 35 wt %;
a concentration of yttria (Y₂O₃) ranging from about 0.1 wt % to about 0.5 wt %; and
a concentration of aluminum (Al) less than 0.3 wt %; and
making, via an additive manufacturing process, the component from the feedstock powder;
wherein the component has a grain structure comprising a plurality of columnar grains aligned substantially parallel with a build direction associated with the additive manufacturing process.
